(19) United States
(12) Patent Application Publication
(10) Pub. No.: US 2003/0051026 A1
(43) Pub. Date: Mar. 13, 2003

(54) Network surveillance and security system

(76) Inventors: Ernst B. Carter, San Francisco, CA (US); Vasily Zolotov, San Francisco, CA (US)

Correspondence Address: THOMPSON COBURN, LLP, ONE FIRSTAR PLAZA, SUITE 3500, ST LOUIS, MO, 63101, US

(21) Appl. No.: 09/766,560

(22) Filed: Jan. 19, 2001

(51) Int. Cl. G06F 15/173; G06F 11/30

(52) U.S. Cl. 709/224; 713/201; 706/909

(57) ABSTRACT

A system that monitors and protects the security of computer networks uses artificial intelligence, including learning algorithms, neural networks and genetic programming, to learn from security events. The invention maintains a knowledge base of security events that updates autonomously in real time. The invention encrypts communications to exchange changes in its knowledge base with separate security systems protecting other computer networks. The invention autonomously alters its security policies in response to ongoing events. The invention tracks network communication traffic from inception at a well-known port throughout the duration of the communication including monitoring of any port the communication is switched to. The invention is able to track and utilize UNIX processes for monitoring, threat detection, and threat response functions. The invention is able to subdivide the network communications into identifying tags for tracking and control of the communications without incurring lags in response times.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This Invention relates to monitoring and protecting networks of computers. Information processors, databases and other linked components are among the constituents of networks. Networks improve communication and coordination between individual computers and facilitate efficient use of resources. Communication links with parties outside of a network enable further gains. Communications internal to and external of a network also present risks, however. These risks can include unauthorized access to data or facilities, improper utilization of resources, or damage to network operations.

The risks from internal and external communications vary according to the type of communication. Controlling access to differing parts of the network is integral to network security. Additional security challenges arise from enabling access to the network by external, potentially unknown, parties such as by an Internet connection. The network must both correctly identify authorized external parties and provide the appropriate amount of authorized access. Outside access further requires the network be able to detect and rapidly respond to attempts to interfere with or damage the network's operations.

Preferably, a network security system will employ a knowledge base plus respond to and learn from new events. The intended network operations, combined with analysis of previously encountered attempts to disrupt those operations, comprises the knowledge base. Among the new events are incidents outside the scope of prior network experiences. Also among the new events will be formerly experienced occurrences in disguise. The quality of the protection provided to the network by the security system will depend in part on the breadth of the knowledge base. However, information technology is constantly evolving. No compendium of knowledge can be broad enough to encompass all threats, particularly newly emerging ones. Preferably, a security system is able to respond to unanticipated events. An ability to expand its knowledge base to incorporate information relating to unanticipated events is also desirable of a security system.

A security system will preferably have the capacity to analyze ongoing communications both to ensure that the network operates as intended for authorized users and to detect threats from others. The system monitors network operations to detect occurrences which threaten the network's security. The system would attempt to recognize these occurrences, by consulting its knowledge base, to determine the correct response. If the occurrence is not recognized, the system would preferably have the additional capability of drawing comparisons to prior occurrences to infer appropriate countermeasures. The ability to learn from both encounters with new threats and the results of attempted countermeasures to those threats would also be desirable of a network security system. Further advantages would be realized from a security system that could communicate with privacy over a publicly accessible network such as the Internet. A security system could thus communicate knowledge learned from a newly encountered security threat to other systems that have not yet encountered that threat. An encryption capability would facilitate private communication over public networks, and thus allow the avoidance of the additional expense of maintaining private communication channels. A still further improvement to the network security system would be a proprietary encryption capability, to provide an even greater degree of safety than available with publicly available encryption systems.

Information technology security products are available for a variety of purposes, such as protecting from computer viruses and detecting network intrusions. (See Table 1 follwing) Also available are a variety of encryption systems. A need exists, though, for a comprehensive network surveillance and security system capable of learning in response to newly emerging threat situations. An additional need exists for a network surveillance and security system capable of privately communicating, over a public communication system, new developments relating to network surveillance and security. Among the existing products commonly available in the industry for network surveillance and security are:

TABLE 1
Intrusion Detection

| Company | Product |
|---|---|
| FOR NETWORKS: | |
| Advantor Corporation | Advantage plus |
| Advantor Corporation | Advantage Suite for Networks |
| Anzen Computing | Auzen Flight Jacket |
| AXENT Technologies | Intruder Alert |
| AXENT Technologies | NetProwler |
| AXENT Technologies | Passgo SSO |
| Cisco Systems | NetRanger |
| Computer Associates International, | eTRUST Intrusion Detection |
| Inc. | |
| Computer Associates International, | eTrust Intrusion Detection |
| Inc. | Log View |
| Digital Equipment Corporation | POLYCENTER Security Intrusion |
| Hewlett-Packard | HP OpenView Node Sentry |
| Hewlett-Packard | Node Sentry |
| Internet Security Systems | RealSecure |
| Internet Security Systems | SAFEsuite Decisions |
| Intrusion.com | Kane Border Patrol |
| Intrusion.com | Kane Security Analyst |
| Intrusion.com | SecureNet PRO |
| Lopht Heavy Industries | AntiSniff |
| Litton PRC | PreCis |
| Lucent | Lucent Realsecure |
| NetSecure Software | NetSecure Log |
| Network Associates | CyberCop Monitor |
| Network Flight Recorder | Network Flight Recorder |
| Network ICE | Black ICE Sentry |
| Network ICE | ICEpac Security Suite |
| Network Security Wizards | Dragon IDS |
| Patriot Technologies | PATRIOT IDS |
| SecureLogix | TeleWall |
| Touch Technologies | INTOUCH INSA |
| Zone Labs | ZoneAlarm |
| FOR HOSTS: | |
| 2Cactus Development | SecureBSD 1.0 |
| Adavi | Silent Watch |
| AXENT Technologies | Audit |
| AXENT Technologies | Intruder Alert |
| AXENT Technologies | Intruder Alert for VMS |
| Centrax | Centrax Log Analyst |
| Centrax | eNTrax |
| ClickNet Software | entercept |
| Computer Associates International, | eTrust Intrusion Detection Central |
| Inc. | Centrax |
| CyberSafe | Centrax |
| CyberSafe | CyberSafe Log Analyst (CLA) |
| DataLynxInc. | auditGUARD |
| DataLynxInc. | Security CeNTer |
| Digital Equipment Corporation | POLYCENTER Security Intrusion |
| Internet Security Systems | SAFEsuite Decisions |
| Intrusion.com | Kane Security Monitor (KSM) |
| Litton PRC | PreCis |
| NetSecure Software | NetSecure Log |
| NetSecure Software | NetSecure Sign |
| Network Associates | CyberCop Monitor |
| Network ICE | Black ICE Pro |
| Network Security Wizards | Dragon IDS |
| Network Security Wizards | Dragon Squire |
| Patriot Technologies | PATRIOT IDS |
| Pedestal Software | Intact |
| Pedestal Software | Intact Directory Services |
| Pedestal Software | Intact Enterprise |
| PentaSafe | PSDetect-400 |
| Sybergen Networks Inc. | Sybergen Secure Desktop |
| Symark Software | Watcher |
| Tripwire, Inc. | Tripwire for UNIX 2.2.1 |
| Tripwire, Inc. | Tripwire for Windows NT 2.2.1 |
| Trusted Systems Services | Advanced Checker |
| WebTrends | AuditTrack for NetWare |
| WetStone Technologies | SMARTWatch |
| For Management and Reporting: | |
| Advantor Corporation | Advantage Suite for Networks |
| AXENT Technologies | Enterprise Security Manager |
| AXENT Technologies | Intruder Alert |
| AXENT Technologies | Passgo SSO |
| Bionetrix | BioNetrix Authentication Suite |
| Check Point Software | Check Point RealSecure |
| Computer Associates International, | eTRUST Intrusion Detection |
| Inc. | |
| Computer Associates International, | eTrust Intrusion Detection |
| Inc. | Central |
| Computer Associates International, | eTrust Intrusion Detection Log |
| Inc. | View |
| eSoft | Interceptor |
| Freemont Avenue Software, Inc. | T.REX Firewall |
| Hewlett-Packard | HP OpenView Node Sentry |
| Intrusion.com | Kane Border Patrol |
| Intrusion.com | Kane Secure Enterprise |
| Intrusion.com | Kane Security Analyst |
| Intrusion.com | SecureNet PRO |
| Lopht Heavy Industries | AntiSniff |
| Litton PRC | PreCis |
| Lucent | Lucent Realsecure |
| NetSecure Software | NetSecure Log |
| Network ICE | ICEcap |
| Network ICE | ICEpac Security Suite |
| Network Security Wizards | Dragon IDS |
| Pedestal Software | Intact Enterprise |
| Penta Security Systems | E-RAT |
| Penta Security Systems | Siren2000 |
| PentaSafe | VigilEnt Enterprise |
| SRI International | EMERALD eXpert-BSM |
| Sybergen Networks Inc. | Sybergen Management Server |
| Tripwire, Inc. | Tripwire for UNIX 2.2.1 |
| Tripwire, Inc. | Tripwire for Windows NT 2.2.1 |
| WetStone Technologies | SMARTWatch |

Security Products Available for Cryptography

| Company | Product |
|---|---|
| HARDWARE-SECURITY | |
| MODULES: | |
| Baltimore Technologies | CG5000 Host Security Module |
| RedCreek Communications | Ravlin 3200 |

Hardware-Coprocessor:

| Company | Product |
|---|---|
| 3com | 3CR990-TX-97 10/100 PCI NIC |
| | with 3XP |
| Altiga | VPN Concentrator |
| ASIC International, Inc. | Ai Montgomery Exponentiator Core |
| ASIC International, Inc. | Ai-DES-1 DES Core |
| ASIC International, Inc. | Ai-MD5-1 |
| ASIC International, Inc. | Ai-SHA-1 |
| ASIC International, Inc. | CryptoEngine |
| Baltimore Technologies | HSP4000 |
| General Dynamics | FASTLANE ATM Encryptor |
| | (KG-75) |
| Hewlett-Packard | Praesidium SpeedCard |
| Hi/fn | 7711 Encryption Processor |
| Hi/fn | 7751 Encryption Processor |

Toolkits and Frameworks:

| Company | Product |
|---|---|
| Spyrus | TLSGold SSL Toolkit |
| SSE | TrustedCA |
| SSE | TrustedDoc |
| SSH Communications Security | SSH IPSEC Express |
| SSH Communications Security | SSH ISAKMP/Oakley |
| SSH Communications Security | SSH X.509 Certificate Tools |
| StorageTek | ATLAS ATM |
| SynData Technologies | SynCrypt |
| Trintech | S/PAY |
| Utimaco | SafeGaurd Sign&Crypt |
| ValiCert | ValiCert Validator Toolkit |
| WetStone Technologies | SMARTCrypt |
| WinWare | Mirage OCX |
| Xcert International | Xcert Development Kit |

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

The following explications of the information technology relating to computer networks, their operation and organization are selections from the publicly accessible information technology resource: whatis?com™, an online community of TechTarget.com accessible on the World Wide Web at the URL: http://www.whatis.com; Copyright 2000 whatis.com and TechTarget.com, Inc. Reprinted with permission of TechTarget.com, Needham, Mass.

Networks & Communication

“In information technology, a network is a series of points or nodes interconnected by communication paths. Networks can interconnect with other networks and contain subnetworks. A given network can also be characterized by the type of data transmission technology in use on it; by whether it carries voice, data, or both kinds of signals; by who can use the network (public or private); by the usual nature of its connections (dial-up or switched, dedicated or nonswitched, or virtual connections); and by the types of physical links (for example, optical fiber, coaxial cable, and Unshielded Twisted Pair). Large telephone networks and networks using their infrastructure (such as the Internet) have sharing and exchange arrangements with other companies so that larger networks are created.” (TechTarget.com)

Communications within and between networks have various forms. One requirements for communication is compatible formats between the communicating end parties. Differences between formats are comparable to differing languages' variations in rules of grammar. For a communication to be understood, both parties must speak the same language. These differences may include differences in both syntax and semantics. As described on Whatis.com:

“Syntax is the grammar, structure, or order of the elements in a language statement. (Semantics is the meaning of these elements.) Syntax applies to computer languages as well as to natural languages. Usually, we think of syntax as ‘word orde’. In computer languages, syntax can be extremely rigid as in the case of most assembler languages or less rigid in languages that make use of “keyword” parameters that can be stated in any order.

“Semantics is the branch of semiotics, the philosophy or study of signs, that deals with meaning. In discussing natural and computer languages, the distinction is sometimes made between syntax (for example, the word order in a sentence or the exact computer command notation) and semantics (what the words really say or what functions are requested in the command).” (TechTarget.com)

Communication Protocols

Protocols are the rules governing these formats. Internal and external network communications utilize a variety of protocols, depending on the parties involved and the channel used. As described on Whatis.com:

“In information technology, a protocol is the special set of rules for communicating that the end points in a telecommunication connection use when they send signals back and forth. Protocols exist at several layers in a telecommunication connection. There are hardware telephone protocols. There are protocols between the end points in communicating programs within the same computer or at different locations. Both end points must recognize and observe the protocol. Protocols are often described in an industry or international standard.

On the Internet, there are the TCP/IP protocols, consisting of:

Transmission Control Protocol, which uses a set of rules to exchange messages with other Internet points at the information packet layer.

Internet Protocol, which uses a set of rules to send and receive messages at the Internet address layer.

Hypertext Transfer Protocol, File Transfer Protocol, and other protocols, each with defined sets of rules to use with other Internet points relative to a defined set of capabilities.” (TechTarget.com)

The transmission of information through network communication processes commonly involves a procedure of decomposing a communication into fragments and then reassembling the fragments into the original communication. These fragments are often termed packets, which are described on whatis.com as:

“A packet is the unit of data that is routed between an origin and a destination on the Internet or any other packet-switched network. When any file (e-mail message, HTML file, Graphics Interchange Format file, Uniform Resource Locator request, and so forth) is sent from one place to another on the Internet, the Transmission Control Protocol (TCP) layer of TCP/IP divides the file into ‘chunks’ termed packets of an efficient size for routing. Each of these packets are separately numbered and include the Internet address of the destination. The individual packets for a given file may travel different routes through the Internet. When they have all arrived, they are reassembled into the original file (by the TCP layer at the receiving end).

“A packet-switching scheme is an efficient way to handle transmissions on a connectionless network such as the Internet. An alternative scheme, circuit-switched, is used for networks allocated for voice connections. In circuit-switching, lines in the network are shared among many users as with packet-switching, but each connection requires the dedication of a particular path for the duration of the connection.

“‘Packet’ and ‘datagram’ are similar in meaning. A protocol similar to TCP, the User Datagram Protocol (UDP) uses the term datagram.” (TechTarget.com)

Utilization of the Internet provides significant cost reductions and greater flexibility for network communications. Accordingly, monitoring and protecting network communication over the Internet is a major purpose of network surveillance and security systems. As described on Whatis.com, the various relevant protocols to Internet communications include:

“Transmission Control Protocol/Internet Protocol (TCP/IP) is the basic communication language or protocol of the Internet. It can also be used as a communications protocol in a private network (either an intranet or an extranet)

“TCP/IP is a two-layer program. The higher layer, Transmission Control Protocol, manages the assembling of a message or file into smaller packets that are transmitted over the Internet and received by a TCP layer that reassembles the packets into the original message. The lower layer, Internet Protocol, handles the address part of each packet so that it gets to the right destination.

“TCP/IP uses the client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-layer applications that use it are collectively said to be “stateless” because each client request is considered a new request unrelated to any previous one.

“Many higher layer application protocols use TCP/IP to get to the Internet. These include the World Wide Web's Hypertext Transfer Protocol (HTTP), the File Transfer Protocol (FTP), Telnet (Telnet) which lets you logon to remote computers, and the Simple Mail Transfer Protocol (SMTP). These and other protocols are often packaged together with TCP/IP as a ‘suite’.

“Personal computer users usually get to the Internet through the Serial Line Internet Protocol (SLIP) or the Point-to-Point Protocol (PPP). These protocols encapsulate the IP packets so that they can be sent over a dial-up phone connection to an access provider's modem.

“Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).” (TechTarget.com)

A diverse array of differing protocols are employed by computer network products. In order to develop a consistent system for managing networks which may incorporate these products, the Simple Network Management Protocol (SNMP) has been formulated. As described on Whatis.com:

“SNMP is the protocol governing network management, and the monitoring of network devices and their functions. It is not limited to TCP/IP networks. The details of SNMP are in these Internet Engineering Task Force (IETF) Request For Comments incorporated herein by reference:

RFC 1089—SNMP over Ethernet

RFC 1140—IAB Official Protocol Standards

RFC 1147—Tools for Monitoring and Debugging TCP/IP Internets and Interconnected Devices [superceded by RFC 1470]

RFC 1155—Structure and Identification of Management Information for TCP/IP based internets.

RFC 1156 (H)—Management Information Base Network Management of TCP/IP based internets

RFC 1157—A Simple Network Managment Protocol

RFC 1158—Management Information Base Network Management of TCP/IP based internets: MIB-II

RFC 1161 (H)—SNMP over OSI

RFC 1187—Bulk Table Retrieval with the SNMP

RFC 1212—Concise MIB Definitions

RFC 1213—Management Information Base for Network Management of TCP/IP-based internets: MIB-II

RFC 1215 (I)—A Convention for Defining Traps for use with the SNMP

RFC 1224—Techniques for Managing Asynchronously-Generated Alerts

RFC 1270 (I)—SNMP Communication Services

RFC 1303 (I)—A Convention for Describing SNMP-based Agents

RFC 1470 (I)—A Network Management Tool Catalog

RFC 1298—SNMP over IPX

RFC 1418—SNMP over OSI

RFC 1419—SNMP over IPX

Copies of the RFCs and a Frequently-Asked Questions discussion on SNMP is available at:

http://www.cis.ohio-state.edu/hypertext/faq/usenet/snmp-faq/partl/faq.htm.” (TechTarget.com)

As described in whatis.com:

“an agent (also called an intelligent agent) is a program that gathers information or performs some other service on a regular schedule without the user's immediate attention.” (TechTarget.com)

Network Communication Architectures

The Open Systems Interconnection (OSI) Reference Model has been put together to facilitate comprehension of network architectures and functional relationships. OSI was officially adopted as an international standard by the International Organization of Standards (ISO). Currently, it is Recommendation X.200 of the ITU-TS. As described on Whatis.com:

“Open Systems Interconnection (OSI) is a standard reference model for communication between two end users in a network. It is used in developing products and understanding networks. This figure shows where commonly-used Internet products and services fit within the model:

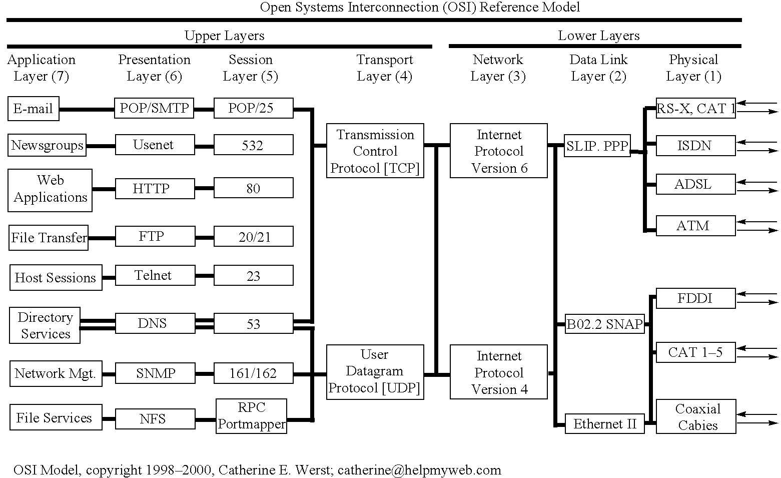

The OSI Reference Model describes seven layers of related functions that are needed at each end when a message is sent from one party to another party in a network. An existing network product or program can be described in part by where it fits into this layered structure. For example, TCP/IP is usually packaged with other Internet programs as a suite of products that support communication over the Internet. This suite includes the File Transfer Protocol (File Transfer Protocol), Telnet, the Hypertext Transfer Protocol (Hypertext Transfer Protocol), e-mail protocols, and sometimes others. Although TCP fits well into the Transport layer of OSI and IP into the Network layer, the other programs fit rather loosely (but not neatly within a layer) into the Session, Presentation, and Application layers.

“In the OSI Reference Model figure, only Internet-related programs are included in the Network and higher layers. OSI can also be applied to other network environments. A number of boxes under the Application and the Presentation layers do not fit as neatly into these layers as they are shown. A set of communication products that conformed fully to the OSI reference model would fit neatly into each layer.” (TechTarget.com)

Each of the seven layers in the OSI model have specific, though not necessarily exclusive, functions, interconnections and relevant protocols. Starting with layer one, and progressing successively through to layer seven, the following explications of network functions provide specifics of network communications.

Physical Layer (layer one)

The physical layer is concerned with transmitting raw data bits over a communication channel. The design issues include ensuring that when one side sends a bit of “1”, it is received as a bit of “1”, not as a bit of “0”. Typical issues are:

how many volts should be used to represent “1” and how many for “0”

how many microseconds a bit lasts;

whether transmission may proceed simultaneously in both directions;

how the initial connection is established, and how it is torn down when both sides are finished; and

how many pins the network connector has and what each pin is used for.

These design issues largely deal with mechanical, electrical, and procedural interfaces, and the physical transmission medium, which lies below the physical layer. Physical layer design can be properly considered to be within the domain of the electrical engineer.

And, as described on Whatis.com:

“Data-Link Layer (layer two)

“The Data Link Layer is the protocol layer responsible for providing reliable data transfer across a physical link (or telecommunications path) within a network. Data Link Control (DLC) is the service provided by the Data Link Layer.

“Many point-to-point protocols exist at the Data Link Layer including High-OSI layer Data Link Control, Synchronous Data Link Control, Link Access Procedure Balanced, and Advanced Data Communications Control Procedure. All of these protocols are very similar in nature and are found in older networks (such as X.25 networks). On the Internet, one of two point-to-point protocols are used at this layer: Ser. Line Internet Protocol or Point-to-Point Protocol (PPP) with PPP being the newer, approved standard. All of these protocols may be used in point-to-point connections such as those on a Metropolitan Area Network, a Wide Area Network backbone, or when dialing an Internet service provider from a home.

“In local area networks where connections are multipoint rather than point-to-point and require more line-sharing management, the Data Link Layer is divided into two sublayers: the Logical Link Control (LLC) and the Media Access Control (MAC). The LLC protocol performs many of the same functions as the point-to-point data link control protocols described above. The MAC protocols support methods of sharing the line among a number of computers. Among the most widely used MAC protocols are Ethernet (IEEE 802.3), Token Bus (IEEE 802.4), and token ring (IEEE 802.5) and their derivatives.

“The two Data-Link Layer sublayers are described in the IEEE-802 LAN standards and can be characterized as:

Media Access Control (MAC)

The MAC address on a network is a computer's unique hardware number. On an Ethernet LAN, it's the same as an Ethernet address. When connected to the Internet from a computer (or host, according to Internet protocol), a correspondence table relates your IP address to your computer's physical (MAC) address on the LAN. The MAC address is used by the Media Access Control sublayer of the DLC layer of telecommunication protocol. There is a different MAC sublayer for each physical device type.

Logical Link Control (LLC)

The LLC protocol performs many of the same functions as the point-to-point data link control protocols described above. The MAC protocols support methods of sharing the line among a number of computers. Among the most widely used MAC protocols are Ethernet (IEEE 802.3), Token Bus (IEEE 802.4), and token ring (IEEE 802.5) and their derivatives.

“The Data-Link Layer assures that an initial connection has been set up, divides output data into data frames, and handles the acknowledgements from a receiver that the data arrived successfully. It also ensures that incoming data has been received successfully.” (TechTarget.com)

Data frames are described on Whatis.com as:

“In telecommunications, a frame is data that is transmitted between network points as a unit complete with addressing and necessary protocol control information. A frame is usually transmitted serial binary digit (bit) by bit and contains a header field and a trailer field that “frame” the data. (Some control frames contain no data.)

“Here is a simple representation of a frame, based on the frame used in the frame relay access standard:

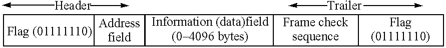

“In the figure above, the flag and address fields constitute the header. The frame check sequence and second flag fields constitute the trailer. The information or data in the frame may contain another encapsulated frame that is used in a higher-OSI layer or different protocol. In fact, a frame relay frame typically carries data that has been framed by an earlier protocol program.” (TechTarget.com)

Returning to the OSI Reference model of network functional layers:

“Network Layer (layer three)

“The Network layer knows the address of the neighboring nodes in the network, packages output with the correct network address information, selects routes, and recognizes and forwards to the Transport layer incoming messages for local host domains. Among existing protocols that generally map to the network layer are the Internet Protocol (IP) part of TCP/IP and NetWare IPX/SPX. Both IP Version 4 and IP Version 6 (IPv6) map to the network layer.” (TechTarget.com)

“Transport Layer (layer four)

“The Transport layer ensures reliable message arrivals and provides error checking mechanisms and data flow controls. The Transport layer provides services for both “connection-mode” transmissions and for “connectionless-mode” transmissions. For connection-mode transmissions, a transmission may be sent or arrive in the form of packet that need to be reconstructed into a complete message at the other end. The Transmission Control Protocol portion of TCP/IP is an example of a program that can be mapped to the Transport layer.” (TechTarget.com)

“Session Layer (layer five)

“The Session layer (sometimes called the “port layer”) manages the setting up and taking down of the connection between two communicating end points. A connection is maintained while the two end points are communicating in a session of some duration. Some sessions last only long enough to send a message in one direction, while other sessions may last longer, usually with one or both of the communicating parties able to terminate it.

“For Internet applications, each session is related to a particular port, a number that is associated with a particular upper layer application. For example, the HTTP program or daemon always has port number 80. The port numbers associated with the main Internet applications are referred to as well-known port numbers. Most port numbers, however, are available for dynamic assignment to other applications.” (TechTarget.com)

A description of the meaning of a daemon from whatis.com relates that:

“A daemon is a program that runs continuously and exists for the purpose of handling periodic service requests that a computer system expects to receive. The daemon program forwards the requests to other programs (or processes) as appropriate.” (TechTarget.com)

A description of the meaning of a port and a port number from whatis.com relates that:

“In programming, a port (noun) is a ‘logical connection place’. In the Internet's protocol, TCP/IP, a port is the way a client program specifies a particular server program on a computer in a network. Higher-OSI layer applications that use TCP/IP such as the Web protocol-Hypertext Transfer Protocol (HTTP)—have ports with preassigned numbers. These are known as ‘well-known ports’ that have been assigned by the Internet Assigned Numbers Authority. Other application processes are given port numbers dynamically for each connection. When a service (server program) initially is started, it is said to bind to its designated port number. When any client program wants to use that server, it also must request to bind to the designated port number.” (TechTarget.com)

Returning to the OSI Reference model of network functional layers:

“Presentation Layer (layer six)

“The presentation layer ensures that the communications passing through it are in the appropriate form for the recipient. For example, a presentation layer program may format a file transfer request in binary code to ensure a successful file transfer. Programs in the presentation layer address three aspects of presentation:

Data formats—for example, Postscript, ASCII, or binary formats

Compatibility with the host operating system

Encapsulation of data into message “envelopes” for transmission through the network

“An example of a program that generally adheres to the presentation layer of OSI is the program that manages the Web's Hypertext Transfer Protocol (Hypertext Transfer Protocol). This program, sometimes called the HTTP daemon, usually comes included as part of an operating system. It forwards user requests passed to the Web browser on to a Web server elsewhere in the network. It receives a message back from the Web server that includes a Multi-Purpose Internet Mail Extensions (MIME) header. The MIME header indicates the kind of file (text, video, audio, and so forth) that has been received so that an appropriate player utility can be used to present the file to the user.” (TechTarget.com)

“Application Layer (layer seven)

“The application layer provides services for applications that ensure that communication is possible. The application layer is not the application itself that is doing the communication. It is a service layer that provides these services:

Makes sure that the other party is identified and can be reached

If appropriate, authenticates either the message sender or receiver or both

Makes sure that necessary communication resources exist (for example, is there a modem in the sender's computer?)

Ensures agreement at both ends about error recovery procedures, data integrity, and privacy

Determines protocol and data syntax rules at the application OSI layer It may be convenient to think of the Application layer as the high-OSI layer set-up services for the application program or an interactive user.” (TechTarget.com)

Network Operating Systems

Computer networks utilize operating systems to execute their processes. A commonly used network operating system is the UNIX operating system, described on Whatis.com as:

“UNIX is an operating system that originated at Bell Labs in 1969 as an interactive time-sharing system. In 1974, UNIX became the first operating system written in the C language. UNIX has evolved as a kind of large freeware product, with many extensions and new ideas provided in a variety of versions of UNIX by different companies, universities, and individuals. UNIX became the first open or standard operating system that could be improved or enhanced by anyone. A composite of the C language and shell (user command) interfaces from different versions of UNIX was standardized under the auspices of the Institute of Electrical and Electronics Engineers as the Portable Operating System Interface (Portable Operating System Interface). In turn, the POSIX interfaces were specified in the X/Open Programming Guide 4.2 (also known as the “Single UNIX Specification” and “UNIX 95”). Version 2 of the Single UNIX Specification is also known as UNIX 98. The “official” trademarked UNIX is now owned by the The Open Group, an industry standards organization, which certifies and brands UNIX implementations.

“UNIX operating systems are used in widely-sold workstation products from Sun Microsystems, Silicon Graphics, IBM, and a number of other companies. The UNIX environment and the client/server program model were important elements in the development of the Internet and the reshaping of computing as centered in networks rather than in individual computers.” (TechTarget.com)

There are primarily two types of UNIX operating systems in use on computer networks. The two versions of UNIX descend from the original two versions:

System X_{R} Release X_{S} by AT&T Bell Laboratories (X_{R} and X_{S} being variables which refer to the edition of the system or release, respectively).

Berkeley Software Distribution UNIX by the University of California.

They originated from an original source at Berkeley and have since given rise to multiple brands including combined version with libraries that provide compatibility for both UNIX types. Various hardware platform manufacturers and other vendors provide support for both versions.

Unix Architectures

The first integrated network communications capability in UNIX was developed for Berkeley UNIX 4.2bsd, and is commonly known as the sockets implementation. A socket is the equivalent of a network address for a process. A user process (client) makes a system call to the OS to use the socket utility to connect to a server and provides the socket utility with a parameter stream which has all the necessary communication parameters (a typical example of the parameters are protocol, address of server, and port number), and the server process must concurrently be running a utility that is listening to the port—polling—to check the well known ports for system calls. A connection between sockets is made to start a session. As described on Whatis.com:

“Sockets is a method for communication between a client program and a server program in a network. A socket is defined as “the endpoint in a connection.” Sockets are created and used with a set of programming requests or “function calls” sometimes called the sockets application programming interface (API). The most common sockets API is the Berkeley UNIX C interface for sockets. Sockets can also be used for communication between processes within the same computer.

“The typical sequence of sockets requests from a server application in a ‘connectionless’ context, such as on the Internet, in which a server handles many client requests and does not maintain a connection longer than the serving of the immediate request is:

socket( )

|

bind( )

|

recvfrom( )

|

(wait for a sendto request from some client)

|

(process the sendto request)

|

sendto (in reply to the request from the client . . . for example, send an HTML file)

A corresponding client sequence of sockets requests would be:

socket( )

|

bind( )

|

sendto( )

|

recvfrom( )

Sockets can also be used for ‘connection-oriented’ transactions with a somewhat different sequence of C language system calls or functions.” (TechTarget.com)

The sockets implementation provides a programming interface for networking across different system architectures. The 4.2bsd kernel implements the equivalent of a connection of the data link through to the session layer (i.e., layer 2 through to layer 5) of the OSI Reference model. A kernel is described on the aforementioned resource Whatis.com as:

“The kernel is the essential center of a computer operating system, the core that provides basic services for all other parts of the operating system. A synonym is nucleus. A kernel can be contrasted with a shell, the outermost part of an operating system that interacts with user commands. Kernel and shell are terms used more frequently in UNIX and some other operating systems than in IBM mainframe systems.

“Typically, a kernel (or any comparable center of an operating system) includes an interrupt handler that handles all requests or completed I/O operations that compete for the kernel's services, a scheduler that determines which programs share the kernel's processing time in what order, and a supervisor that actually gives use of the computer to each process when it is scheduled. A kernel may also include a manager of the operating system's address spaces in memory or storage, sharing these among all components and other users of the kernel's services. A kernel's services are requested by other parts of the operating system or by applications through a specified set of program interfaces sometimes known as system calls.” (TechTarget.com)

Berkeley UNIX 4.2bsd Networking

Berkeley adopted an architecture based on sockets. They developed additional system calls and kernel service routines to provide comprehensive socket management. Berkeley also provided the File Transfer Protocol (FTP), User Datagram Protocol (UDP) for datagram service in the Internet domain, and the TELNET protocol for terminal emulation.

Protcol Utilizations

The Transmission Control Protocol (TCP) is an integral part of Berkeley UNIX 4.2bsd and 4.3bsd kernel implementations. Berkeley also implemented an Address Resolution Protocol (ARP) that maps TCP/IP addresses to Ethernet 802.3 addresses, providing a convenient local area network interface. The TCP corresponds to OSI layer four, controls data transfer for end-to-end service, and establishes a connection when two processes need to communicate. Additionally, binding establishes a link between a process and a socket, and through TCP maintains information about each connection, including sockets at both ends, data segment sequence numbers, and window sizes. TCP connections are full duplex, and achieve substantial transmission reliability through the use of sequence numbers for data segments. In particular, transmission reliability is ensured since, if a particular segment is not received, the segment is re-transmitted.

The Internet Protocol (IP) roughly corresponds to OSI Layer 3 and has responsibility for datagram service across a network with Berkely UNIX. The IP header is used to provide the address of the sender and the receiver as well as other options. is used to provide addressing and data fragmentation, inter alia, breaking up data into smaller chunks called datagrams and adding the Internet address of the destination for the datagram to the Internet header. The use of the IP provides type of service, time to live (time limit for delivery), options (time stamps, security, routing), and header checksum.

System Calls and Utilities

As described in whatis.com:

“A utility is a small program that provides an addition to the capabilities provided by the operating system. In some usages, a utility is a special and nonessential part of the operating system. In other usages, a utility is an application that is very specialized and relatively limited in capability.” (TechTarget.com)

The Berkeley 4.2/4.3bsd UNIX OS implements 17 system calls for use with the socket interface. It brought over the FTP for reliable file transfer and the TELNET protocol for remote terminal emulation from the ARPA network which preceded the Internet. Berkeley also implements the system calls rpc (remote procedure call) and rlogin (remote login) as replacements for trusted hosts, and further provided rsh (remote shell) for the UNIX system.

AT&T UNIX System V Streams and RFS

The AT&T Streams architecture is a layered architecture. The streams are interfaces between the protocol layers and the UNIX kernel. The layered architecture provides the capability to implement different protocols with the same Streams interface. The interfaces are implemented as a set of new system calls at the sessions layer of the OSI model, and as a set of Streams interface modules, such as a streams header or streams driver, that comprise the presentation layer between the user's application and the system calls. The Remote File System (RFS) is a utility provided with AT&T UNIX System V.3 that uses the Streams interface. This allows the use of any network protocol and makes RFS independent of the type of network hardware or software. The RFS implementation also supports a Transport Layer Interface (TLI) for low-level access to networking for system applications. The Streams Interface is called in the same manner as any other communications interface—with a set of system calls that are serviced by kernel service modules.

A stream has three parts: a Stream head, optional processing modules, and a driver (also called a Stream end). The Stream head provides the interface between the Stream and user processes at the application layer. One or more modules (optional) process data that travels between the Stream head and the driver. An example of a processing module and its action is canonical conversions in a TTY driver. The driver may be a device driver, providing communications or other I/O services from an external device, or an internal software driver, commonly called a pseudo-device driver.

By using a combination of system calls, kernel routines, and kernel utilities, the streams interface passes data between the driver and the Stream head in the form of messages. Messages that pass from the Stream head toward the driver travel downstream, and messages in the opposite direction travel upstream. These messages contain data passed between the user space and the Streams data space in the driver.

### System Calls and Utilities

Streams provide a simple interface through system calls. The system calls include:

| | |
|---|---|
| 1. open | Create a Stream to the specified driver; |
| 2. close | Dismantle a specified Stream; |
| 3. read | Receive data from a Stream; |
| 4. write | Send data to a Stream; |
| 5. ioctl | Provides a push protocol control module for |
| | a particular device in Streams stack; |
| 6. getmsg | Receive Data and Control message to Stream; |
| 7. putmsg | Send Data and Control message to Stream; |
| 8. poll | Notify application program when selected |
| | event occurs on a Stream. |

The RFS provides transparency between remote and local file systems. The user process uses the RFS to access a file on another system without having to know the details of accessing the file and maintains security and integrity of the system for concurrent file access. The RFS provides this capability while retaining the normal UNIX file system semantics. The UNIX adv command sends a message to the name service node that it is making files available as a server. The mount command allows administrators on the client system to make a remote file system available for use locally in a transparent manner. A network connection is set up between the client and the server consequent to a mount command. The server keeps track of how many remote users have a file open at a given time and it maintains security by distinguishing between local opens and remote opens. Remote access can be restricted to the privileges of selected local accounts.

Network File Systems (NFS)

The SUN Micro-systems Network File System (NFS) is supported on a number of UNIX implementations. NFS supports transparent network-wide read and write access to files and directories. Workstations or disk file servers export selected file systems to the network to make them sharable resources. Workstations import file systems to access files.

The base protocol for the Sun Microsystems UNIX implementation is TCP/IP. The divergence from the Berkeley implementation of TCP/IP occurs at the Session layer where Sun has implemented Remote Procedure Calls (RPC). Sun layers the RPC on top of the TCP/IP socket interface. RPC allows communications with remote services in a manner similar to procedure calling mechanisms of procedural programming languages. At the Presentation layer, the Sun implementation has defined the External Data Representation (XDR). The XDR definition allows different machines to communicate, despite variations in their data representations, by standardizing network data representation. XDR translates data to the standard representation before sending to the network.

The NFS implementation also includes the implementation of a virtual file system (VFS) that uses vnodes to separate file system operations from the semantics of the implementation. An extension of the standard mount command of UNIX 4.2bsd allows network users to mount files for shared access. The exportfs command exports file systems to the network. NFS, called a client/server architecture, designates the exporting file system as the server and the importing file system as the client.

Additionally, the ISO selected the IEEE Ethernet 802.3 standard for the physical link and data link layers. Table 2 below describes the OSI Reference model mapping of network software for three UNIX operating systems.

TABLE 2
Mapping of Network Software Categories
to OSI Reference Model Layers

| | AT&T UNIX | | Sun |
|---|---|---|---|
| OSI Model | System | Berkeley UNIX | Microsystems |
| Layer | V.3 | 4.3bsd | 4.3bsd |
| Application | RFS | Application Using | NFS, Application |
| | Application Using | Sockets | Using Sockets, |
| | Streams | FTP, TELNET, | FTP, TELNET |
| | | rlogin | rlogin |
| Presentation | Stream Modules | Library Routines | XDR (Extended |
| | (Transport Library) | | Data |
| | | | Representation) |
| Session | New System Calls | New System | Remote Proce- |
| | for Streams | Calls to Im- | dure Calls |
| | | plement Sockets | And Sockets |
| Transport & | Protocol Modules | TCP | TCP or Network |
| Network | for TCP/IP, XNS, | IP | Disk Protocol |
| | SNA, OSI | | IP |
| Data Link & | Ethernet | Ethernet | Ethernet |
| Physical | (IEEE 802.3) | (IEEe 802.3) | (IEEE 802.3) |
| | Token Ring, SNA | Address | Address |
| | | Resolution | Resolution |
| | | Protocol | Protocol |

### SUMMARY OF THE INVENTION

The present invention is a Network Surveillance and Security System for monitoring and protecting a computer network. The Network Surveillance and Security System combines an artificial intelligence capability with communication resources. In this context, artificial intelligence is described in whatis.com as:

“Artificial intelligence (AI) is the simulation of human intelligence processes by machines, especially computer systems. These processes include learning (the acquisition of information and rules for using the information), reasoning (using the rules to reach approximate or definite conclusions), and self-correction. One application of AI is referred to by the term ‘expert system’.” (TechTarget.com)

In this context, an expert system is described, also in whatis.com, as:

“An expert system is a computer program that simulates the judgement and behavior of a human or an organization that has expert knowledge and experience in a particular field. Typically, such a system contains a knowledge base containing accumulated experience and a set of rules for applying the knowledge base to each particular situation that is described to the program. Sophisticated expert systems can be enhanced with additions to the knowledge base or to the set of rules.” (TechTarget.com)

The Network Surveillance and Security System includes a knowledge base which encompasses what is presently known about the network's operations. The knowledge base includes the network's intended operations and what is known of past attempts to either damage the network's operations or have it operate other than as intended. The Network Surveillance and Security System also possesses a learning capacity for expanding its knowledge base. The present invention is further capable of communicating over publicly accessible networks with other Network Surveillance and Security Systems. These communications with other Network Surveillance and Security Systems can include aspects of the present operational security status of the network as well as additions to its knowledge base. Among these additions may be recent changes in operations, details of newly encountered events, effects of newly encountered events on operations, plus responses by the Network Surveillance and Security System and the results of these responses. Encryption preserves the privacy of these communications. Further ensuring the communicated knowledge's confidentiality is a proprietary encryption system, exclusive to the Network Surveillance and Security System.

The Network Surveillance and Security System monitors local area network (LAN) traffic in real-time. Wide area network (WAN) traffic seeking access to the protected network is monitored both in real-time and in intervals. The invention protects both network based systems and internal system storage devices.

The Network Surveillance and Security System monitors all communication traffic within at least one section of a network where any type of communication protocol is functioning within a communication domain. According to whatis.com:

“In computing and telecommunication in general, a domain is a sphere of knowledge identified by a name. Typically, the knowledge is a collection of facts about some program entities or a number of network points or addresses. On the Internet, a domain consists of a set of network addresses.” (TechTarget.com)

Ethernet protocols are, by design, broadcast protocols in which every host on a selected section of a network receives the broadcast. As described in whatis.com for Internet environments, though also applicable for network environments in general:

“On the Internet, the term ‘host’ means any computer that has full two-way access to other computers on the Internet. A host has a specific ‘local or host number’ that, together with the network number, forms its unique IP address. If you use Point-to-Point Protocol to get access to your access provider, you have a unique IP address for the duration of any connection you make to the Internet and your computer is a host for that period. In this context, a ‘host’ is a node in a network. ” (TechTarget.com)

In a surveillance mode, the Network Surveillance and Security System samples and analyzes data packets destined for host computers. The analysis of data packets determines if the packet originates from an authorized user of the host or group of host computers under surveillance.

Functioning as a security guard for business-to-business (B2B) Internet portals is one feature of the Network Surveillance and Security System. The Network Surveillance and Security System variously guards by surveying host port connections, detecting and disconnecting unauthorized intrusions, alerting the network administrators, and identifying the source of the intrusion. The monitoring involves checking the source address of a signal source seeking access to the network against a database of authorized users. If the source address is not in the database, the Network Surveillance and Security System denies connection to the network to preempt possible threats.

The Network Surveillance and Security System uses artificial intelligence to detect and analyze attacks on servers in the protected network. The artificial intelligence determines attack patterns and the event sequences preceding an attack. Among the components of the Network Surveillance and Security System's artificial intelligence are knowledge-based tools comprising inference engines, genetic learning algorithms, and a neural network. As described in wbatis.com:

“Genetic programming is a model of programming in which programs compete to survive or cross-breed with other programs to continually select the most effective programs that approach closer to the desired result. Genetic programming is appropriate for problems with a large number of fluctuating variables such as those related to artificial intelligence.” (TechTarget.com)

With artificial intelligence, the Network Surveillance and Security System is able to actively expand its recognition of different types of attack. Artificial intelligence also improves the ability of the Network Surveillance and Security System to make predictions about the nature of a new encounter and project the outcomes of differing countermeasures.

Among the general benefits of the Network Surveillance and Security System is an unimpeded network traffic flow. The present invention does not delay network operations or activities. In addition, technicians can install the Network Surveillance and Security System without alterations to existing software or configuration files. The invention is generally hosted on a machine that is added to the protected network. Another beneficial aspect of the present invention is that the continually expanding knowledge base enables a human network administrator who is not a security expert to effectively supervise a network's protection.

Architecture of the Network Surveillance And Security System

The organization of the Network Surveillance and Security System is described herein as a structure of layers. These are abstract layers of UNIX processes which relate functionally, but are not limited to interacting exclusively with the other layers they border in the organizational description. On a physical level, all of the processes are essentially the same—an organized group of electrical impulses traveling across circuits and switches. The processes are best understood in terms of their functionality and contents. It is the interrelations of these functions and contents which are reflected in the following desciption of the organization of the Network Surveillance and Security System.

Understanding of the interrelations of the processes of the Network Surveillance and Security System can be aided by drawing an anology to a person playing chess. In describing an individual's understanding of the game of chess, a natural approach would be to also describe their understanding at different abstract levels. A first level may be a perceptual recognition of what constitutes a game board and the pieces used. A second level could be the rules of the game of chess. A third level could be specific tactical approaches to particular combinations of moves and a fourth level could be overall strategies for various attacks or defenses. Certain thought processes would be relevant to particular levels but would not be restricted to application at just those levels or even excusively in the realm of chess. An approach to solving a problem of chess strategy could also be applicable to planning a political campaign. Still, at the physical level, all thought processes are essentially identical—an organized group of electrochemical impulses traveling across neurons and synapses.

The various processes which comprise the Network Surveillance and Security System are interrelated by function and content according to an organizational plan. However, an algorithm which is developed in one context may be utilized by any process in any context, when found useful. Hence, the following structural descriptions should be seen as not a structure in the sense of bricks stacked upon each other, but rather as a structure which provides comprehension, efficiency of operation, and functional organization.

Following is the Architecture of the sub-layers which compise the four layers of the Network Surveillance and Security System.

I. EXPERT SYSTEM SECURITY INTELLIGENCE LAYER-
Executive Program

Inference Engine Sub-Routine

```
1. Knowledge Base Executive
2. Intrusion Detection Knowledge
  Layer
3. Intelligence Search Engines
4. Intelligence Sorting Engines
5. Attack sequence Knowledge
  Base
6. Communication Utilities
  Knowledge Base
I.A. Neural Network Sublayer
  Executive Program &
  Algorithms
I.A.1 EVENT LEARNING
  Knowledge Representation
  Observations
  Rules
I.A.2 NEURAL ARTIFICIAL
INTELLIGENCE
  Knowledge Representations
I.A.2.a Representations
  Theorems
  Facts
I.A.2.b Reasoning
  Observations
  Rules
I.A.2.c Learning
  Theorems
  Facts
  Observations
I.A.3 NEURAL NETWORK
SECURITY
ALGORITHMS
I.A.3.a Neuron Models
  Rules
I.A.3.b Symbolic
Representations
  Networks
  Constellations
  Systems
I.B. Genetic Programming
  Sublayer
  Executive Program &
  Algorithms
I.B.1 RESEARCH
FUNCTIONS
  Features (inputs)
  Classes (outputs)
I.B.1.a Training Domains
  Features (inputs)
  Classes (outputs)
I.B.1.b Learning Domains
  Features (inputs)
  Classes (outputs)
I.B.2 ACCEPTANCE &
VALIDATION
  Features (inputs)
  Classes (outputs)
I.B.2.a Learning Domains
  Features (inputs)
  Classes (outputs)
I.B.2.b Testing Domains
  Features (inputs)
  Classes (outputs)
I.B.3 MACHINE LEARNING
ALGORITHMS
  Features (inputs)
  Classes (outputs)
I.B.3.a Training Domains
  Features (inputs)
  Classes (outputs)
I.B.3.b Acceptance &
Validation
  Features (inputs)
  Classes (outputs)
```

II. COMMUNICATION SYSTEM LAYER (CSL)
CSL EXECUTIVE PROGRAM

| II.A Neural Network information Routing | | | II.B Genetic Programming Information | | |
|---|---|---|---|---|---|
| | | | Routing | | |
| II.C.1.a | ROUTING | II.C.2.a | BASIC SECURITY | II.C.3.a | COMMAND |
| | CONVERSIONS | | PROCESSES | | PROCESSES |
| i. | Expert | | Translators & | | Translators & |
| | Personalities | | Converters | | Converters |
| | Information | | | | |
| ii. | Translators & | | | | |
| | Converters | | | | |
| II.C.1.b | NEURAL | II.C.2.b | CONSTELLATION | II.C.3.b | GENETIC |
| | NETWORK | | SERVERS | | PROGRAMMING |
| | Process Control | | Process Control | | Process Control |
| | Communication | | Communication | | Communication |
| II.C.1.c | NEURAL | II.C.2.c | CONSTELLATION | II.C.3.c | GENETIC |
| | NETWORK PROCESS | | PROCESS | | PROCESS |
| | MANAGEMENT | | MANAGEMENT | | MANAGEMENT |
| i. | UNIX | i. | UNIX | i. | UNIX |
| ii. | Expert System | ii. | Constellation | ii. | Expert System |

III. COMMUNICATION INFRASTRUCTURE AND INTERFACE LAYER (CIIL)
CIIL EXECUTIVE PROGRAM

| | |
|---|---|
| III.A Storage System Executive Program | III.B Network Interface Executive Program |

| | | |
|---|---|---|
| III.C.1 | III.C.2 | III.C.3 |
| EXPERT PERSONALITIES | BASIC SECURITY | COMMAND PROCESSES |
| | PROCESSES | |
| III.C.1.a | III.C.2.a | III.C.3.a |
| UNIX File System Utilities | Communication utilities | UNIX Control Utilities- |
| | | Version |
| UNIX Commands | Encryption Executive | BSDU Commands |
| BSD4.4 Commands | Program | FreeBSD |
| SVR4 Commands | | IBM-AIX |
| | | SVR4 Commands |
| | | HP-ULTRIX |
| | | Linux |
| | | Solaris |
| | | Digital Unix |
| III.C.1.b | III.C.2.b | III.C.3.b |
| Databases | Process Control | Hardware Interfaces Control |
| | Management | Program |
| i. Security Reference | i. Interprocess | Message Channels |
| Database (SRD) | Communication (IPC) | Ethernet |
| Intrusion Reference | Pipes | Token Ring |
| Data | Named Pipes | FrameRelay |
| Attack Sequences | STREAMS | ATM |
| Data | Sockets (internal) | BroadCast (M-Bone) |
| | Socket (external) | RS-232 |
| | | V35 |
| ii. Security Reference | ii. Domain Control | |
| Model(SRMD) | Program | |
| | Local | |
| | Internet | |
| iii. Security Reference | | |
| Monitor (SRMN) | | |
| iv. Security Authorization | | |
| Database (SAD) | | |
| v. Authorization Access | | |
| Model (AAM) | | |
| Authorization | | |
| Profile (AP) | | |
| Unauthorized | | |
| Profiles | | |
| III.C.1.c | III.C.2.c | III.C.3.c |
| Rule Based Personalities | Security Access | Portmon (PM) Executive |
| System | Controller Executive | Program |
| i. God Process | i. Constellation | Routers/Firewalls |
| | Access Record | Access Record Logger |
| | 10 Logger (CARL) | (RECarl) |
| | Address Mapper | Address Mapper |
| | (CAM) | (RFCam) |
| | Port Monitor & | Port Monitor & |
| | Controller | Controller |
| | System Logger | System Logger |
| | (SYSLgr) | (RFSYSLgr) |
| ii. Demon Process | ii. File System Watch Dogs | |
| | root file system | |
| | guard | |
| | user-bin guard | |
| | slash-etcetera guard | |
| | slash-bin guard | |
| | File Permission | |
| | Guards | |
| | File Access Guards | |
| iii. Support Team | iii. Directory Watch Dogs | |
| | Group Permission | |
| | Guards | |
| | Directory Access | |
| | Guards | |
| iv. Surveillance Intelligence | | |
| Forces (SIF) | | |
| Servants | | |
| Knights and Spies | | |
| Agents | | |
| Archangels | | |
| Angels | | |
| v. Military Intelligence | | |
| Army | | |
| Captain | | |
| Lieutenants | | |
| Sergeants | | |
| Corporal | | |
| Constellation Guards | | |
| Infantry Server Guards | | |

IV. PLATFORM SYSTEM LAYER (PSL)
Executive Program

| | |
|---|---|
| IV.A BSD 4.4 Operating System | IV.B AT&T SVR4 Operating System |
| Interface Commands | Interface Commands |

IV.C. UNIX PRODUCTS

| | | |
|---|---|---|
| IV.C.1 BSD UNIX | IV.C.2 BSD and AT&T | IV.C.3 AT&T UNIX |
| | UNIX | |
| IV.C.1.a | IV.C.2.a | IV.C.3.a |
| FREEBSD | SOLARIS | AT&T SYSTEM |
| | | V R 3 |
| IV.C.1.b | IV.C.2.b | IV.C.3.b |
| BSDI | HP-ULTRIX, | AT&T SYSTEM |
| | IBM-AIX | V R 4 |
| IV.C.1.c | LV.C.2.c | IV.C.3.c |
| LINUX, | IRIX 5.X, IRIX 6.X | DEC-UNIX |
| SUN OS 4.X | | |
| IV.C.1.d | IV.C.2.d | IV.C.3.d |
| SUN OS 3.X | DIGITAL UNIX | VM/MVS-UNIX |

Network Surveillance and Security System Functions

The previously described general operations of the Network Surveillance and Security System are accomplished by the following functions.

(A) Security Audits

The Network Surveillance and Security System continuously audits a protected constellation of servers which comprise the section of the network under guard. Access log information of each server's internal and external communication traffic is audited. Among the information in the log are user activities, access requests, and attempted security breaches. The Security System performs auditing on a non-stop, around the clock basis. The auditing process of all network traffic enables analysis of traffic patterns. The traffic pattern analysis identifies customary, acceptable patterns and weighs newly encountered patterns to determine if they deviate from the standards. Detection of unusual traffic patterns is one source the Network Surveillance and Security System learning function can use to expand its knowledge base.

Monitoring of Internet servers within a protected constellation by the Network Surveillance and Security System detects attacks which advance beyond a firewall. As described in whatis.com:

“A firewall is a set of related programs, located at a network gateway server, that protect the resources of a private network from other users. (The term also implies the security policy that is used with the programs.)

“A firewall works closely with a router program to filter all network packets to determine whether to forward them toward their destination. A firewall also includes or works with a proxy server that makes network requests on behalf of workstation users.” (TechTarget.com)

All traffic within the internal (LAN) network infrastructure is audited for unauthorized entries. Subsets of the Ethernet datapackets that indicate identifying information such as the source IP address are monitored by the Network Surveillance and Security System. These subsets are termed Sniplets and are used to identify and track packets in the LAN traffic.

Process Surveillance and Analysis

Previously, surveillance systems have only observed traffic crossing over ports. Surveillance of traffic native to the network itself has not generally been done. The Network Surveillance and Security System conducts surveillance and analysis of all native and non-native network processes.

(B) Knowledge Base Analysis

The Network Surveillance and Security System utilizes the knowledge base to complete the security audits in the following manner:

Each Ethernet frame is decomposed into component sniplets and analyzed in a stateful manner to determine if services are being requested from authorized source addresses.

Each Internet Protocol (IP) packet is decomposed into components termed IP-sniplets and analyzed in a stateful manner to determine if the IP address of the sender is an authorized client of the requested server.

As described in whatis.com:

“‘Stateful’ and ‘stateless’ describe whether a computer program is designed to note and remember one or more preceding events in a given sequence of interactions with a user, another computer or program, a device, or other outside element. Stateful means the computer or program keeps track of the state of interaction, usually by setting values in a storage field designated for that purpose. Stateless means there is no record of previous interactions and each interaction request has to be handled based entirely on information that comes with it. (Computers are inherently stateful in operation, so these terms are used in the context of a particular set of interactions, not of how computers work in general.)

“The Internet's basic protocol, the Internet Protocol (IP), is an example of a stateless interaction. Each packet travels entirely on its own without reference to any other packet. (The upper layer Transmission Control Protocol—TCP—does relate packets to each other, but uses the information within the packet rather than some external information to do this.) The World Wide Web's Hypertext Transfer Protocol (HTTP), an application layer above TCP/IP, is also stateless.

“In order to have stateful communication, a site developer must furnish a special program that the server can call that can record and retrieve state information.

“In formal protocol specifications, a finite state machine is an abstract desciption of how a stateful system works that describes the action that follows each possible state. ” (TechTarget.com)

The security audit results are used by the Network Surveillance and Security System to determine if a particular connection is permitted. The Network Surveillance and Security System uses four parameters to authenticate the user's authorization:

1. Time of connection;

2. Destination and login server including the USERID;

3. Originating signal source address and portal information including:

IP address, Ethernet (or MAC) address, authorization, source network address, and source machine address (from the MAC address);

4. Content monitoring of original connection request including login patterns.

(C) Learning and Updates to Expand Knowledge Base

The Network Surveillance and Security System uses artificial intelligence to expand its knowledge base by learning from new events. The Expert System Security Intelligence Layer of the present invention performs the learning with subcomponents that employ various algorithms. In protecting the network against attacks, these subcomponents produce a dynamic response to changes in attack sequences during an attack. A specialized database algorithm, designed to provide a linked list data structure of “attack sequences,” records gathered information from prior attacks. The database algorithm is based upon an inference engine's references to past events and correlations with neural network algorithms' learning patterns. This algorithm then stores the gathered information after having performed a series of analytical transactions on each new attack sequence.

Within the Expert System Security Intelligence Layer, there is an Event Learning subcomponent that gains knowledge from observation of the network. Event Learning observes the network's current state of security and incorporates information of a new outcome state that results from an initial known state of security encountering an event which has the potential to change that initial known state.

Network Surveillance and Security Systems can also cooperate with each other to share new additions to the knowledge base, such as previously unencountered attack sequence data. Separate Network Surveillance and Security Systems can thus inform and update each other—see function (F) following. A novel encryption component of the present invention—detailed in (E) following—enables confidential communication of characteristics of new encounters over public communication channels. Conventional, unencrypted information communication means can also be utilized for expanding knowledge bases through shared information, with the new information then also contributing to subsequent auditing, analysis, and learning.

(D) Responses & Countermeasures

If an unauthorized access attempt or attack on a protected network occurs, the present invention is also able to conduct countermeasures such as deactivating the port from which a prohibited signal is entering. In addition, the Network Surveillance and Security System can notify the network administrator that a prohibited event is occurring. Among the various types of responses by the Network Surveillance and Security System are:

(E) Secured Remote Access

With the Network Surveillance and Security System, a network can communicate over an encrypted remote access channel. Hence, a network with the NS&SS which communicates over the Internet or any public WAN can achieve an equivalent degree of security as is available over a completely private communication channel, without the infrastructure expense and network management overhead. The NS&SS enables secure communication over the Internet without a need to regulate the connections or overtly authenticate the user. A secure intranet can thus be constructed using non-private communication channels. Additionally, the present invention can be used for secure communications with others outside of the intranet, to ensure authentication and confidentiality. The Network Surveillance and Security System further provides, when the network is connected to an outside party: background monitoring of transactions directed towards company resources through applications at OSI layer 7, monitoring of connection times to those resources, and monitoring of connection ports.

Privisea™ is a novel encryption machine that provides enhanced confidentiality for communication over publicly accessible channels is a further optional feature of the Network Surveillance and Security System. Privisea™ is a proprietary encryption machine exclusively available to owners of the Network Surveillance and Security System. Since only these owners have access to its encryption functions, the certainty of communication confidentiality is enhanced. A key exchange mechanism of the Privisea™ encryption machine enables separate Network Surveillance and Security Systems protecting different networks to communicate and function cooperatively.

Privisea™ is a sub-function of the Network Protocol Center. The Network Surveillance and Security System is compatible with all historic and current protocols that use the IEEE 802.3 standards. The Network Surveillance and Security System is further compatible with Fast Ethernet (100 BASE-T) and Gigabit Ethernet protocols; and in general is compatible with all protocols that route TCP/IP and SNA by IBM. Privisea™ encrypts communications with keys up to 1024 bits and conducts key management across any public or private communication channels. Privisea™ has the capacity to encrypt and decrypt information prior to decomposing it into data packets and transporting it across the Internet, any public network, or a network sector outside the protected area.

(F) Communication of Expanded Knowledge Base

As described in C above, Network Surveillance and Security Systems can immediately exchange updates to each other's Intruder Databases. The shared information enables a protected constellation to even prevent never previously encountered intrusions and attacks. The intrusion prevention can protect one portion of a network from a previous attack on a different portion. The sharing of intrusion prevention information can also enable a Network Surveillance and Security System to profit from the detection and analysis of attacks on a different network. Intrusion prevention information encompasses both the diversity of attack patterns as well as event sequences leading up to an attack. Comprehensive database updates containing intrusion information compiled from all active Network Surveillance and Security Systems will also be available.

Objectives

The components of the Network Surveillance and Security System, both individually and in combination, provide novel network security protection functions. The present invention provides innovative capabilities that are executed in response to a range of concerns that can effect network security. A first group of novel functions is generally applicable across the extent of network security concerns. These generally applicable benefits include:

The protection functions of the Network Surveillance and Security System operate autonomously of attention from a system administrator or operator, as well as autonomously of any actions by a user of the network under protection.

The Network Surveillance and Security Systems are able to update their protective capabilities.

These updates enable the present invention's functions to improve in response to ongoing events. The updates can occur through use of an encrypted communication channel between separate Network Surveillance and Security Systems. The updates can also be self-generated through an artificial intelligence capacity. Additionally, these updates, both self-enacted by individual Network Surveillance and Security Systems and between communicating Network Surveillance and Security Systems, can occur autonomously.

The Network Surveillance and Security System deploys a novel Process Fingerprinting procedure. The Fingerprinting of processes uses information garnered from monitoring of process Ethernet addresses cross-referenced with process IP addresses. The garnered information is used by the Network Surveillance and Security System to assign every process that is operational in the Protected Server Constellation a unique identifier termed a Process Fingerprint. The Process Fingerprints enable a comprehensive accounting and tracking of the characteristics of every operational process.

A second group of novel functions is in the area of applications of artificial intelligence for the protection of a network's security. The applications of artificial intelligence variously provide functions which are either individually novel or provide novelty through unanticipated combinations of artificial intelligence functions.

A first novel combination of artificial intelligence (AI) functions for protecting network security includes:

Using artificial intelligence to manage the way learning algorithms model information processes with communication theory paradigms.

Using artificial intelligence learning algorithms to model information processing by UNIX processes. The AI learning algorithms conduct the modeling of UNIX processes with genetic programming and genetic machine learning programs.

Applying AI Genetic Programming that is capable of both self-initiated and self-controlled reprogramming.

Applying Al Genetic Reasoning that is capable of modeling information relating to new events by an examination of information relating to known events. The modeling develops an understanding of new events based on simulations of the known events.

Using Al Genetic Evolution and Co-Evolution for modeling different generations of UNIX utilities used for security protection. The different generations compete for success at protecting security. The survival of the most fit models enables continuous expansion and optimization of the present invention's capabilities to protect the security of the network.

Developing separate populations of problem solving processes by application of co-evolution. Determining the fitness of the constituents of the separate populations. Basing the determination of the constituents fitness on their ability to accomplish specified results. Executing the fitness determinations based on prior observations of network events.

Using self-correcting AI Algorithms to enable the Network Surveillance and Security System to continuously expand and improve its security protection in response to ongoing events.

A second novel combination of AI functions for protecting network security includes:

Using artificial intelligence to model information processes with communication theory paradigms.

Expert System analyzing of dynamic security events in real-time.

Scheduling of processes according to the Digital UNIX real-time process scheduling scheme.

Applying inference approaches to model intruder motivations against systems security policies and customer security policies.

Adapting security AI dynamically in response to ongoing events. The AI adaptations occurring autonomously and being self-directed by the Network Surveillance and Security System.

Learning, when needed, of new attack sequences and adding the learning to a verified compendium of attack sequences.

Testing of new attack sequences against a knowledge base to compare the newly learned knowledge to prior theorems and known facts.

Refining of knowledge base definitions of attack sequences and intrusion detections with the newly learned knowledge.

Updating the knowledge base continuing log of events with facts relating to attacks to enhance automatically protecting against future attacks.

A third novel combination of Al functions for protecting network security includes:

Applying AI neural network theorems to model representations of internet and local area network security knowledge to construct various knowledge bases.

Developing self-generating, knowledge-incorporating AI neural networks to model simulations of logical operations involved in securing computers against security threats.

Applying Al Genetic Programming and Neural Network sub-systems to the maintaining of information security against dynamic threats.

Applying genetic programming and neural network algorithms to simulate internetworking security intelligence (“Internetworking” referring to LAN's connecting to other LAN's across WAN's, as well as to subnets—a portion of a LAN or a WAN—connecting to a subnet or a LAN across a WAN). Creating an internetworking knowledge base and observing internet and internetworking security policies violations in real-time.

Modeling AI Neural Networks to construct symbolic representations of UNIX utilities designed to protect computer systems against information security threats.

Designing self-generating, knowledge-incorporating Neural Networks comprised of simulated neurons to learn, in real time, knowledge relating to dynamic security threats against computer security policies.

Characterizing computer security threats by establishing states representing current system security. The current states are based upon past system security states and enable the Neural Network to predict future system security states.

A fourth novel combination of AI and other functions for protecting network security includes:

Monitoring of multiple packets at TCP Ports in real-time.

Broad platform coverage of a wide range of machines compising a protected network, as well as of a wide range of UNIX varieties running in the network.

Network and host based security protection.

Generating of alerts and reports to system administrators and site officials.

Enables administration by a non-expert system administator

Both stand-alone and interactive operations are self reliant.

Real-time monitoring of appropriate events.

Interval Based monitoring of appropriate events.

Statistical Anomaly Detection of long-term patterns of intrusive behavior.

Pattern Matching Detection.

Collecting of newly encountered attack sequence information.

Learning of newly encountered attack sequence information.

Analyzing of firewall logs for intrusion detection.

Analyzing of system logs for intrusion detection.

Updating and replacing as warranted of firewall filters.

Coordinating and communicating of information relating to attack encounters between Network Surveillance and Security Systems.

A fifth novel combination of AI and network based security protection functions includes:

Eliminating the need for interactive network and security administration.

Supporting network based security policies.

Analyzing packet contents statefully using information from packet headers.

Analyzing statefully the contents of Ethernet packet headers.

Analyzing statefully the contents of IP packet headers.

Analyzing statefully the contents of TCP packet headers.

Analyzing statefully the Session ID and protocol layer information from Packet Header contents.

Monitoring of all connections to TCP and UDP ports for unauthorized activities.

A sixth novel combination of AI and system based security protection functions includes:

Monitoring of failed login attempts.

Detecting of system(s) use contrary to administrative policies.

System network traffic monitoring

System internal resource authorizations administration

System external resource authorizations administration

Constellation internal resource authorizations administration

A seventh novel combination of security protection functions which concern Protected Constellations internal resource authorizations includes:

Detecting and locking of weak accounts.

Monitoring of file systems.

Monitoring to protect file ownership.

Monitoring of file security.

Monitoring to protect directory ownership.

An eighth novel combination of security protection functions monitors a Protected Constellation's TCP ports and connections made at those ports. Connections are initially made at the well-known ports. After the connection is made, the ongoing communication is then routed to other, less well-known ports. The Network Surveillance and Security System continues to monitor the connections both over the well-known ports and subsequently, over the less well-known ports. The monitoring of the processes which comprise the connections throughout their existence is an unprecedented security protection capability. Following is a roster of the well-known TCP ports which are monitored:

| TCP Port | Service Name |
|---|---|
| 7 | echo |
| 9 | discard |
| 13 | daytime |
| 19 | Character generator |
| 21 | File Transfer Protocol |
| 23 | Telnet |
| 25 | SMTP |
| 37 | time |
| 42 | nameserver |
| 43 | who is |
| 53 | domain Name Service |
| 79 | finger userinformation |
| 80 | http for WWW |
| 109 | POP2 |
| 110 | POP3 |
| 111 | Sun RPC remote procedure Calls |
| 113 | Authentication service |
| 119 | Network News |
| 178 | NeXTSTEP Window Server |
| 512 | exec Execute Commands on remote UNIX host |
| 513 | login login on remote UNIX host |
| 514 | shell Retrieves shell from Remote UNIX host |
| 515 | printer Remote Printing |
| 2049 | NFS NFS over TCP |

An ninth novel combination of security protection functions monitors a Protected Constellation's user defined ports (UDP) and connections made at those ports. Connections are initially made at the well-known ports. After the connection is made, the ongoing communication is then routed to other, less well-known ports. The Network Surveillance and Security System continues to monitor the connections both over the well-known ports and subsequently, over the less well-known ports. The monitoring of the processes which comprise the connections throughout their existence is an unprecedented security protection capability. Following is a roster of the well-known UDP ports which are monitored:

| TCP Port | Service Name |
|---|---|
| 37 | time |
| 53 | domain |
| 69 | tftp trivial FTP |
| 111 | Sun Remote Procedure Calls port mapper |
| 123 | Network time protocol |
| 161 | Simple Network Management Protocol |
| 512 | biff incoming mail alert |
| 513 | who—Returns who is logged on system |
| 514 | syslog—System Log Facility |
| 517 | talk—Internet talk port—chat |
| 518 | new talk requests |
| 520 | route—RIP route info protocol |
| 533 | Netwall write to every user's terminal |

Previously, surveillance systems have only observed traffic crossing over ports. Surveillance of traffic native to the network itself has not generally been done. The Network Surveillance and Security System conducts surveillance and analysis of all native and non-native network processes.

An additional novel feature of the Network Surveillance and Security System is the use of matrix algebra to provide substantial new means of tracking and analyzing network operations. The networks under protection typically involve large numbers of simultaneous operations and users, involved in dynamic interactions. Substantial amounts of protected resources at multiple, interwoven layers are being continuously requested and accessed. Comprehensively monitoring all of these myriad events and components as they operate, and maintaining this monitoring in real time throughout their existence has not been previously accomplished. The present invention accomplishes these tasks by modeling the Protected Constellation and its operations with matrices. The use of matrices provides previously unattainable functionality gains for network security monitoring and protection.

Since the operations of a multi-user, multi-processor, multi-threaded UNIX based network simultaneously involves numerous interwoven processes which continuously change relationships and status, it is not possible to follow the network's operations with a simple serial set of data audits. The Network Surveillance and Security System uses a novel application of matrix algebra to accomplish a comprehensive, dynamic accounting of the network in real time. A network's state of operations can be characterized as inhabiting a multidimensional, dynamically evolving Network Status Space. Each dimension of the Network Status Space represents a quality relating to the network, its users, or the processes in operation. One such dimension is an individual user's access permissions to a specific file group. Distances along this dimension would correspond to whether or not the user has read, write, or execution permissions for that file group. These distance examples would be a series of discrete values. The dimensions could also have continuously valued distances, such as a dimension which reflects the elapsed time of a user's login session. The entire status of the network and its operations can then be considered to correspond to a point in the Network Status Space. The coordinates of the point would be the relevant distances along particular dimensions, for all the dimensions required to represent every facet of the network and its operations.

The Network Surveillance and Security System uses matrices to perform transformations between points in the Network Status Space. While the utilization of matrix algebra is not fundamentally distinct, in a mathematical sense, from the use of systems of linear equations or equivalent methods, the gains realized when applied to network security monitoring and protection are fundamentally novel. The network's operations are dynamic, time-critical, and continuously occurring. For a security system to accomplish all of the relevant goals, it must be able to keep pace in real time. If the security system is able to process and make all of the relevant judgments, but at a lag of just 1% behind the time for occurrence of what is being judged, the security protection won't be accomplished. The security system cannot “catch-up”, since there are new events constantly occurring to monitor. Hence, any inefficiency does not just produce a lessened caliber of performance, but likely results instead in an inability to perform at all. In order to avoid this inadequacy, most security systems only consider a limited measure of a network's operations to determine its security. The present invention's use of matrices not only provides a more efficient means to conduct network security analysis and protection, it also enables more comprehensive forms of security protection that were unachievable previously.

One form of novel network security protection uses the Network Status Space. The Network Surveillance and Security System values every point in the Space for its security quality. Some points in the space will be indicative of network status with degrees of acceptable security, some indicative of degrees of unacceptable security, and some indicative of degrees of uncertain security. These points will often be aggregated in regions of similar security value. The Network Surveillance and Security System can determine the network's security status merely by determining what region of the Network Status Space the network's current status resides in. The Network Surveillance and Security System can also use the Network Status Space to efficiently determine how, if necessary, to improve the network's security status. A path, expressed as a matrix transformation in the Network Status Space, between the current network status location and the desired network status location can be readily found and the requisite actions for effecting the status change commanded.

Another form of novel network security matrix application enables the tracking and subsequent monitoring of communications by users accessing the network. Present network security monitoring approaches watch the well-known ports for incoming and outgoing communication packets. These approaches make a judgment about the acceptability of the communication, and are then subsequently uninvolved in monitoring that communication. The communication packets are initially routed through the appropriate well-known port, to ensure that the packets are correctly routed and have the appropriate protocols, but are then switched to other, lesser-known ports for the remainder of the communication's duration to make available the well-known ports for the next communication. A communication may be able to pass the initial inspection at the well-known port, and still present a later manifesting threat to the security of the network. The prior approaches are unable to detect these threats because they lack the capacity to track these communications' paths throughout the network. The Network Surveillance and Security System uses matrices applications to track and monitor these communications throughout their duration, thereby enabling the security of the network to be maintained beyond the initiation of the communication.

Process Management

The Network Surveillance and Security System also uses a novel scheduling approach that conducts time management of processor unit(s) in accordance with the Digital UNIX (DU) Real-time Scheduler Scheme [DEC 94]. The DU Scheduler Scheme supports both real-time and time-sharing applications It complies with the POSIX 1003.1b interface [IEEE93] that defines real-time programming extensions.

### BRIEF DESCRIPTION OF THE FIGURES

FIG. 1 is a schematic depiction of the physical arrangement of the present invention and its relations to other computer networks.

FIG. 2 is a schematic depiction of forms of communication connecions available with the present invention.

FIG. 3 is a schematic depiction of process examples within the layers of the present incention.

FIG. 4 is a schematic depiction of common types of interrelations between process examples within the layers of the present incention.

FIG. 5 is a state diagram of the inference engine component of the present invention.

FIG. 6 is a schematic model of a neuron process within the Neural Network component of the present invention.

FIG. 7 is a schematic model of an example of an interneuron transfer function within the Neural Network component of the present invention.

FIG. 8 is a schematic representation of the overall operations of the present invention.

FIG. 9 depicts is a flow chart of a procedure for conducting Genetic Programming on a population according to the present invention.

FIG. 10 is an illustration of the AT&T UNIX System V Streams-based networking model.

FIG. 11 is an illustration of the underlying architecture of a stream in the UNIX kernel.

FIG. 12 is an illustration of the AT&T UNIX streams architecture.

FIG. 13 is an illustration of the RFS architecture in UNIX networks.

FIG. 14 is an illustration of the SUN Micro-systems Network File System (NFS).

FIG. 15 is a depiction of parent-child relationships among an example of a MIA according to the present invention.

FIG. 16 is a depiction of the rules-based process personalities system acording to the present invention.

FIG. 17 is a depiction of examples of communication connections among process personalities according to the present invention.

FIG. 18 is a symbolic depiction of the arrangement of components of the present invention as encountered by a data packet traversing a network.

FIG. 19 illustrates common state transitions among processes when a network under the protection of the present invention receives a request for access to a protected resource.

FIG. 20 schematically depicts a transition between security states of a network under the protection of the present invention.

FIG. 21 depicts operations of an encryption channel of the present invnetion.

FIG. 22 depicts a stream cipher according to the present invention.

### DETAILED DESCRIPTION OF THE PREFERRED EMBODIMENT

In view of the above, it will be seen that the various objects and features of the invention are achieved and other advantageous results obtained. The examples contained herein are merely illustrative and are not intended in a limiting sense.

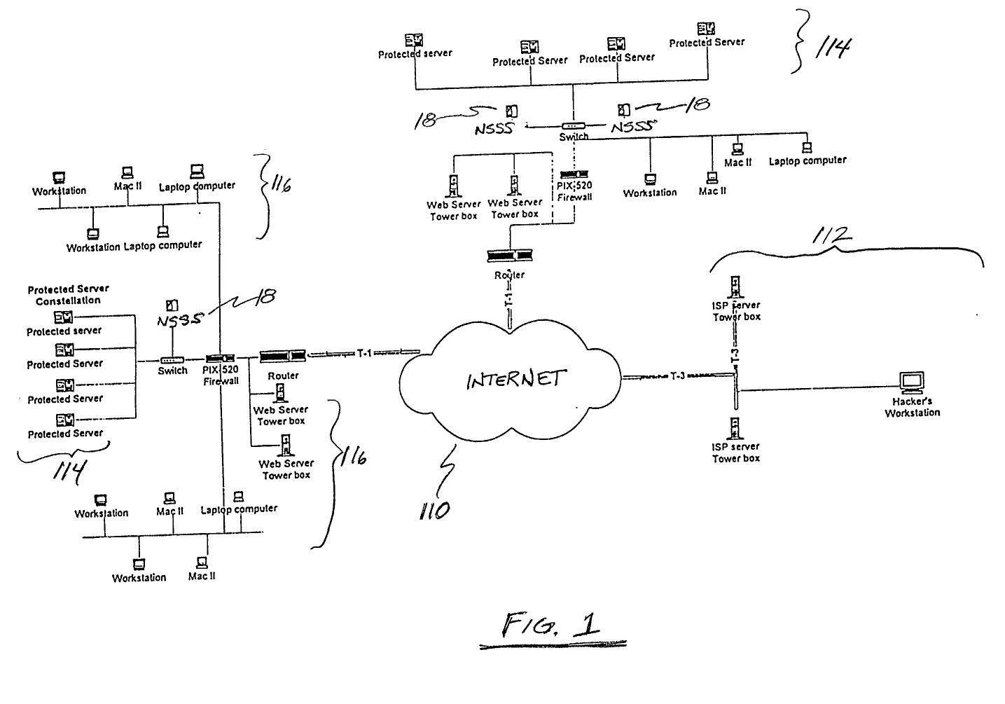

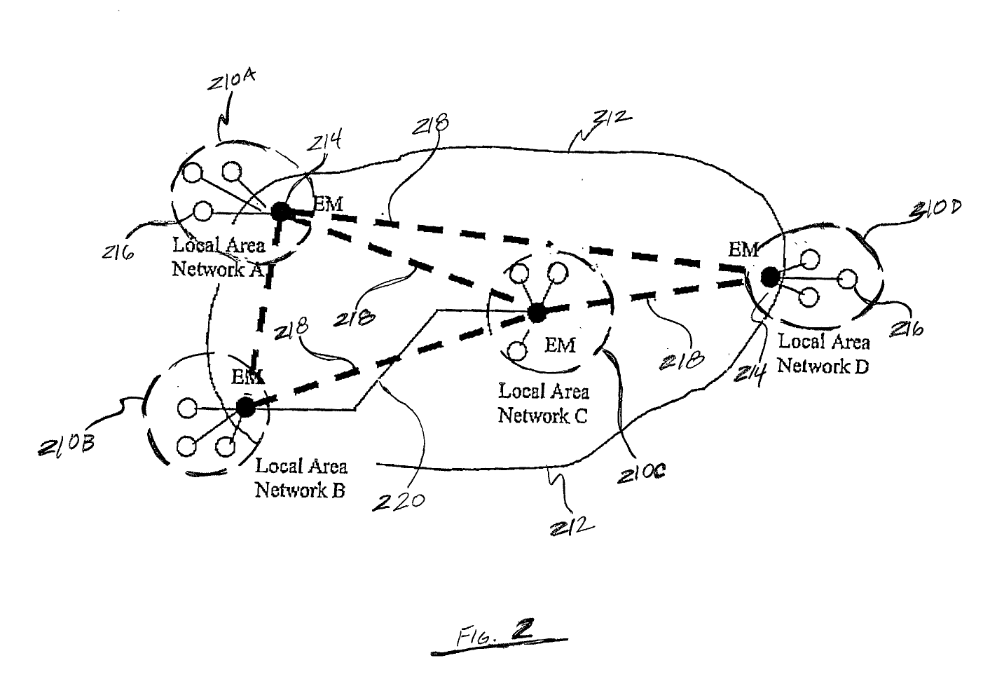

The physical disposition of the Network Surveillance and Security System 18 in relation to the Internet and other computer netwrks is depicted in FIG. 1. The Internet 110 is the WAN over which a prospective attacker's system 112 may communicate with a Protected Server Constellation 114. Other network components 116 are unprotected by the Network Surveillance and Security System 18.

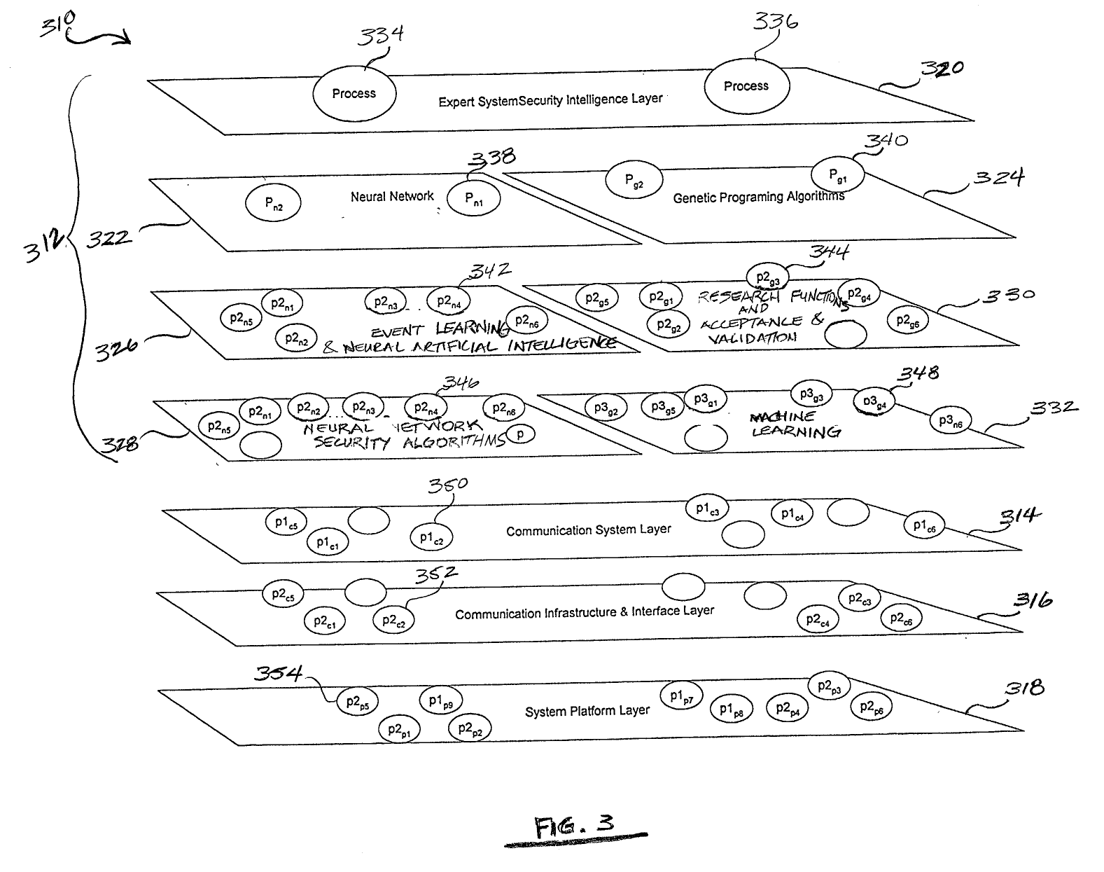

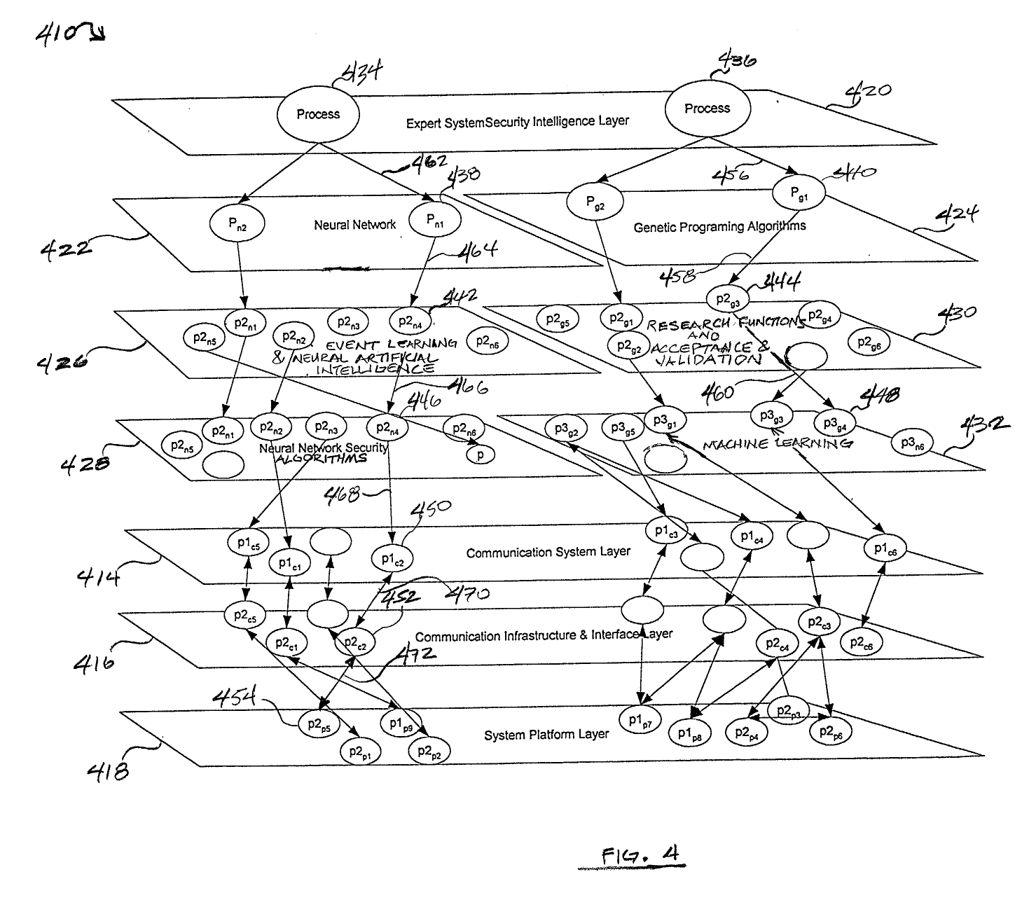

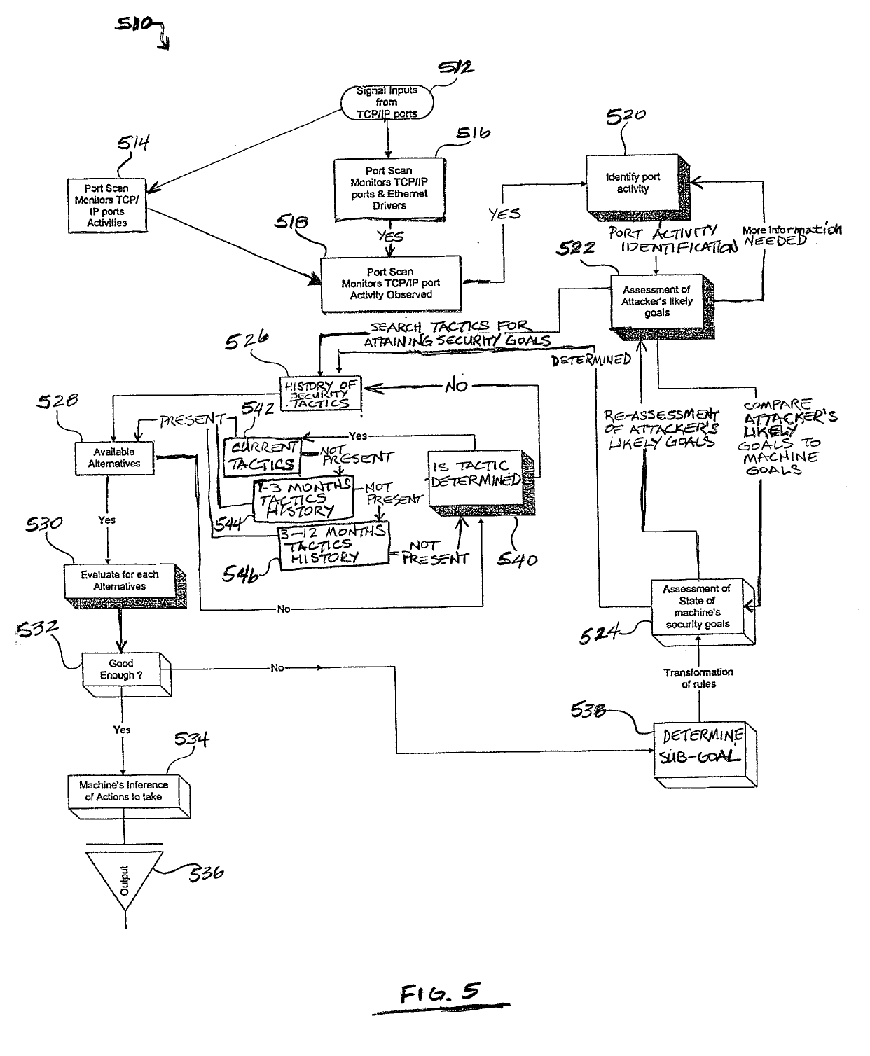

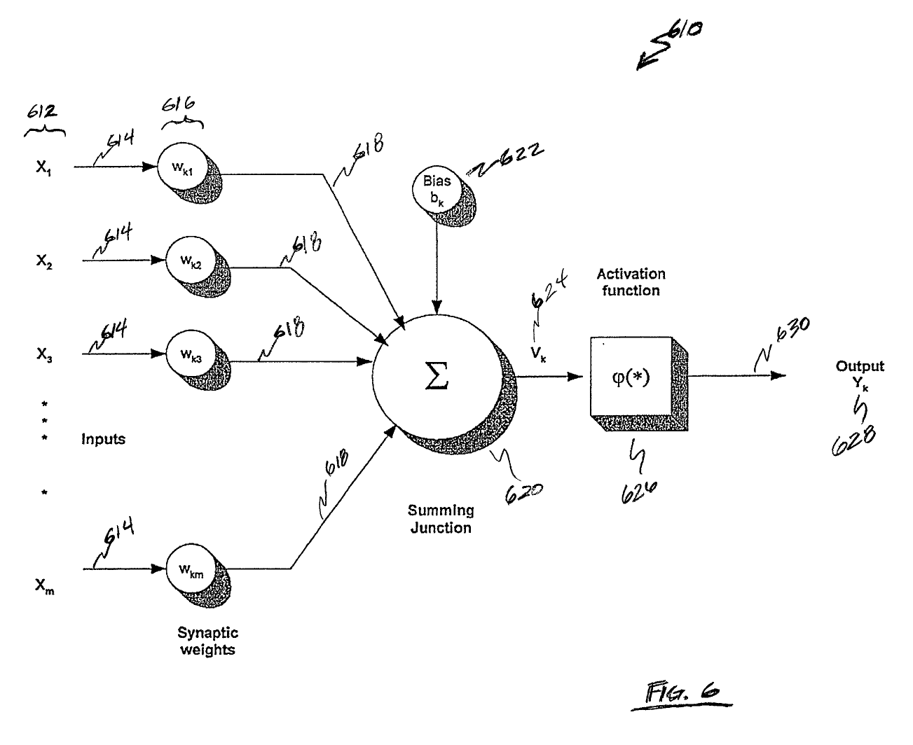

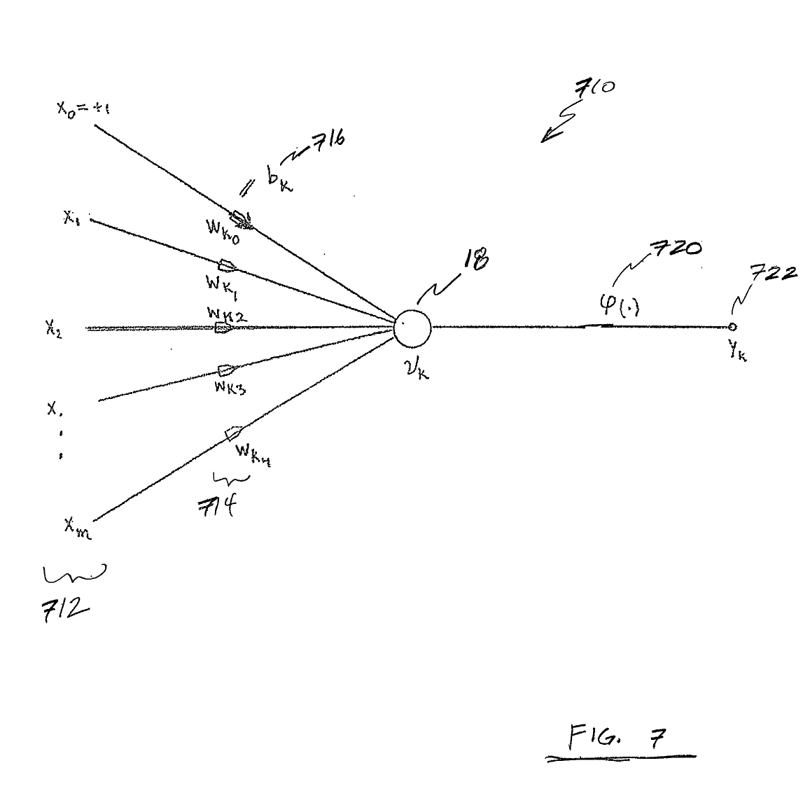

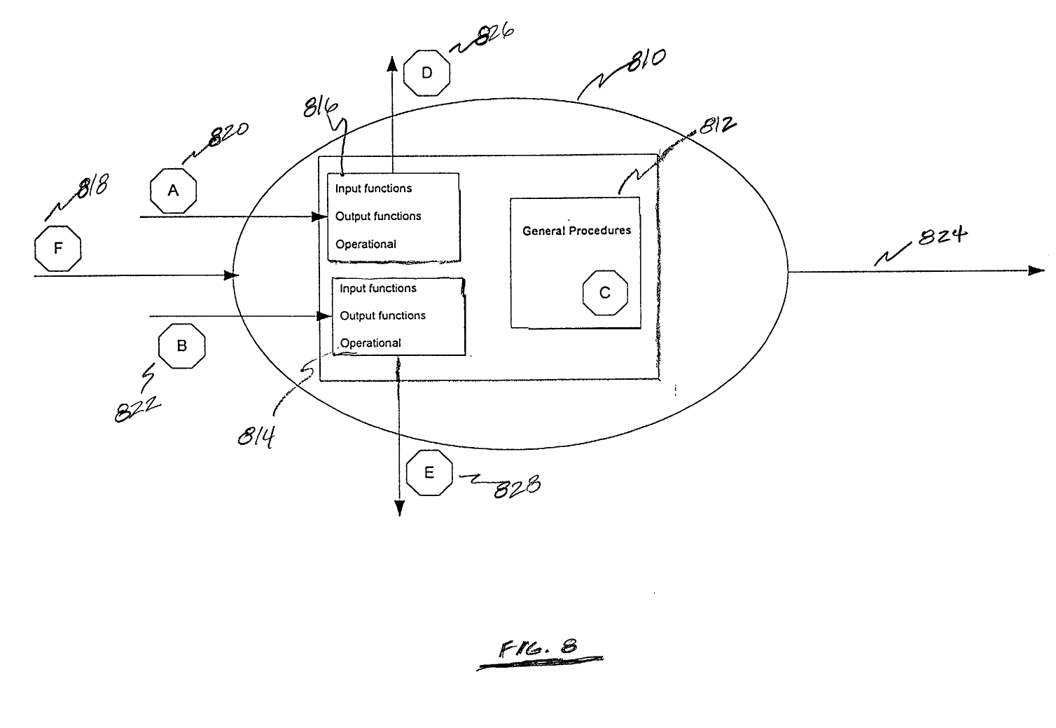

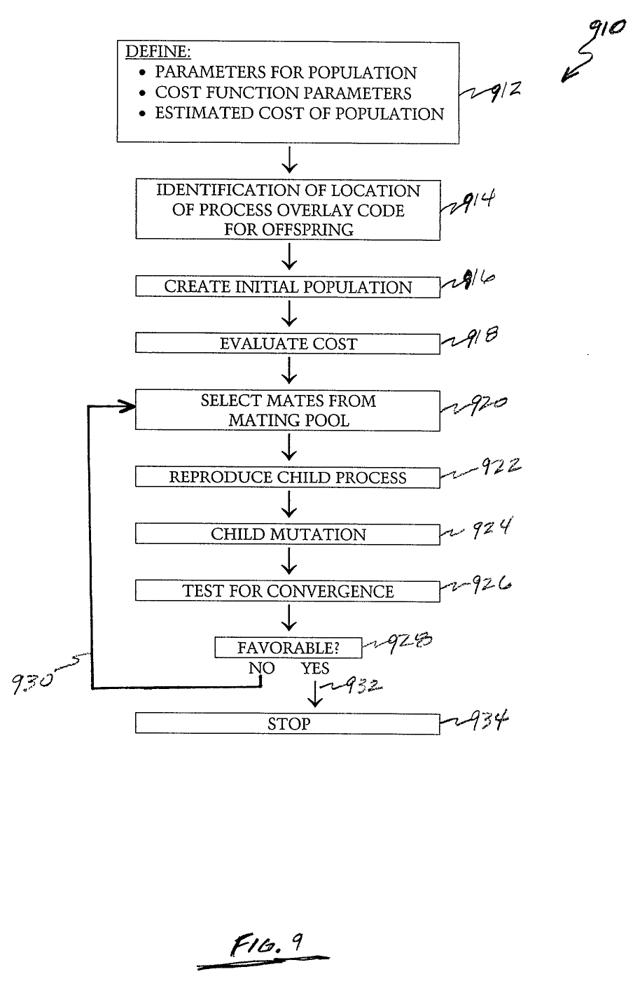

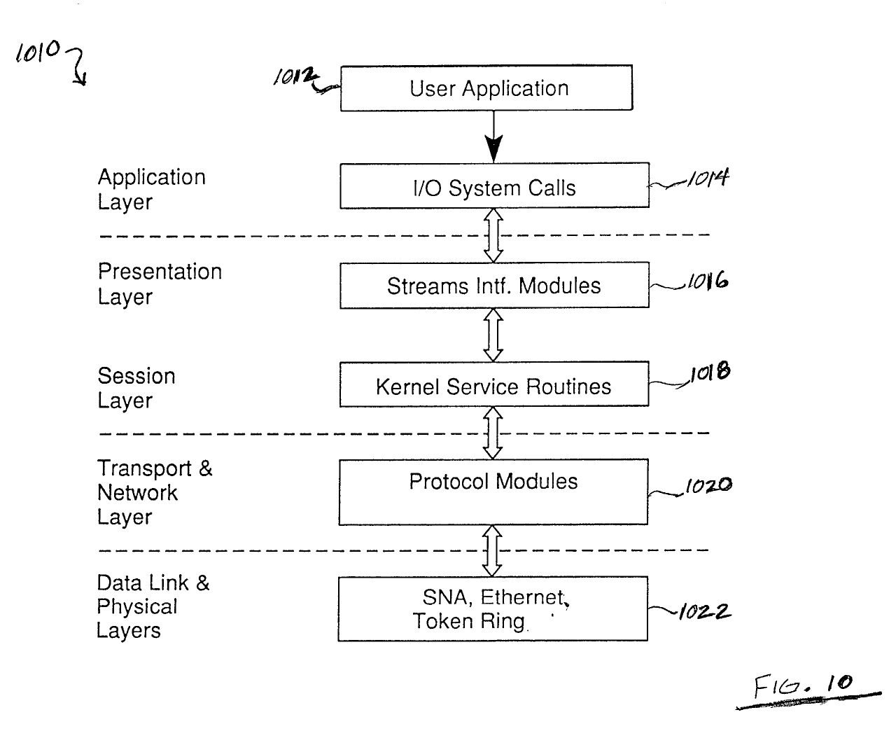

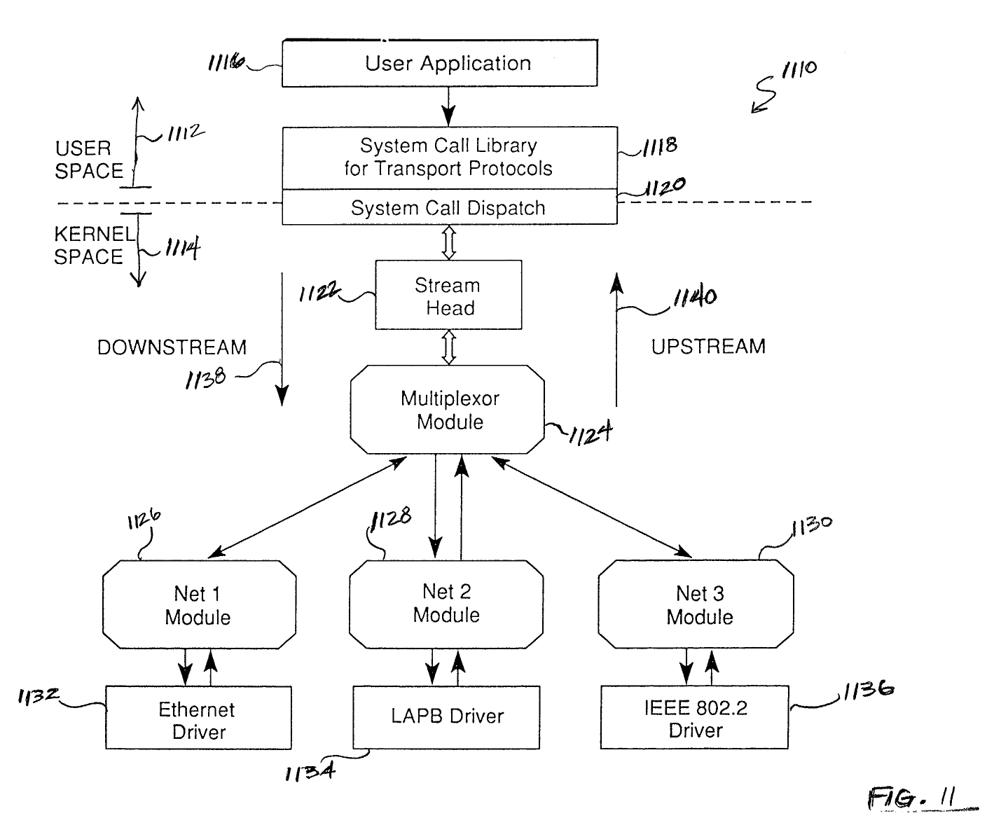

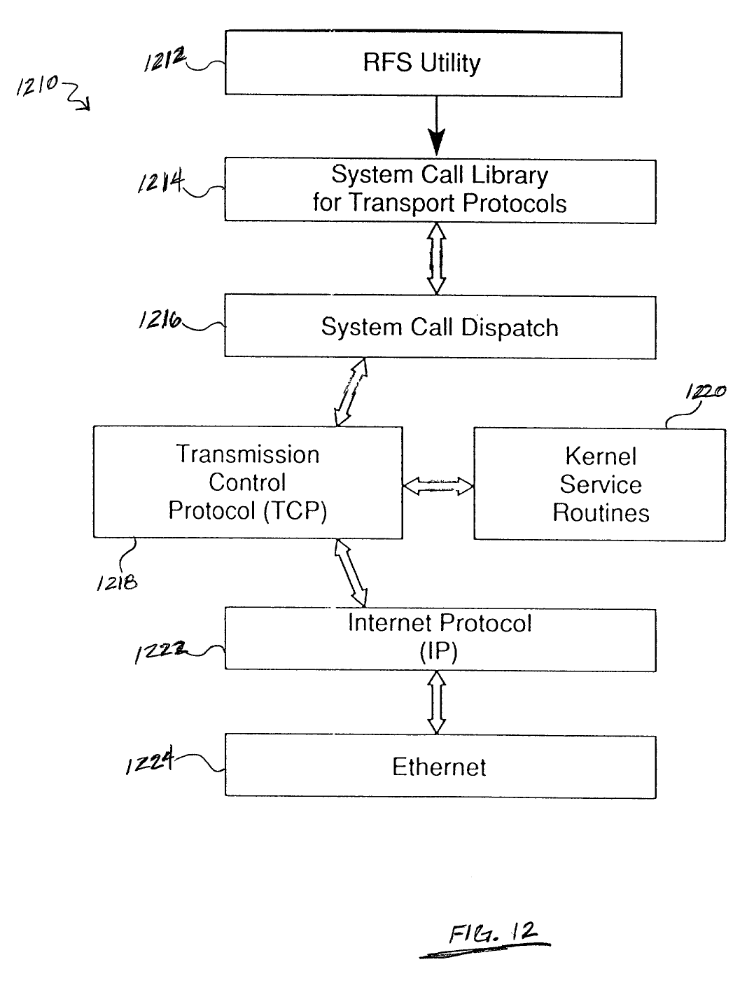

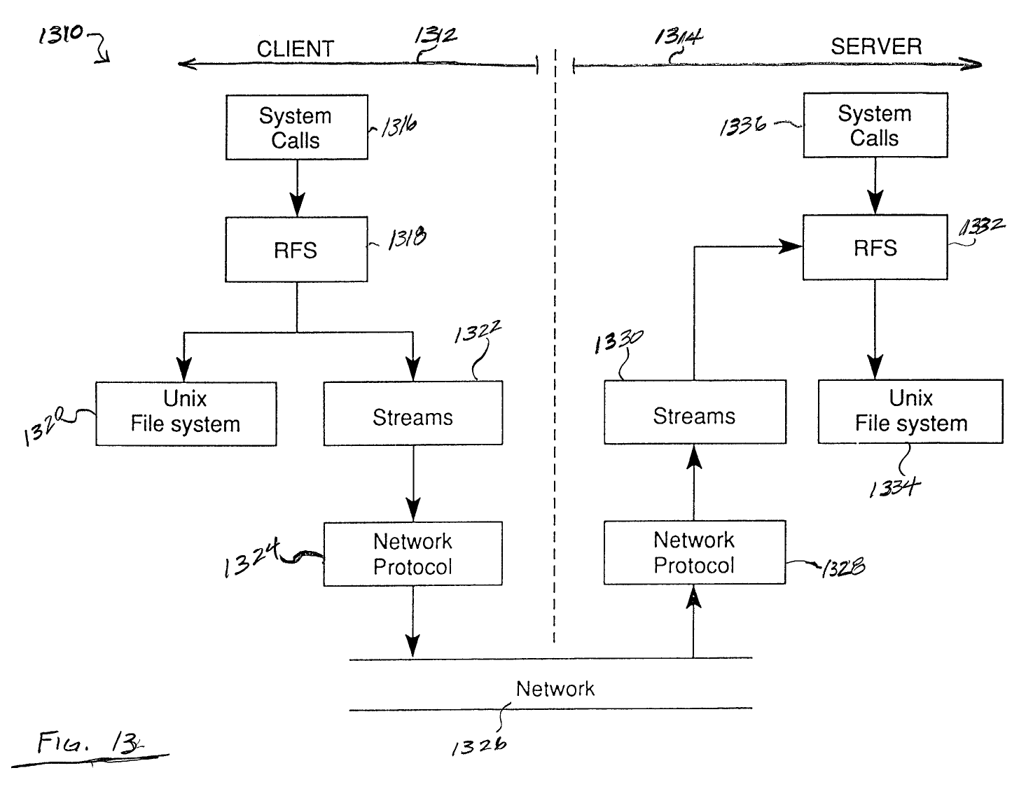

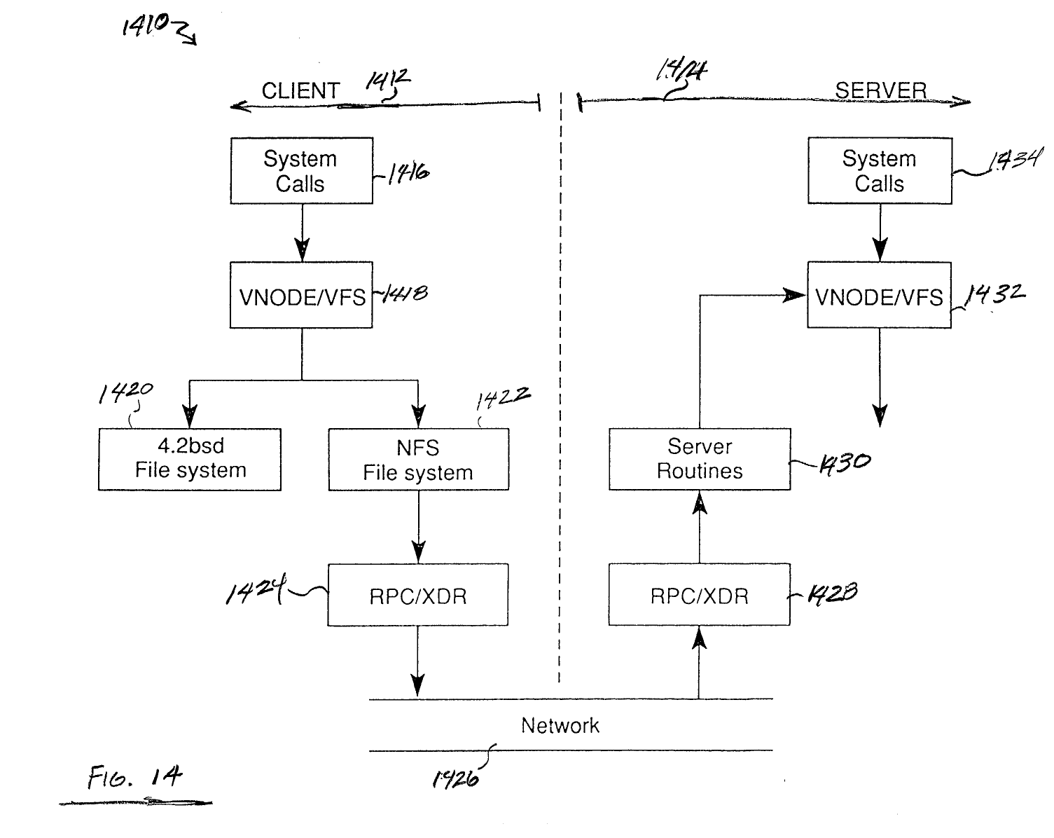

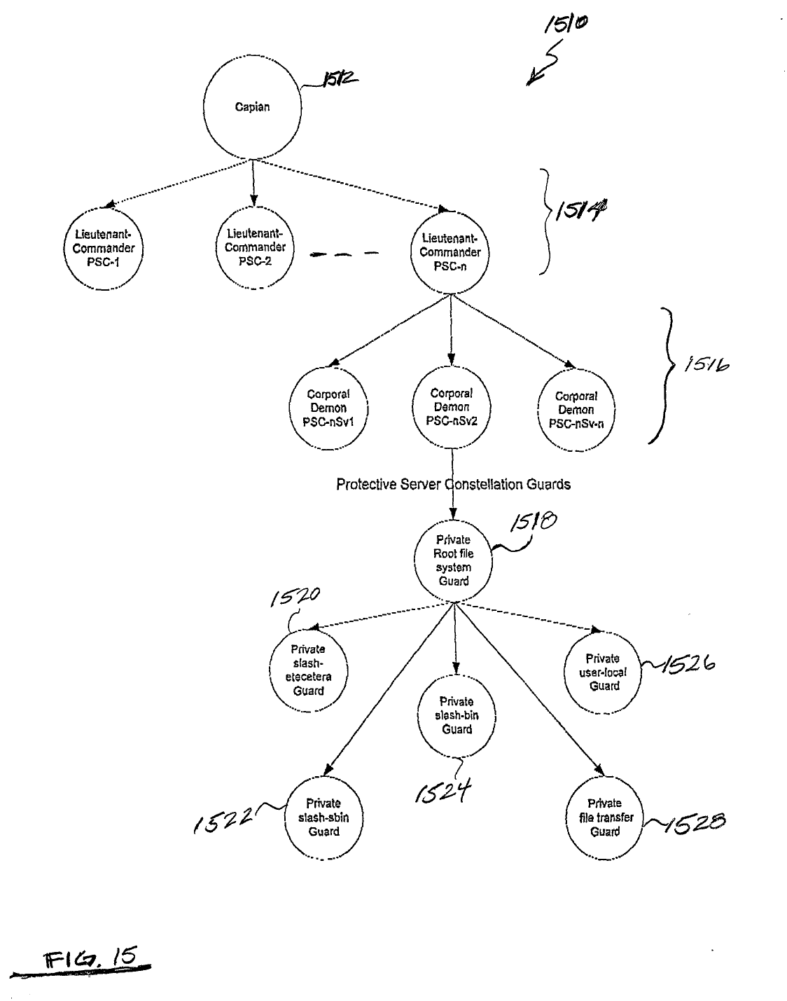

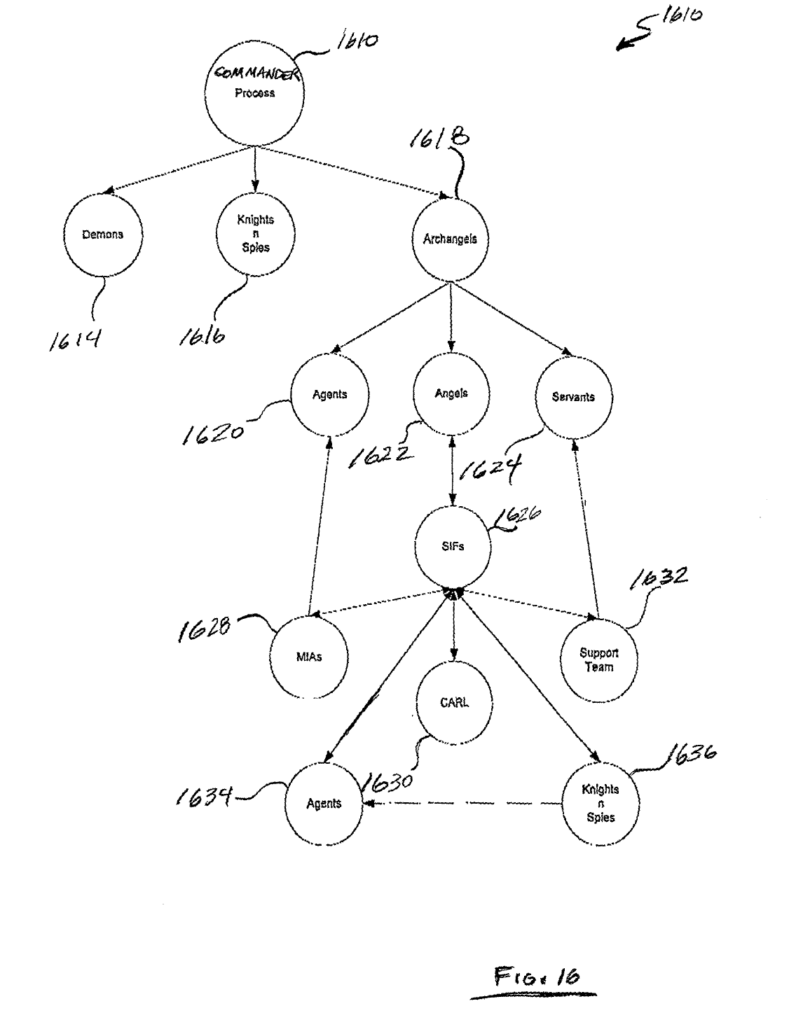

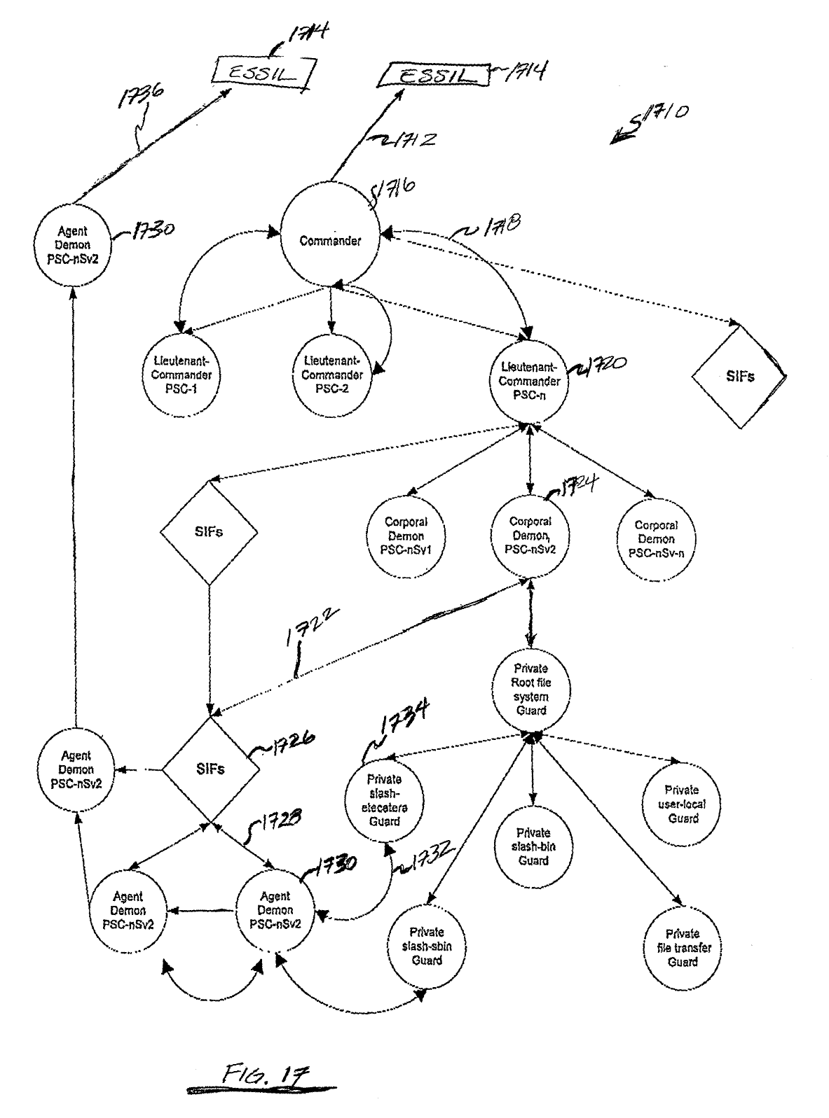

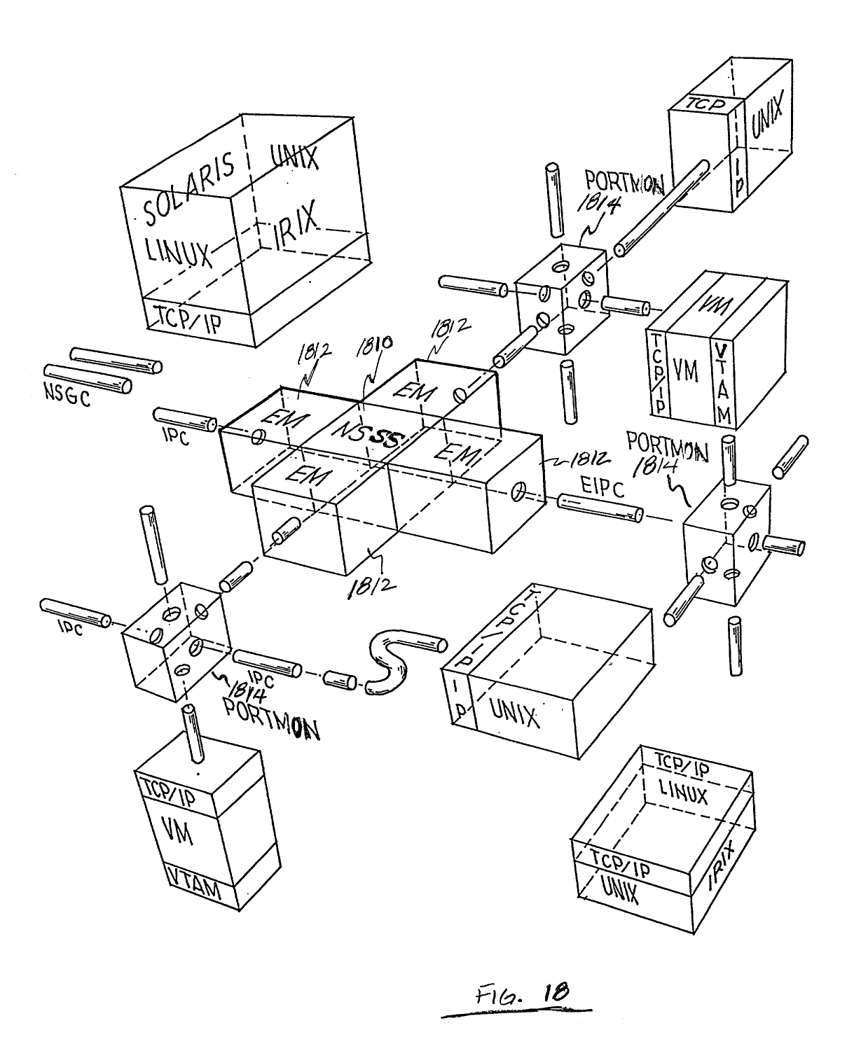

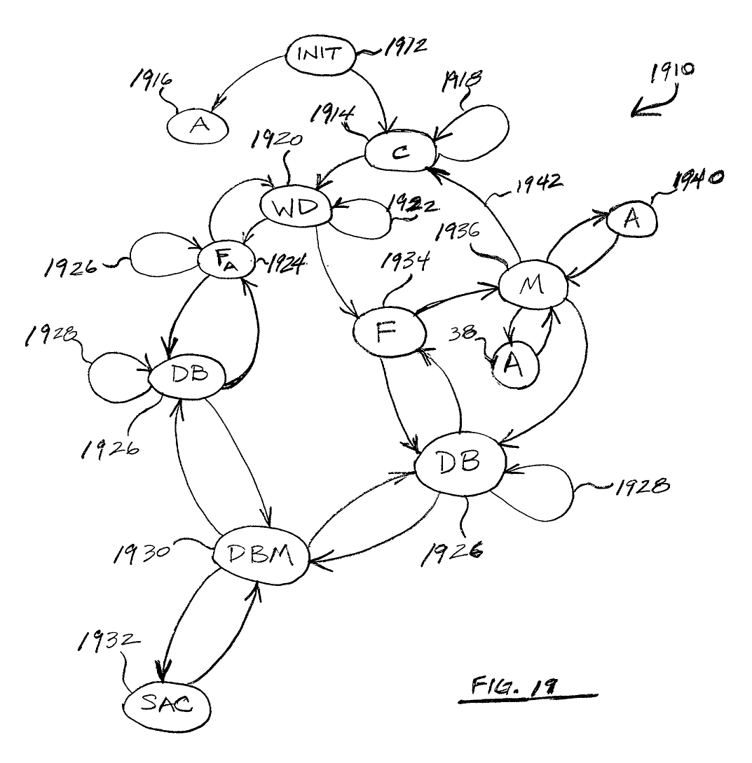

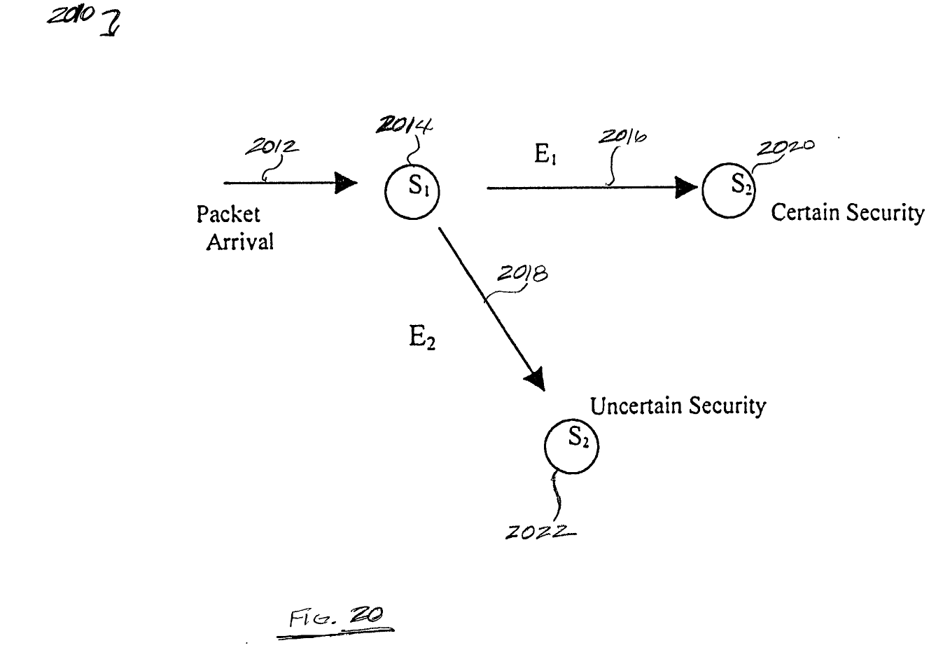

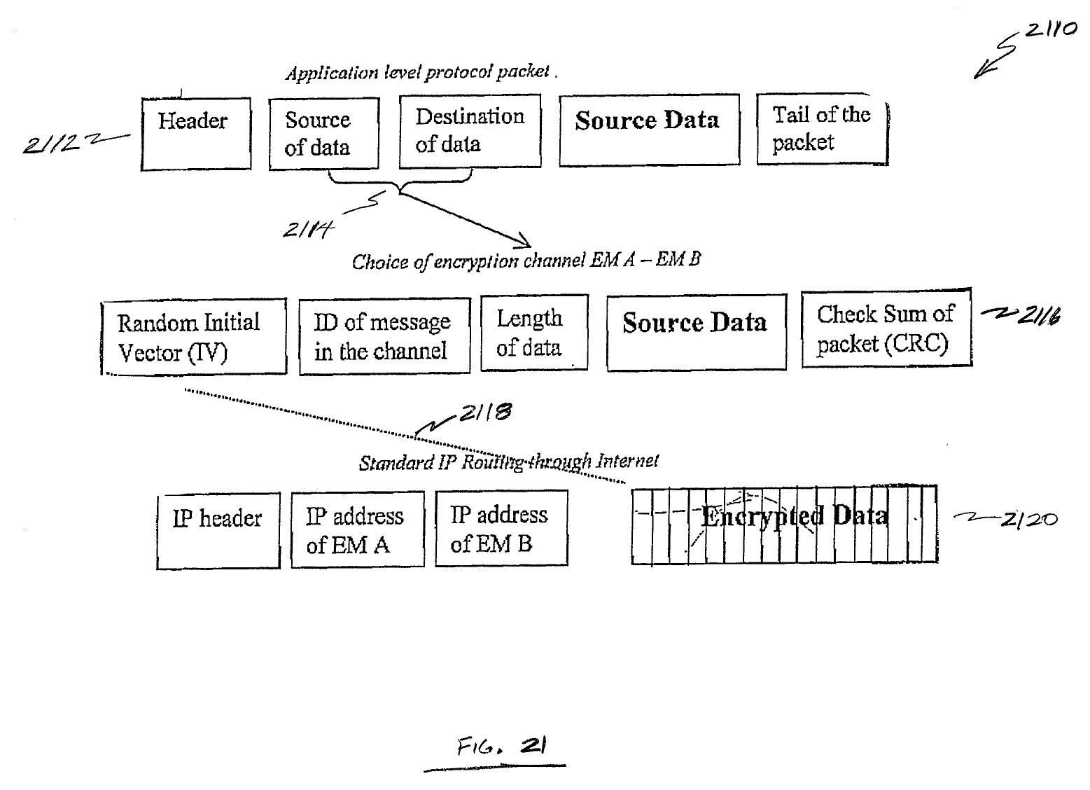

FIG. 2 depicts the forms of communication connections with LANs A-D 210 that are protected with the Network Surveillance and Security System. The Internet 212 is used for communication between the LANs 210. Every message between the LANs is encrypted and decrypted by the Encryption machines 214. Three forms of communication over the Internet 212 are utilized. A first form is interconnection of nodes 216 within the LANs 210 on the Application level. The first form corresponds to, for eample, a Distributed network File System. A scond form is transportaion of encrypted data 218 between LANs 210. The second form should provide security transport infrastructure and accommodate application porotocols without reprogramming. A third form is tracing of real IP packets 220 with Internet routers. The third form corresponds to Internet protocol communications.

Composition and Architecture of the Network Surveillance and Security System

The Network Surveillance and Security System is comprised of UNIX processes. These processes operate in an abstract space and have a fluid, rather than static, organization. At a given juncture, a particular process may interact with a variety of other processes that may or may not be closely related. Accordingly, the architecture of the Network Surveillance and Security System, as described following, is intended as an orientation to general relations among the processes of the present invention, but is not illustrative of strictly delineated interactions among them.

The processes of the Network Surveillance and Security System can be considered as analogous to considerations a person makes when analyzing a problem such as a chess game. At one level, the individual recognizes the board and pieces as being a game. At another level, the player knows the rules of the game. At a next level the player knows various tactics to respond to a given situation when playing the game. At a still deeper level, the player knows multi-move strategies and defenses. While the use of these different levels of knowledge are considered separate and organized in a hierarchy by the player, they are not exclusively related to just the next higher or lower level. The player will employ different combinations of knowledge dynamically in response to ongoing considerations. The similarity of the Network Surveillance and Security System to this analogy is that the invention will also use different combinations of processes to accomplish different operations dynamically. The processes may combine in numerous ways depending on ongoing network events, and these combinations are not limited to the neighboring relationships of the Network Surveillance and Security System architecture.

A critical means of information processing used by the Network Surveillance and Security System to enable many of its functions is the utilization of matrices to track and control information and processes. These matrices are generated in various manners according to the requirements of the situation they are utilized for.

The first step of matrix generation is to observe all processes currently running on a given system being observed or monitored. A given matrix is generated to contain all processes currently running on the system. This action is performed by a process monitor routine which executes a command under SVR4 “ps-ef | filename”. The command pipes all running processes into a file indicated by filename. A process read routine strips away all process ids (PIDs) and parent process ids (PPIDs) from the filename file along with the user information, such as the UID—the owner of each process—from the filename file. Another process called matrix generation generates the process identification matrix from the information stored in the filename file.

A process called access control reads the filename file and strips out all the information from the file containing the service being used by the user and cross references it with the file being accessed and the directory where the file is located.

Once the PIDs have been identified and placed within a Process Identification Matrix, PIDs may be selected for reference at anytime by a process that wishes to control certain processes by using a Process Identification Vector. The Process Identification Vector selects the PIDs by using the Process Identification Vector to identify the associated UID in building a User Control Matrix of UIDs. The User Identification Matrix is also used to associate a given userID with a given processID running on the system at any given time. Once a User Identification Matrix is completed, a userID can be selected from the User Identification Matrix to find all the processes associated with each user and compiled within a single column within the Process Control Matrix.

To select each userID from the User Identification Matrix, a User Identification Vector is used to make the selection of the particular userID. The User Identification Vector is a tuple of Xs such that {X={x₁, x₂, x₃, . . . , xₙ}. Where x is either 1 or 0. If the value of x is 1, then this value is used to select a UserID in the User Identification Matrix. When a UserID is selected, it is used to generate a value for the Group Identification Matrix.

The generation of the Process Control Vector requires the Process Identification Matrix. Once a process has been identified as a process belonging to a terminal on the system, and after it has been identified as a process belonging to a user, it is placed within the Process Identification Matrix. The Process Identification Vector is used to select a group of Processes from the Process Identification Vector to generate Process Control Vectors. These Process Control Vectors are comprised of Processes that are used to identify the UserID each process belongs to and the UserID is then used to identify the GroupIDs each UserID belongs. Once each of the components have been identified in their respective Matrices, the matrices are used to generate the Control Matrices.

The Process Control Vector contains ProcessIDs collected from running processes and this data is taken from the Process Identification Matrix and placed in the Process Control Matrix. The Process Control Matrix contains ProcessIDs which are used by the Process Control Vector to control the number of ProcessIDs being monitored by specified processes such as Agents, Knights, and other personalities.

The Group Control Matrix works in a very similar manner to the Process Control Matrix except that the Group Control Matrix controls group members by monitoring the group rights and permissions different members of the different groups possess. The construction of the Group Control Matrix is also similar to the construction of the Process Control Matrix in that the GroupIDs are derived from UserIDs which are derived from processIDs. A Group Identification Matrix is generated from the UserIDs of each user, and cross-referenced with the Password file to determine the number of groups each user is a member. Once the Group Identification Matrix is complete, the processing of the Group Control Matrix can take place. The data from the Group Identification Matrix is copied to the Group Control Matrix to perform Group Controlled Functions. Group control functions are performed by using the Group Control Vector against the Group Control Matrix to select GIDs that are to be monitored, have permissions changed or eliminated altogether.

The user-group permissions control matrix is generated by taking information from the User Control Vector and the Group Control Matrix and transporting the information to a matrix called the User-Group Permissions Control Matrix.

The Permissions Control Matrix is generated by taking information from the User Control Vector and constructing a two column Matrix using the user's permissions for the directory being accessed by the user, and another column for the permissions of the file the user is accessing. Examples of specific matrices are described following.

The tracking and subsequent monitoring of communications from users is conducted with TCP Port control vectors, a TCP Port Control Matrix, and a TCP Port—Definitions Control Matrix at the Communication Infrastructure and Interface Layer and the Expert System Security Intelligence Layer. These matrices and vector are:

| TCP PORT CONTROL VECTOR | TCP PORT CONTROL MATRIX | | | | | |
|---|---|---|---|---|---|---|
| α₁ | 7 | 23 | 53 | 111 | 513 | * |
| α₂ | 9 | 25 | 79 | 113 | 514 | * |
| α₃ | 13 | 37 | 80 | 119 | 515 | * |
| α₄ | 19 | 4 | 109 | 178 | 540 | * |
| α₅ | 21 | 43 | 110 | 512 | 2049 | * |
| α₆ | | | | | | |

TCP PORT - DEFINITIONS CONTROL MATRIX

| | | | | | |
|---|---|---|---|---|---|
| ECHO | TELNET | DOMAIN | SUN-RPC | LOGIN | NULL |
| DISCARD | SMTP | FINGER | AUTH | SHELL | NULL |
| DAYTIME | TIME | HTTP | NNTP | PRINTER | NULL |
| CHARGEN | NAME- | POP2 | NSWS | UUCP | NULL |
| | SERVER | | | | |
| FTP | WHOIS | POP3 | EXEC | NFS | NULL |

The TCP Port Control Vector controls which TCP ports are assigned to agents for monitoring. The number of Agents assigned is determined by the needs of a specific monitoring situation. The TCP Port Control Matrices at the Communication Infrastructure and Interface Layer and the Expert System Security Intelligence Layer, are labels for variables and are designated by the port number and port name labels, respectively, of the well-known TCP ports. The “*” and the “null” designations in the Port Control Matrices at the Transport System and Expert System Security Intelligence Layers, respectively, indicate open variable slots for the future assignment of further ports, when needed. The system uses matrix multiplication to assign the Agents of the Port Control Vector monitoring of the traffic on the TCP ports they are matched with, to produce the TCP Port Monitor Vector. In this example the Agents will typically be capable of monitoring four TCP ports each. When an Agent is monitoring less than four TCP ports it is available to have additional TCP ports assigned to it. In other cases, alternative Agents can monitor various numbers of TCP ports—as well as other ports. By adding and subtracting various permutations of the Agents in the TCP Port Control Vector multiplied by the TCP Port Control Matrix, in principle, various combinations and types of ports can be monitored.

After the communication connection for a user has been made, the connection is then shifted to a lesser-known port from the well-known TCP port. Since there is not a consistent organizational scheme, other than to the next available port, which indicates what port a given connection will be switched to, monitoring the connection throughout its duration requires that the connection be tracked from the well-known TCP port to the lesser-known port. The TCP port numbers of the variables in the TCP Port Control Matrix correspond to the port definitions in the TCP Port-Definitions Control Matrix. While the matrices can, in principle, be composed in differing arrangements, The selective control of the TCP Port Control Vector and further addition or subtraction of matrix multiplication results can provide all the variations necessary without changes in either of the TCP Port Control Matrices.

The TCP Port-Definitions Control Matrix defines the ports in terms of the meaning of the contents of the communications which pass over them. The designation of the ports by the contents of their communications is significant at the Expert System Security Intelligence Layer because it enables the Network Surveillance and Security System to use a meaning of a connection and the intelligence relating to the connection to keep track of a communication connection after it has left the well-known port. Monitoring directed by the meaning of the communication's contents eliminates the difficulty in accounting for which communication is passing over a randomly selected port. The application of the Expert System Security Intelligence Layer AI to analysis of the communication, and its ability to accurately direct a response, if needed, are also enabled by the capacity to directly track the communication, regardless of the port number the connection is passing over. The higher level functions of the Expert System Security Intelligence Layer, such as learning and inferring predictions, is also enabled by the matrix enabled tracking and monitoring.

The User Datagram Protocol is an alternative communication protocol to TCP. The application of matrices by the Network Surveillance and Security System to the tracking and monitoring of UDP communications is analogous to the tracking and monitoring of TCP communications. The UDP Control Vector is similar and is not shown. The UDP Port Control Matrix, at the Transport System Layer, and the UDP Port-Definitions Control Matrix are:

UDP PORT CONTROL MATRIX (Transport System Layer)

| | | | | |
|---|---|---|---|---|
| 7 | 37 | 123 | 314 | 533 |
| 9 | 53 | 161 | 517 | * |
| 13 | 69 | 512 | 518 | * |
| 19 | 111 | 313 | 520 | 2049 |

UDP PORT - DEFINITIONS CONTROL MATRIX

| | | | | |
|---|---|---|---|---|
| ECHO | TIME | NTP | SYSLOG | NETWALL |
| DISCARD | DOMAIN | SNMP | TALK | NULL |
| DAYTIME | T - FTP | bIFF | N - TALK | NULL |
| CHAR GEN | SUN - RPC | WHO | ROUTE | NFS |

The above discussions of the TCP Port Control matrices applies also to the UDP Port Control Matrices, as do similar benefits for monitoring and protecting network security. Other examples of Matrices are:

| PROCESS SELECTION VECTOR | USER SELECTION MATRIX |
|---|---|
| 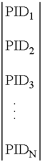 | 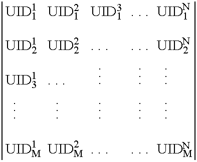 |

| USER SELECTION VECTOR | GROUP SELECTION MATRIX |
|---|---|
| 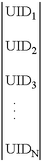 | 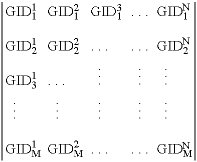 |

USER/GROUP PERMISSIONS CONTROL MATRIX

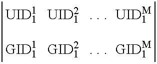

PERMISSIONS CONTROL MATRIX

| directory | file |
|---|---|
| drwx rwx rwx | -rwx rwx rwx |
| | . |
| drwx rwx rwx | . |
| | . |
| . | . |
| . | . |
| . | . |
| drwx rwx rwx | -rwx rwx rwx |

The above example of a User/Group Permissions Matrix is for the user “1”. The number “m” of the UID's and GID's in the User/Group Permissions Matrix above corresponds to the number of shell windows the user has operating in the system. The User/Group Permissions Matrix is generated for each user from the process control vector. An intermediate, Permissions Generator Matrix, not described, is used to generate a Permissions Control Matrix. The Permissions Generator Matrix assigns the locations in the Permissions Control Matrix in correspondence to each of the shell windows the user has operating in the system. The determination of correctly applied file type permissions is by comparison of the User/Group Permissions Matrix with a Permissions Control Matrix:

The number of rows in the Permissions Control Matrix corresponds to the maximum number of user ID's (or Group ID's) in the User/Group Permissions Matrix. In the example shown, there are m rows. Each of the entries in the matrix for the example depicted, such as “-rwx rwx rwx”, contain four separate blocks of permissions information. The first block is a code indicating the relevant type of file that the particular permission is for. The symbols are:

| | |
|---|---|
| — | File |
| d | Directory |
| l | Link to Another File |
| b | Blocked Device (e.g. CD-ROM or disc storage) |
| s | socket (SVR4, BSD) |
| = | FIFO (SVR4, LINUX) |

The second through fourth blocks are read, write, and execute permissions, respectively. The second block determines the access granted to the owner of the file. The third block determines the access granted to a non-owner of the file who is a member of the group the file belongs to. The fourth block determines the access granted to a non-owner of the file, who is also not a member of the group the file belongs to.

The comparison of the User/Group Permissions Matrix and the Permissions Control Matrix are made with an adaptation of matrix multiplication. The elements of each matrix are matched to each other as in matrix multiplication in their above order, but the matched elements are then evaluated for correspondence, rather than multiplied. The evaluations provide information indicating whether or not users and processes are operating according to their intended permissions. If the matched elements do not have corresponding permissions, the Network Surveillance and Security System is able to determine that the security of protected files may be threatened. Other blocks of identifying information which may be tracked and controlled similarly with matrices include:

| | |
|---|---|
| PPID | parent process ID |
| PID | process ID |
| PGID | process group ID |
| SID | session ID |
| TT | terminal name |
| TPGID | terminal process group ID |
| UID | user ID |

An outline of the Network Surveillance and Security System architecture is shown in FIG. 3. FIG. 3 is a schematic depiction of examples of processes within the four layers of the Network Surveillance and Security System 310. These four layers are:

I. Expert System Security Intelligence Layer (ESSIL) 312

II. Communication System Layer 314

III. Communication Infrastructure & Interface Layer 316

IV. Platform System Layer 318

The ESSIL 312 includes an Executive sub-layer 320, a Neural Network Executive Layer 322, and a Genetic Programming Algorithms Executive Layer 324. Further Neural Network sub-layers include an Event Learning & Neural Artificial Intelligence sub-layer 326 and a Neural Network Security Algorithms sub-layer 328. Further Genetic Programming sub-layers include the Research Functions and Acceptance & Validation sub-layer 330 and the Machine Learning sub-layer 332. Arrayed throughout the layers and sub-layers 312 through 332 are various processes with which the Network Surveillance and Security System conducts operations. A pair of processes 334 and 336 are shown at the Expert System Security Intelligence Executive Layer 320. An example of a process at the Neural Network Executive Layer 322 is a process 338. An example of a process at the Genetic Programming Algorithms sub-layer 324 is a process 340. An example of a process at the Event Learning & Neural Artificial Intelligence sub-layer 326 is a process 342. An example of a process at the Research Functions and Acceptance & Validation sub-layer 330 is a process 344. An example of a process at the Neural Network Security Algorithms sub-layer 328 is a process 346. An example of a process at the Machine Learning sub-layer 332 is a process 348. An example of a process at the Communication System Layer 314 is a process 350. An example of a process at the Communication Infrastructure & Interface Layer 316 is a process 352. An example of a process at the is a process An example of a process at the Platform System Layer 318 is a process 354.

The processes of FIG. 3 are shown with an assortment of purely illustrative designating indicia which are indicative of the flexibility of utilization of the components of the Network Surveillance and Security System for differing security requirements. The variations in indicia show the Network Surveillance and Security System employing processes throughout its sub-layers conducting differing functions in correspondence to differing network security protection situations. These differing functions and their correspondence to differing situations are not strictly arranged within the Network Surveillance and Security System architecture according to a rigid hierarchy, but are flexibly deployable for optimal performance.

FIG. 4 is a schematic depiction of examples of intersub-layer communication connections 410 between the process examples of FIG. 3. These communication connections may be one-way or two-way. A one-way connection 456 communicates from process 436 to process 440. Another one-way connection 458 communicates from process 440 to process 444. An additional one-way connection 460 communicates from process 444 to process 448. The connections 456-460 thereby produce a one-way communication chain from a process in sub-layer 420 to, in turn, processes in sub-layers 424, 430, and 432.

A communication connection between sub-layers may also include both one-way and two-way connections. A one-way connection 462 communicates from process 434 to process 438. A one-way connection 464 communicates from process 438 to process 442. A one-way connection 466 communicates from process 442 to process 446. A one-way connection 468 communicates from process 446 to process 450. Processes 450 and process 452 communicate to and from each other through a. two-way connection 470. Processes 452 and process 454 communicate to and from each other through a. two-way connection 472. The connections 462-468 thereby produce a one-way communication chain from a process in sub-layer 420 to, in turn, processes in sub-layers 422, 426, 428, and 414. The connections 470 and 472 produce two-way communications between processes in sub-layers 414, 416, and 418.

It should be understood that the interprocess communcation connections depicted in FIG. 4 are for illustrative purposes, and are not indicative of limitations on the varieties of interprocess communication connections that can be made by the present invention. Also within the scope of the present invention are interprocess connections between processes within any combination of sublayers, such as sub-layer 422 to sub-layer 432, as well as intra sub-layer connections. The directions of the connections are also merely illustrative. Furthermore, the connections are not limited to a one-to-one, process-to-process structure. Some connections may have outputs which are communicated to several processes, or inputs from several processes, such as in the case of Neuron processes (desrcibed later) within the Neural Network.

The most sophisticated functions of the Network Surveillance and Security System are conducted by the Expert System Security Intelligence Layer. The organization of the Expert System Security Intelligence Layer is the following:

I. EXPERT SYSTEM SECURITY INTELLIGENCE LAYER (ESSIL) -
Executive Program
Inference Engine Sub-Routine

| | |
|---|---|
| 1. Knowledge Base Executive | 4. Communication Utilities Knowledge Base |
| 2. Intrusion Detection Knowledge Base | 5. Intelligence Search Engines |
| 3. Attack sequence Knowledge Base | 6. Intelligence Sorting Engines |

I.A. Neural Network Sublayer

Executive Program & Algorithms

I.A.1 EVENT LEARNING

Knowledge Representation

Observations
Rules

I.A.2 NEURAL ARTIFICIAL
INTELLIGENCE

Knowledge Representations

I.A.2.a Representations

Theorems
Facts

I.A.2.b Reasoning

Observations
Rules

I.A.2.c Learning

Theorems
Facts
Observations

I.A.3 NEURAL NETWORK SECURITY
ALGORITHMS

I.A.3.a Neuron Models

Rules

I.A.3.b Symbolic Representations

Networks
Constellations
Systems

I.B. Genetic Programming Sublayer

Executive Program & Algorithms

I.B.1 RESEARCH FUNCTIONS

Features (inputs)
Classes (outputs)

I.B.1.a Training Domains

Features (inputs)
Classes (outputs)

I.B.1.b Learning Domains

Features (inputs)
Classes (outputs)

I.B.2 ACCEPTANCE & VALIDATION

Features (inputs)
Classes (outputs)

I.B.2.a Learning Domains

Features (inputs)
Classes (outputs)

I.B.2.b Testing Domains

Features (inputs)
Classes (outputs)

I.B.3 MACHINE LEARNING
ALGORITHMS

Features (inputs)
Classes (outputs)

I.B.3.a Training Domains

Features (inputs)
Classes (outputs)

I.B.3.b Acceptance & Validation

Features (inputs)
Classes (outputs)

I. ESSIL Executive

The Executive program is the command process of the ESSIL. The proceses within the ESSIL and their operations are determined by the ESSIL Executive. A sub-routine of the ESSIL Executive which is specialized for attack responses is the Inference Engine Algorithm.

Inference Engine Sub-Routine

FIG. 5 depicts a state flow-chart of the Inference Engine (IE) 510 Sub-routine of the Expert Security System Intelligence Layer. The IE 510 receives its initial information input in a state Signal Inputs from TCP/IP Ports 512. Upon receipt of the Signal inputs the IE 510 switches to a state Port Scan Monitors TCP/IP Ports Activities 514; and a state Port Scan monitors TCP/IP Ports and Ethernet Drivers 516. Upon observation of TCP/IP port activities, the IE 510 switches from states 514 and 516 to a state Port Scan Monitors TCP/IP Ports Activity Observed 518. After observing the port activity in state 518, the IE 510 switches to the state Identify Port Activity 520. Upon an identification of the port activity, the IE 510 switches to a state Assesment of Attacker's Likely Goals 522.

5rom state 522, the IE 510 will return to state 520 if more port activity identification is needed to assess the attacker's goals. If, when in state 522, the IE 510 determines a need to compare an attacker's likely goals to the machine's goals (the machine's goals being the security goals input by the Network Surveillance and Security System administrator), the IE 510 may switch from state 522 to a state Assesment of State of Machine's Security Goals 524. 5rom state 524, the IE 510 will then switch to state 522 for a re-assesment of an attacker's likely goals.

If, when in state 522, the IE 510 determines the attacker's likely goals, the IE 510 will then search tactics for attaining security goals by switching to a state History of Security Tactics 526. If, when in state 524, the IE 510 has determined the state of the machine's securtiy goals, it will switch from state 524 to state 526.

From state 526, the IE 510 will switch to a state Available Alternatives 528 for determining the available alternatives among the history of security goals for attaining the machine's security goals when confronting the attacker's likely goals. When in state 528, if the IE 510 finds available alternatives, it swiches to a state Evaluate for Each Alternative 530 to weigh the alternative's. After weighing the alternatives in state 530, the IE 510 will judge if the alternatives are sufficient to meet the machine's security goals by switching to a state Good Enough? 532. If the IE 510 in state 532 infers the alternatives are good enough, the IE 510 switches to a state Machine's Inference of Actions to Take 534. The reulting inferred actions are then the Ouput 536 from the IE 510.

If the IE 510, when in state 532, determines the alternatives are not good enough, the IE 510 will switch to a state Determine Sub-Goal 538. A sub-goal would be a partial acomplishment of the machine's security goals. 5 or example, if the machine's security goals are to stop any attack before degradation of the performance of the Protected Server Constellation occurs and prevent any posible future attack form the attacker's host IP address, then a sub-goal could be to at least temporarily close a specific port through which the attack is currently attempting to access the Protected Server Constellation. When in state 538, the IE 510 will determine a transformation in the rules governing the machine's security goals to accomplish the sub-goal determined and switch to state 524.

When in state 528, if the IE 510 has no available security tactic it will switch to a state Is Tactic Determined 540 to begin to search for an available alternative. If the IE 510, when in state 540, does not determine an available tactic, the IE 510 then returns to state 526 for further searching. If the IE 510, when in state 540, does determine an available tactic, the IE 510 then switches to a state Current Tactics 542 to consider the most recently used (within the preceding month) tactics for an inference as to the suitability of the determined tactic. If the determined tactic is present in the current tactics, the IE 510 switches from state 542 to state 528. If the determined tactic is not present in the current tactics, the IE 510 switches from state 542 to a state 1-3 Months Tactics History 544 to consider the archive of tactics used within the period between one and three months preceding. If the determined tactic is present in the one to three months history of tactics, the IE 510 switches from state 544 to state 528. If the determined tactic is not present in the one to three months history of tactics, the IE 510 switches from state 544 to a state 3-12 Months Tactics History 546 to consider the archive of tactics used within the period between three and twelve months preceding. If the determined tactic is present in the three to twelve months history of tactics, the IE 510 switches from state 546 to state 528. If the determined tactic is not present in the three to twelve months history of tactics, the IE 510 returns from state 546 to state 540.

I. Expert System Security Intelligence Layer

The ESSIL also encompasses the knowledge base which includes five sub-components:

1. The knowledge base for intrusion detection

2. The knowledge base of attack sequences

3. The knowledge base of UNIX communication utilities

4. ESSIL sorting engines

5. ESSIL search engines

Search engines are specialized to peak performance ratios against records searched and cached from previous search patterns. Each search engine is a process that is forked out upon request from an incoming transaction and is designed to fine-tune each search within a portion of shared memory reserved for each component searched. Searched components are broken down into subcomponents and sub nodes, whereby each sub node forms a subcategory of lists within shared memory to enhance the performance of each search.

I.A. Neural Network Sublayer

Artificial Neural Networks represent a well-known discipline in the cognitive sciences that have been developed to employ intelligence in an emulation of the human brain. A neural network is a massively parallel distributed processor comprised of simple, individual processing units. Neural Networks provide for storing and making available knowledge of experiences. In the case of the present invention, this knowledge pertains to experiences of the network under protection. Neural Networks acquire knowledge from the network environment it experiences by learning. Learning occurs when interneuron connection strengths, known as synaptic weights, are selectively used to store the learned knowledge. Modification of synaptic weights is a well known method of designing neural networks.

I.A.1 Event Learning Algorithms

The learning process is performed by one or more learning algorithms. The function of the learning algorithms is to modify the synaptic weights of the network in a controlled manner to attain a desired objective.

Knowledge Representation

Knowledge refers to the stored information or models used by the Neural Network to interpret, predict, and appropriately respond to the activation pattern. The information incorporated into the Neural Network is in the form of analogues which model the information. These analogue models are the Neural Network's representations of the information that has been learned as knowledge. The two primary characteristics of a knowledge representation are the explicit information learned, and how the information is physically encoded for subsequent use.

The Knowledge Representation executive of the Event Learning Algorithms is constructed with rules from observations. The observations are the various inputs to the Expert System which contain information pertaining to the operations of the protected constellation. The rules are the manner in which the observations are made. Rules are constantly evolving, through modification of existing rules and creation of new rules. The evolution of the rules is driven by the new knowledge the Network Surveillance and Security System develops by learning from observations.

Knowledge representation is goal directed. Maintaining the security of the protected constellation is the goal of the Network Surveillance and Security System. Among the major responsibilities of the Neural Network are learning models of the ideal security states of the systems, the protected constellation(s) that the systems are a part of, and the overall network environment in which the systems and constellations are embedded. Additionally, the Neural Network must maintain a model of the systems and constellations which closely represents their actual current security state. The Neural Network must also determine the means to maintain the actual current security state model sufficiently close to the ideal security state model so as to achieve the applicable security goals.

Knowledge of the system in its secured state includes two forms of information:

I) A known, secure state of the system. This form of knowledge is referred to as prior information.

II) Measurements of the system, obtained by monitoring output from UNIX processes designed to observe the protected environment. This form of knowledge is referred to as observations. The term Observables refers to points of observation. Ordinarily, these observations are inherently prone to errors in observables, being subject to monitoring errors and estimation imperfections. The observations provide the information for the examples used to train the learning by the Neural Network.

Four general rules that influence the representation of knowledge by the Neural Network are:

1. Similar inputs from similar classes are similarly modeled by the representations in the Neural Network. Optionally, the resulting similar models can also be classified in categories according to these similarities.

A commonly used measure of similarity is related to the distance between two points in an Euclidean space and is defined as:

If X₁ denotes a real valued vector of dimension m in an Euclidean space,

Xᵢ=[x₁, x₂, . . . xᵢₘ]^{T}

Where the superscript T denotes matrix transposition. The distance (D) between a pair of vectors xᵢ and xⱼ is defined as:

$$D ( {x}_{1} , {x}_{j} ) ≡ \vert {x}_{i} - {x}_{j} \vert = {[ {\sum }_{n = 1}^{m} {( {x}_{in} - {x}_{jn} )}^{2} ]}^{1 / 2}$$

where xᵢₙ and xⱼₙ are the n^{th} elements of the input vectors xᵢ and xⱼ, respectively. The dimensions m represent the qualities monitored for security protection. The distances along a given dimension would reflect the relative variations in the quantity represented by that dimension. An example of a quantity among the dimensions m would be the ip address of a user requesting access to the protected constellation. The ip address could be an unauthorized guest account on a computer which also hosts an authorized guest account. These two accounts ip addresses will differ by a relatively small amount and hence the distance separating their representations along the dimension that corresponds to ip addresses will also be small.

2. Dissimilar inputs from dissimilar classes are modeled by widely diverging representations in the network.

3. The number of neurons involved in the representation of a quality corresponds to the importance of that quality to the learning goals. Correlating the number of neurons involved in a representation with the importance of the item being represented is well known in the art. Detecting an attack in the midst of other system activities is an important goal of the Neural Network. The caliber of performance of attack detection is measured in terms of two probabilities:

Probability of detection, defined as the probability that the system correctly determines an attack is imminent or occurring.

Probability of a false alarm, defined as the probability that the system incorrectly determines an attack is imminent or occurring.

4. Prior information and invariances are integrated into the design of the Neural Network with a specialized (restricted) structure, as is well known in the art.

I.A2 Neural Artificial Intelligence (NAI)

Functions of an Artificial Intelligence (AI) system involve:

Storing knowledge,

Applying stored knowledge to problem solving, and

Acquiring new knowledge from experiences.

These three functions can be considered to be essentially making, using, and improving knowledge representations. The three key components of the Neural Artificial Intelligence Sublayer are representation, reasoning, and learning.

I.A.2.a Representations

The NAI uses language and symbol structures to represent both general knowledge of a domain of interest (such as general knowledge of the UNIX O/S and UNIX utilities), as well as more specific knowledge of problem solving (such as network security risks). Generally, the symbols are familiar terms, to ease understanding by a human user.

The NAI representations are constructed with an interplay between theorems and facts. The theorems are conjectures about the contents and uses of the NAI knowledge representations. The facts are tests of these conjectures, to aid in determining which theorems are to be incorporated into the AI knowledge representations.

I.A.2.a Reasoning

For an AI system to accomplish reasoning, it must satisfy the following conditions:

Able to observe and extract both explicit and implicit information.

Able to express and solve a broad range of problems and problem types.

Able to determine which operations to apply to a particular problem, when a solution to the problem has been obtained, and when to terminate further work on the problem.

The NAI reasoning is conducted in a manner that is similar to the manner of construction of the knowledge representation of A.1 Event Learning Algorithms—with rules, from observations.

I.A.2.c Learning

The NAI Learning component uses the improvements in knowledge bases made by the A.1 Event Learning Algorithms to improve the Neural Network Executive Program's use of the knowledge bases to perform its tasks. The Network Surveillance and Security System is designed with the cognizance that the information derived from the environment is often imperfect. Hence, the NAI Learning component does not know, in advance, how to fill in missing details or ignore details that are unimportant. The machine must therefore operate by guessing, and then receiving feedback regarding the performance results for those guess. The feedback mechanism enables the machine to evaluate its hypotheses and revise them if necessary. The NAI Learning will commonly operate by hypothesizing a theorem about the security state of the protected constellation, determining the validity of the theorem by comparing with observations, and incorporating into the knowledge base as facts those theorems which prove valid.

The NAI Learning involves two different kinds of information processing:

Inductive reasoning, and

deductive reasoning.

Inductive reasoning determines general patterns and rules from raw data and experience. Deductive reasoning uses general rules to determine indications in specific instances. Similarity-based learning is a type of inductive reasoning, whereas the proof of a theorem from known axioms and other existing theorems is a type of deductive reasoning. The NAI inductive reasoning can be considered a “top-down” approach, in which an accumulation of data is analyzed; patterns are resolved; and rules are constructed from these patterns. The NAI deductive reasoning can be considered a “bottom-up” approach, in which axioms are postulated; a scheme of rules are deduced from combinations of the axioms; and patterns of specific events are constructed from the scheme of rules. Another type of learning used, termed explanation based learning, draws from both induction and deduction. Explanation based learning is similar to drawing analogies and will be detailed in more depth in the following description of the Genetic Programming Sublayer.

I.A.3 Neural Network Security Algorithms

The algorithms that the Neural Network uses are constructed from processes which model neurons that are interconnected into a network.

I.A.3.a Neuron Models

The simple, individual processing units which comprise Neural Networks are termed neurons. Neurons, in one form or another, are common to all neural networks. Their common compositions enable differing Neural Network applications to share theories and learning algorithms.

There are three basic elements of the neuronal model:

A set of synapses or connecting links, each of which is characterized by a weight or strength of its own. Specifically, a signal xⱼ at the input of synaptic link to neuron k is multiplied by the synaptic weight wₖⱼ. The first subscript of wₖⱼ refers to the neuron in question and the second subscript refers to the input end of the synapse to which the weight refers.

A Summing Junction for summing the input signals, which are weighted by the respective synapses of the neuron; the operations described here constitute a linear combiner after weighting and biasing.

An activation function limits the amplitude of a neuron's output. The activation function is also referred to as a squashing function in that it squashes (limits) the permissible amplitude range of the output signal to some finite value.

FIG. 6 depicts a schematic of a model of a Neuron Processing Unit 610. Neuron 610 receives one or more Input Signals 612 (xₗ through xₘ) over the Synaptic links 614. Neuron 610 multiplies these Input Signals 612 with the Sysnaptic Weights 616 (wₖₗ through wₖₘ, resectively) to produce the Weighted Signals 618 (xₗ wₖₗ through xₘ wₖₘ). A Summing Junction 620 combines the Weighted Signals 618 under the influence of a Bias 622 (bₖ). A Summing Output 624 (vₖ) of the Summing junction 620 is input as the argument of an Activation Function 626 (φ). The Neuron Output 628 (Yₖ) is then communicated over the Neuron's Activation link 630.

The neuronal model in FIG. 6 includes a bias, denoted by bₖ. The bₖ has the effect of increasing or lowering the net input of the activation function, depending on whether it is positive of negative, respectively. It should be noted that the neuron k is depicted as having a single activation link for purposes of clarity only. Alternatively, neuron k could have a plurality of activation links. Similarly, it should be noted that though neuron k is depicted as having a plurality of synaptic links, it alternatively could have just a single synaptic link.

The neuron K is defined by the following mathematical relations:

yₖ=φ(vₖ)

where, vₖ≡ The Threshhold Function, is

vₖ=uₖ+bₖ and,

$${u}_{k} = {\sum }_{j = 1}^{m} {w}_{kj} {x}_{j}$$

The Activation Function, denoted by φₖ determines the output Yₖ of neuron k. The value of the Threshold Function vₖ is the argument of the Activation Function φₖ. The Activation Function φ may assume a variety of forms. The flexibility in the forms of φ enables the Neural Network to more efficiently learn knowledge of greater complexity.

One example of a Threshold Function φₖ is:

$${ϕ}_{k} ( {v}_{k} ) = \{ \begin{matrix}1 & if {v}_{k} \geq 0 \\ 0 & if {v}_{k} < 0\end{matrix}$$

A second example of a Threshold Function φₗ is:

$${ϕ}_{l} ( {v}_{l} ) = \{ \begin{matrix}1 & if {v}_{l} \geq + 1 / 2 \\ {v}_{l} & if - 1 / 2 < {v}_{l} < + 1 / 2 \\ 0 & if {v}_{l} \leq - 1 / 2\end{matrix}$$

I.A.3.b Symbolic Representations

Networks

Constellations

Systems

Neural Network Assembly

Neurons are assembled into neural networks by the formation of interconnections between the neurons. These interconnections are made when an activation link of a first neuron meets a synaptic link of a second neuron. The activation link of a neuron carries an output signal from that neuron. The synaptic link of a neuron carries an input signal to that neuron. Synaptic links are generally, but not exclusively, governed by a linear input-output relation. Activation links are generally, but not exclusively, governed by a nonlinear input-output relation.

The Neural Network can also incorporate feedback mechanisms either by a direct connection between the synaptic and the activation links of a neuron, or indirectly via intermediary neurons between the synaptic and activation links of a neuron.

The overall structure of a Neural Network can be characterized as an assembly of linked nodes, where the neurons are located at nodes. The assembly of neurons into a Neural Network is directed by the following rules:

#1) A signal flows along a link in a single direction defined by whether it is a synaptic (and hence in the incoming direction) link or an activation (and hence in the outgoing direction) link.

Two different types of links may be distinguished by the following:

Synaptic Links. Links whose behavior is generally linear. Specifically, the mode signal xⱼ is multiplied by the synaptic weight wₖⱼ to produce the mode signal yₖ, as illustrated above in FIG. G.

Activation links. Links whose behavior is governed in general by a nonlinear input-output relation. This form of relationship is illustrated above in FIG. G as well.

#2) An incoming node signal is the aggregate of the signals entering the node over the sum of its synaptic links.

#3) The signal from a node is transmitted to each outgoing link originating from the node, with the transmission being entirely independent of a transfer function of the outgoing links. An example of an interneuron transfer function is uₖ of FIG. 7 (depicted immediately below). It is also possible to model the operation of an interneuron transfer with the neuron model of FIG. 7 by appropriate selections of the mathematical relations which define the neuron. The uses and operations of interneuron transfer functions in constructing Neural Networks are well known in the art.

FIG. 7 depicts an example of an interneuron transfer function 710. A plurality of input signals xₗ→xₙ 712 are weighted 714 and biased 716. The weighted and biased inputs are processed by an interneuron transfer function uₖ 718. The resulting output φ 720 is then relayed to the next Neural Network node 722.

Network Architecture

The manner of construction of a neural network from neurons is intimately linked with the learning algorithm used to train the network. Constructing the Neural Network according to rules which result from a learning algorithm produces a Neural Network capable of learning.

Multilayer Feedforward Networks

A feedforward neural network is distinguished by the presence of one or more hidden layers. The computation nodes of hidden layers are correspondingly termed hidden neurons or hidden units. The function of hidden neurons is to intervene between the external input and the network output in some useful manner. By adding one or more hidden layers, the network can extract higher-order statistics. Higher-order statistics can relate to predicted events. One example of a higher-order statistic extracted by the present invention is the probable outcome, for the security of a protected constellation, of a particular response to an observed network activity. Other statisitcs would include probable outcomes for a system within the Protected Server Constellation, a particular resource within a particular system, or an account within a particular system within a Protected Server Constellation.

Source nodes comprise the input layer of the Neural Network. The inputs from outside the Neural Network interface with the neurons which comprise the Neural Network at the source nodes. The source nodes supply the elements of the incoming activation pattern (input vector) which is applied to the neurons at the computation nodes in the first hidden layer. The output signals of the first hidden layer are used as inputs to the third hidden layer, and so on throughout the Neural Network. Typically, the only inputs to neurons in a layer of the network are the preceding layer's output signals. More complex forms of network layer interrelations can also provide benefits, and are implemented by the present invention when indicated. The greater complexities can include, but are not limited to, output signals skipping layers, inputting to pluralities of layers, inputting to previous layers, or inputting to the same layer. The set of outgoing signals of the neurons in the output (final) layer of the Neural Network constitute the overall response of the Neural Network to the input vector.

Evolutionary algorithms can represent a binary genome as a string of bits. Each binary genome has a particular meaning. Each character bit in a string represents a value of a particular neuron in a Neural Network. A Neural Network Genetic Algorithm Mapper Matrix produces a finite state map which represents the Expert System Security Intelligence Layer interrelationships of the Neural Network and the Genetic Algoithms.

FIG. 8 is a schematic depiction of a single program that performs a typical single function within the network surveillance and security system. A general procedures 812 encompasses a single-component of the Network Surveillance and Security System operations. The depiction is of a typical UNIX background (Daemon) with design modifications of genetic programming operations 814 and Neural Network operations 816. The general procedures 812 are outside of the Expert System Security Intelligence Layer, but are monitored by the Expert System Security Intelligence Layer. A Network Surveillance and Security System input 818 receives inputs from other similar Network Surveillance and Security Systems processes running in tandem. A Neural Network input 820 and a genetic programming input 822 receive information from other neurons and genomes, respectively. An output 824 sends information out to other Network Surveillance and Security System processes also running in tandem. An output 826 sends out information to Neural Network neurons. An output 828 sends out information to genetic programming genomes.

I.B. Genetic Programming (GP) Sublayer

Genetic Programming is a well known application of Artificial Intelligence. The GP Sublayer uses Genetic Programming to test the validity of the Network Surveillance and Security System knowledge base. GP is also used to expand the knowledge base both by learning to recognize new patterns in network traffic for detecting intrusions and attacks, as well as by exploring new response strategies to intrusions and attacks. The GP sublayer uses both evolutionary and co-evolutionary modeling. Whether modeling network traffic or responses, a population of processes is assembled which encompass a range of the possibilities that are being modeled. Evolutionary modeling drives that population into another, more-fit population by application of a selection criteria. Co-evolutionary modeling mates the most fit species from one or more populations to produce a new population that can provide a combination of the prior populations' benefits. Co-evolution is one form of fitness based testing that is well known in the art. Co-evolution begins with an initial population of processes. A separate population encoding a variety of fitness tests is co-evolved from the original population by allowing performance on fitness tests to influence the survival of the constituents of the two populations. Both populations share the same operating environment. Both populations are allowed to evolve, with weaknesses of the first population being exploited by the second and vice-versa. Both populations improve their fitness in response to the criteria in their respective evaluation functions. The evaluation function can also change dynamically between differing levels of evaluation rigor. While one embodiment of the present invention will customarily use two populations, the number of populations is not, in principle, limited. The available information processing resources and performance requirements of the NSSS will effect the number of populations used.

Genetic Programming: Mating Procedure

Mating is the creation of one or more offspring from the parents selected in the pairing process.

FIG. 9 depicts a procedure 910 for conducting Genetic operations on a population. A first step 912 Defines the population parameters, the cost function parameters, and the estimated cost of a population. A second step 914 identifies the location of the process overlay code for the offspring processes in the new population. A third step 916 creates the initial population of proceses. A fourth step 918 evaluates the cost. A fifth step 920 Selects mates from the mating pool within the initial population. A sixth step 922 conducts reproduction to produce child processes. A seventh step 924 conducts mutation of the child processes. An eighth step 926 tests for convergence of the child processes with security goals. A seventh step 928 determines whether or not the convergence tested in step eight is favorable. If the convergence is not favorable, the procedure returns 930 to the fifthe step 920 to retry the mating, reproduction, and mutation steps. If the convergence is found favorable 932, then the resulting process is output and the procedure is stopped 934.

A UNIX process is selected as a parent process to respond to a specific security threat. When the system determines a class of threats are present, the GP selects a set of parent processes to create the initial population of security guards and surveillance agents to respond to the threat.

Two processes are selected as parent processes to run as daemons on the system. The two parents will run independent of one another and reproduce by undergoing a mating procedure to produce offspring processes.

The fork system call is used to produce a child process. One of the parent processes is the female process. The female process calls the fork utility and produces the child process. The child process is a duplication of the code of the female process and obtains the file descriptors passed on by the female process.

During reproduction a “male” Type XY process must also be selected in addition to the selection of a female process. The type XY process passes the type XX “female” parent process parameters indicating the location of a stored UNIX file. The stored file is a UNIX executable similar to each of the Types XY & XX parent processes. The stored file was constructed from security and surveillance commands from both parents, as well as commands from a database of security and surveillance commands that were constructed from theorems derived from obserables of perceived recent threats. One-third of the security and surveillance commands are taken from each parent and one-third is from the database commands. The security and surveillance commands are a combination of the operations carried out by both parents in response to the potential threats to their generation of processes. The commands are grouped against an observed threat by the construction of a Neural Network of commands. The Neural Network of commands is designed to determine the best command structure observed against an observed potential threat. The commands taken from the parents are classified according to their effectiveness against the observed threat or their effectiveness in expunging a portion of that threat. The commands are classified using a constructed Neural Network designed to determine how well the parents were able to use them to respond to observed events that were examined as potential threats to the security of the Protected Server Constellation.

A child process undergoes a mutation procedure by using the “exec” system call which requires the parameters passed on to its mother (female parent) process by its father (male parent) process. The child uses the “exec” system call utility to overlay the initial code (a duplication of the code of its mother) with the code that exists at the location pointed to by the parameters from the father. The child process is a member of the new generation, as are other sibling processes from the same two parents.

Any selected parent process of Type XX may be paired with another parent process of Type XY (since they are of the opposite gender). The variation in pairings will produce offspring that have varying abilities to perform security protection operations to counter a given security threat.

The effectiveness of a population is evaluated. A population's quickness and effectiveness in restoring the system back to its ideal state of security is expressed as a rating. Such evaluations can be in terms of both time and performance. Performance can be defined as performance degradation and operating efficiency. When a population of responses has a cost that passes a defined critical point (cost meaning both efficiency of the response to the threat and effect of the response upon the performance of Protected Constellation), a new population is constructed based on events observed by the present population. Each population retains its knowledge of observed phenomenon for cross-referencing with knowledge base theorems and facts before a succeeding population is constructed. Observations produce results that can:

generate additional commands;

alter the sequences of commands; or

modify the parameters that the commands operate on in order to produce and achieve different results.

The commands, their altered sequence, and/or the modification of the parameters they operate on are all collected in a UNIX file and stored to form an executable. This procedure is conducted by the parent process of Type XY which passes the location of this file (under UNIX known as a path variable) to the parent process of Type XX during the mating procedure that produces a child process.

The Genetic Programming Executive Program is comprised of the steps:

| step # | step name | step procedure |
|---|---|---|
| 1 | INIT POP | Begin construction of a new population. |
| 2 | EVAL | Individual processes in existing population are assigned fitness |
| | | ratings according to a defined criteria. |
| 3 | UNTIL | Until the new population is fully populated, repeat: |
| | | -select an individual process in the population using a selection algorithm; |
| | | -Perform genetic operations on the selected process(es); |
| | | -Insert results of genetic operations into new population. |
| 4 | IF | If a designated termination criteria is fulfilled, then continue to |
| | | step 5; if not, replace the existing population with the new |
| | | population and repeat steps 2-4. |
| 5 | END | Present the best individual, according to the rating determined in |
| | | step 2, in the population as the executive program algorithm's |
| | | output. |

I.B.1 Research Functions

Features (inputs)

Classes (outputs)

I.B.1.a Training Domains

Features (inputs)

Classes (outputs)

I.B.1.b Learning Domains

Features (inputs)

Classes (outputs)

I.B.2 Acceptance& Validation

Features (inputs)

Classes (outputs)

I.B.2.a Learning Domains

Features (inputs)

Classes (outputs)

I.B.2.b Testing Domains

Features (inputs)

Classes (outputs)

I.B.3 Machine Learning Algorithms

Features (inputs)

Classes (outputs)

I.B.3.a Training Domains

Features (inputs)

Classes (outputs)

I.B.3.b Acceptance & Validation

Features (inputs)

Classes (outputs)

II. COMMUNICATION SYSTEM LAYER (CSL)
CSL EXECUTIVE PROGRAM

II.A Neural Network information Routing
II.B Genetic Programming Information

Routing

II.C.1.a ROUTING

CONVERSIONS

i. Expert Personalities

Information

ii. Translators &

Converters

II.C.1.b NEURAL

NETWORK
Process Control
Communication

II.C.1.c NEURAL

NETWORK
Process Management
i. UNIX
ii. Neural Network
Processes

II.C.2.a BASIC SECURITY

PROCESSES
Translators &
Converters

II.C.2.b CONSTELLATION

SERVERS

Process Control
Communication

II.C.2.c CONSTELLATION

SERVERS

Process Management
i. UNIX
ii. Pocesses on
Constellation
Servers

II.C.3.a COMMAND

PROCESSES
Translators &
Converters

II.C.3.b GENETIC

PROGRAMMING
Process Control
Communication

II.C.3.c GENETIC

PROGRAMMING
Process Management
i. UNIX
ii. Expert System
Genetic
Programming
Processes

II. Communication System Layer

The processes of the Communication System Layer (CSL) mediate exchanges of information between the Expert Security System Intelligence Layer (ESSIL) processes and the Communication Infrastructure and Interface Layer (CIIL) processes. The ESSIL conducts the higher order analysis of and learning about information relating to the operations of the protected constellation. The CIIL processes incorporate information which directly models the traffic of the protected constellation. The CSL manages the routing of information between the various parts of the CIIL and the ESSIL. The CSL also enables any process of the CIIL and any process of the ESSIL to communicate regardless of any differences in their protocols.

Among the functions accomplished by the CSL are:

Routing of the CIIL processes to the appropriate ESSIL processes for analysis and learning.

Routing of the resulting ESSIL processes to the appropriate CIIL processes for operation on the protected constellation.

Managing of CIIL and ESSIL process interlayer communications.

Translating and packaging of interlayer communications to enable successful communication between differing forms of processes.

The CSL Executive Program controls the operations of the sublayers II.A and II.B, the Neural Network Information Routing and the Genetic Programming Information Routing, respectively. Layer II routes Neural Network and Genetic Programming input-output information from Network Surveillance and Security System processes to and from the Neural Network and Genetic Programming sub-layers, respectively. The sub-layers II.C are not subordinate to the sub-layers II. A. and B, but rather have general relationships with the start and end points of the communications they route. Accordingly, the placement of the components within the sub-layers II.C reflects the source/destination in the Expert System Layer of the communications they assist in routing. Processes in the components of sub-layers II.C.1. provide support of routing functions for the Neural Network communications. Processes in the components of sub-layers II.C.3. provide support of routing functions for the Genetic Programming communications. Processes in the components of sub-layers II.C.2. provide support of routing functions for both the Neural Network and Genetic Programming communications, and are hence bridging between sub-layers II.A. and II.B.

III. COMMUNICATION INFRASTRUCTURE AND
INTERFACE LAYER (CIIL)
CIIL EXECUTIVE PROGRAM

```
III.A Storage System Executive Program
III.B Network Interface Executive Program
III.C.1.
EXPERT PERSONALITIES
III.C.1.a
UNIX File System Utilities
UNIX Commands
  BSD4.4 Commands
  SVR4 Commands
III.C.2.
BASIC SECURITY
PROCESSES
III.C.2.a
Communication utilities
  Encryption Executive
Program
III.C.3
COMMAND PROCESSES
III.C.3.a
UNIX Control Utilities -
Version
  BSDU Commands
  FreeBSD
  IBM-AIX
  SVR4 Commands
  HP-ULTRIX
  Linux
  Solaris
  Digital Unix
III.C.1.b
Databases
i. Security Reference
Database (SRD)
  Intrusion Reference
  Data
  Attack Sequences
  Data
ii. Security Reference Model (SRMD)
iii. Security Reference Monitor (SRMN)
iv. Security Authorization Database (SAD)
v. Authorization Access Model (AAM)
  Authorization Profile (AP)
  Unauthorized Profiles
III.C.2.b
Process Control
Management
i. Interprocess Communication (IPC)
  Pipes
  Named Pipes
  STREAMS
  Sockets (internal)
  Socket (external)
ii. Domain Control
Program
  Local
  internet
III.C.3.b
Hardware Interfaces Control
  Message Channels
  Ethernet
  Token Ring
  FrameRelay
  ATM
  BroadCast (M-Bone)
  RS-232
  V35
III.C.1.c
Rule Based Personalities
System
i. God Process
ii. Demon Process
iii. Support Team
iv. Surveillance Intelligence Forces (SIF)
  Servants
  Knights and Spies
  Agents
  Archangels
  Angels
v. Military Intelligence
Army
  Captain
  Lieutenants
  Sergeants
  Corporal
  Constellation Guards
  Infantry Server Guards
III.C.2.c
Security Access
Controller Executive
i. Constellation
  Access Record Logger (CARL)
  Address Mapper (CAM)
  Port Monitor & Controller
  System Logger (SYSLgr)
ii. File System Watch
Dogs
  root file system guard
  user-bin guard
  slash-etcetera guard
  slash-bin guard
  File Permission Guards
  File Access Guards
iii. Directory Watch Dogs
  Group Permission Guards
  Directory Access Guards
III.C.3.c
Portmon (PM) Executive Program
  Routers/Firewalls
  Access Record Logger (RFCarl)
  Address Mapper (RFCam)
  Port Monitor & Controller
  System Logger (RFSYSLgr)
```

Communication Infrastructure Interface Layer

The following UNIX Utilities are among the components of the Communication Infrastructure Interface Layer of the Network Surveillance and Security System:

Local Communications Domain

The local domain for the Network Surveillance and Security System is the UNIX domain. The communications between processes within the Communication Infrastructure Interface Layer use data abstracts such as sockets, full duplex pipes, semaphores, and streams within the UNIX domain. These communications are referred to as Interprocess Communications (IPC). IPC Socket Streams under the UNIX domain provide communication functions for several distinct UNIX architecture brands. Though each of the UNIX architecture brands use different syntaxes, the semantics are the same.

Three IPC Socket type data structures are used:

1. Full Duplex Pipes

2. Stream (AT&T) sockets

3. Datagram (BSD) sockets

Other Interprocess Communications used are:

Communication via files

Blocking files procedure

Pipes

Semaphores

Shared Memory

internet Sockets (sockets in the internet Domain)

FIG. 3-98 on pg. 166 of Prabhat K. Andleigh's “UNIX System Architecture”, Prentice Hall PTR, 1990, depicted in FIG. 10, illustrates the AT&T UNIX System V Streams-based networking model 1010. The Streams Model is depicted in relation to the layers of the OSI Reference Model. At the OSI Application Layer, The User Application 1012 communicates through I/O System Calls 1014 with Streams Interface Modules 1016. The Streams Interface Modules 1016 at the OSI Session Layer communicates with Kernel Service Routines 1018. The Kernel Service Routines 1018 at the OSI Transport & Network Layer communicates with Protocol Modules 1020. The Protocol Modules 1020 at the OSI Transport & Network Layer communicate with the OSI Data Link & Physical Layer Communication Hardware 1022 such as SNA, Ethernet, and Token Ring.

The underlying architecture of a stream in the UNIX kernel as described in FIGS. 3-99 on pg. 167 of Prabhat K. Andleigh's “UNIX System Architecture”, Prentice Hall PTR, 1990, is depicted in FIG. 11. The AT&T Streams Model bridges between the User Space 1112 and the Kernel Space 1114. A User Application 1116 passes information to a System Call Library for Transport Protocols 1118 and System Call Dispatch 1120. The System Call Library for Transport Protocols 1118 and System Call Dispatch 1120 pass information to a Stream Head 1122. The Stream Head 1122 passes information to a Multiplexor Module 1124. The Multiplexor Module 1124 directs information to and from optional Net 1, Net 2, and Net 3 (for example) information processing modules 1126, 1128, and 1130, respectively. The optional information processing Modules 1126, 1128, and 1130 may, for example, do canonical conversions. The modules 1126, 1128, and 1130 may, for the depicted example, process data which travels to and from, an Ethernet driver 1132, LAPB driver 1134, or IEEE 802.2 driver 1136, respectively. Messages passing from Stream Head to Driver travel Downstream 1138, and those passing from Driver to Stream Head travel Upstream 1140. The AT&T streams architecture as described in FIGS. 3-100 on pg. 168 of Prabhat K. Andleigh's “UNIX System Architecture”, Prentice Hall PTR, 1990, is depicted in FIG. 12. A RFS Utility 1212 passes information through a System Call Library for Transport Protocols 1214 to and from a System Call Dispatch 1216. The information then travels to and from the System Call Dispatch 1216 through a Transmission Control Protocol 1218 to and from either Kernel Service Routines 1220, or through an Internet Protocol 1222 to and from an Ethernet 1224 connection.

The RFS architecture as described in FIGS. 3-101 on pg. 169 of Prabhat K. Andleigh's “UNIX System Architecture”, Prentice Hall PTR, 1990, is depicted in FIG. 13. FIG. 13 illustrates the RFS architecture 1310 divided between the client side 1312 and the server side 1314 of the RFS interface. On the client side 1312, a client system call 1316 passes to the client RFS 1318 which passes data to the client UNIX file system 1320 and to client streams 1322. The client streams 1322 passes the data to a client network protocol translator 1324 which conveys the data out over the network 1326. The network then conveys the data to the server network protocol translator 1328 on the server side which passes the information to server streams 1330. The server streams 1330 passes the data to a server RFS 1332. The server RfS 1332 passes the data to a server UNIX file system 1334. The server RFS 1332 also receives system calls 1336.

The SUN Micro-systems Network File System (NFS) as described in FIGS. 3-102 on pg. 170 of Prabhat K. Andleigh's “UNIX System Architecture”, Prentice Hall PTR, 1990, is depicted in FIG. 14. FIG. 14 illustrates the NFS architecture 1410 divided between the client side 1412 and the server side 1414 of the NFS interface. On the client side 1412, a client system call 1416 passes to the client VNODE/VFS 1418 which passes data to the client 4.2bsd file system 1420 and to a NFS file system 1422. The client NFS file system 1422 passes the data to a client RPC/XDR 1424 which conveys the data out over the network 1426. The network then conveys the data to the server RPC/XDR 1428 on the server side which passes the information to server routines 1430. The server routines 1430 passes the data to a server VNODE/VFS 1432. The server VNODE/VFS 1432 passes the data to a “Virtual File System” (not depicted). The server VNODE/VFS 1432 also receives system calls 1434.

In the UNIX domain, The Network Surveillanc and Security System uses one or more of the above data structures to communicate between processes for distribution of event information. The processes both receive information about events and provide event information to the Communication Systems and the Expert System Security Intelligence Layers. Specifically, The Network Surveillanc and Security System passes the information to the upper layers through data abstracts termed pipes, which are full duplex channels for sending and receiving information.

Socket Layer

The Network Surveillanc and Security System uses Stream sockets to communicate between processes within a single guard layer and between processes in differing guard layers. Stream sockets are reliable and deliver data in the order in which it was sent.

Network Protocols Center

The Network Protocol Center is a sub-layer to the Communication Infrastructure and Interface Guard Layer. The Network Protocol Center provides the Network Surveillance and Security System with tools for communicating across the internet and between network systems. Within the Network Protocol Center is a specialized sub-center for performing secure encrypted communications. The data encryption center is termed Privisea™ (see Section E).

Unix Utilities

Labrys™ uses UNIX utilities applicable for the various versions of the UNIX platform, including:

Daemon Processes CIIL Layer

Labrys™ daemons operate as background processes that stay active after their creation and terminate only when the system is shutdown. They also run without a controlling terminal. Daemons processes perform day-to-day activities at scheduled times.

Examples of commands for Daemon processes include:

ps-axj under BSD or SunOS where the -a option shows the status of processes owned by others, the -x option shows processes that do not have a controlling terminal, and the -j option displays the job-related information such as: session ID, process group ID, controlling terminal, and terminal process group ID. Under AT&T SVR4, a similar command to the ps-axj is: ps-efjc.

CIIL Process/ Hardware Component Interactions

The processes under the control of the CIIL_Interact with the following network hardware components:

Ethernet Hub: The Network Surveillance and Security System ports are bonded to the servers of the protected constellation through connection to an Ethernet hub of the protected constellation. This connection provides access to traffic on the ports of the servers being protected.

Ethernet Switch: Connection to an Ethernet switch provides the Network Surveillance and Security System ports with connections to the servers it protects through surveillance of a secured channel on the sub network. The secured channel enables communication between protected servers without other servers being able to eavesdrop.

Encryption Machine: Provides the Network Surveillance and Security System with an encryption mechanism to securely communicate data both within a protected constellation as well as between separate protected constellations.

III. CIIL Executive Program

Process Surveillance and Analysis

Previously, surveillance systems have only observed traffic crossing over ports. Surveillance of traffic native to the network itself has not generally been done. The Network Surveillance and Security System conducts surveillance and analysis of all native and non-native network processes.

Session Management and Session Simulation Management

A user on the network will generally have a number of processes operating during a session of user activity. These processes will generally comprise a family of related processes that are children of the login shell.

The steps comprising the method of controlling access under the SVR4 operating system model are:

The init process forks a child for each terminal listed in the/stc/inittab file.

The child process calls setpgrp, becoming a group leader, and then execs the getty program, which displays a login prompt and waits for input.

When a user types in his login name, getty execs the login program, which asks for and verifies the password, and finally, execs the login shell.

The login shell is thus a direct child of init, and is also a process group leader. As a rule, no other processes can become a group leader and do not create their own group (except for system daemons started from a login session). Hence, all processes are either children of the init process or are started from a login shell.

Types of process groups in SVR4 are:

Controlling terminal

Terminal access

Terminal signals

Dispatching the terminal

Death of Group leader

Types of process groups in the BSD operating system model are:

Jobs

Login sessions

Controlling Terminal

Terminal Access

Controlling Group

Closing the terminal

Another of the significant responsibilities of the CIIL Executive program is the time-managemnt of the Protected Constellation CPU's attention to the various active processes. This time-management is accomplished with a process scheduling scheme.

Process Management

The Network Surveillance and Security System uses a novel scheduling approach that conducts time management of processor unit(s) in accordance with the Digital UNIX (DU) Real-time Scheduler Scheme. The DU Scheduler Scheme supports both real-time and time-sharing applications It complies with the POSIX 1003.1b interface [IEEE93] that defines real-time programming extensions. The DU Scheduler Scheme supports the following three scheduling classes:

Scheduling Classes

| | |
|---|---|
| SCHED_OTHER, | time-sharing |
| SCHED_FIFO, | first-in first-out |
| SCHED_RR, | round-robin |

The Network Security and Surveillance System is a time critical system running time-critical event analysis and processes. The Network Security and Surveillance System uses a NSSS process scheduler to handle real-time process applications that should not be preempted by the UNIX system kernel. All processes that are potentially preemptable run with the Network Surveillance and Security System NSSS scheduling scheme that sets forth priority levels for the manner that they are executed by the CPU. This scheduling scheme will then return resources to the Network Surveillance and Security System promptly upon completion in order to self-correct any errors of process or queue blocking.

The real-time class uses priorities in the range of 100-159. These priorities are not only higher than those of any time sharing process, but are even higher than those in the kernel. Hence, a process in the real-time class will be scheduled before any kernel process.

Real-time processes are characterized by the fixed priority and time quantum. The only way the real-time process can change is if the process explicitly makes a priocntl system call to change one or the other of its process scheduling parameters.

The Network Security and Surveillance System uses its NSSS Real-time process scheduler by invoking a system call to sched_setscheduler to set the scheduling class and priority of a process. The default action is set the default class as time-sharing. Time-sharing varies process priorities dynamically, based on the nice value and the CPU usage. The FIFO and round-robin classes use fixed priorities. Surveillance Processes using a SCHED_FIFO policy have no time quantum and continue to run until they voluntarily yield the processor or are preempted by a higher-priority process. The time-sharing and round-robin classes impose a time quantum, which affects scheduling of processes at the same priority. When a time-sharing or round-robin finishes its quantum, it goes to the end of the process list or its priority. Of course, if there are no runnable processes at higher or equal priority, the currently running process must continue to run. The scheduler used must always run the highest-priority runnable process. Each process has a priority in the range of 0 to 63, with smaller numbers denoting lower priorities. The scheduler maintains an ordered queue for each priority, and selects the process at the front of the highest nonempty queue. When either a blocked process becomes runnable, or a running process yields the processor, that process must usually be placed at the end of the queue for its priority. The only exception is when a process is preempted before it finishes its quantum. Under this case, the process is returned to the front of its queue, so that it will be allowed to finish its quantum before running other processes with the same priority.

Overlapping priority ranges for the three classes will allow greater scheduling flexibility. Following are a list of rules that govern the assignment of process priorities:

Time-sharing processes have priorities between 0 and 29.

Time-sharing processes must have a Superuser privilege to be raised above the priority level of 19 on most systems.

Application processes control time-sharing priorities by changing the nice value of the process via the nice system call. The nice values range from −20 to +20, with smaller numbers denoting higher priorities (such as for daemons and demons that are agents and servants processes). These processes must have Superuser privileges to set negative nice values, which correspond to process priorities within the range of 20 through 29.

The CPU usage factor reduces the priority of time-sharing processes according to the amount of CPU time received.

System processes all have fixed priorities in the range of 20-31.

Fixed-priority processes are assigned priorities within the range of 0 through 63. Superuser privileges are required on processes that attempt to assign priorities higher than 19. All processes with priorities that fall within the range of 32 through 63 are real-time processes, since these processes cannot be preempted by system processes.

The system call utilities used under the NSSS real-time scheduler include sched_setparam calls, which are used to change the priorities of processes in the FIFO and round-robin classes.

Additionally, the sched_yield system call utility is used to place the process at the end of the queue for its priority, thereby yielding the processor to any runnable process at the same priority level.

III.A. Storage System Executive Processes

III.B. Network interface Executive program

III.C.1 Expert Personalities Executive??

III.C.1.a UNIX File System Utilities

III.C.1.b Databases

Policies

Policies govern access rights to various databases in the network under protection of the Network Surveillance and Security System. These policies are initially input to the knowledge base by a system administrator. The Network Surveillance and Security System may also autonomously expand or revise these policies, in accordance with operating objectives and allowances set by the system administrator, when determined necessary. Four sets of policies included in the Network Surveillance and Security System that govern access to databases are:

1. File system policies

2. Network policies

3. Access Right policies

4. Group sharing policies

A sub-group of these policies are Interface policies. These policies govern any type of access to a server in the Protected Constellation. The Interface Policies are:

1. Host to Host System interface Policies

a. Database

i. Host name

ii. Host address

1. IP address

2. Ethernet address

iii. Remote Host

1. IP address

2. Ethernet address

iv. Host Relationship

v. Security Policies

vi. User Accounts

vii. System Administrators

2. Trusted Host System policies

a. Database

i. Host name

ii. Host address

1. IP address

2. Ethernet address

iii. Remote Host

1. IP address

2. Ethernet address

iv. Remote Host Relationship

v. Security Policies

vi. User Accounts

vii. System Administrators

3. External Host System interface policies

a. Database

i. Host name

ii. Host address

1. IP address

2. Ethernet address

iii. Local Host

1. IP address

2. Ethernet address

iv. Local Host Relationship

v. Security Policies

vi. User Accounts

vii. System Administrator

Of the above policies groups, the first group—Host to Host—is applicable to any type of access of a server in the Protected Constellation. The other two groups apply to sub-groups of the users accessing the Protected Constellation databases. The second group is applicable to those defined as Trusted Hosts, and the third group is applicable to those who are accessing the Protected Constellation from a system which is external to the Protected Constellation. The first group of policies will always apply to any user, and the second or third group may also apply. The scrutiny of the access for the trusted hosts is not any less stringent than for the external hosts since they are privy to more sensitive Protected Constellation resources, and therefore present a great potential risk. The external hosts are heavily scrutinized also, since they are potentially unknown. The policies as a whole are input by the system administrator, and are part of the raw data that sub-layer III.C.1.b. Databases are derived from.

III.C.1.c Rule-based Personalities System

i. Commander

A Commander is the Executive process that is launched first and creates all other processes that perform the functions of the Network Surveillance and Security System. There may be only one Commander process, but the number of commader processes is not limited to only one. Upon launching, it sleeps until awoken by a signal from the SIFs (described below) to create Troops that launch an Attack Response, or to issue an order to disband Troops by killing off unneeded processes and performing garbage collection of memory. The Commander process also sends keep alive signals to other Commander processes of remote Network Surveillance and Security Systems. Archangel processes perform communications across networks between remote Network Surveillance and Security Systems for the Commander processes.

ii. Demons

Specialized Demon background processes are used by this sub-layer after an attack to gather information about attackers. Once an attack is encountered, the specialized demons lock further attacks from the source of the attack. The specialized demons record information about the type of intruder/attacker from logs and Archangels. This information includes the intruder/attacker's host Network address, and the file system that was attacked. The specialized demons deliver this information to Military Intelligence Armies (MIAs)—described following in sub-layer III.C.1.c.v. This information enables the MIAs to perform operations on Router filters that will block subsequent attacks from the intruder/attackers by filtering out all IP addresses from the source address of the intruder/attacker.

iii. Support Team

A support team is comprised of background processes that fulfill supporting tasks for the above higher order personalities.

iv. Surveillance Intelligence Forces (SIFs)

A variety of processes, their functional differences characterized as personalities, comprise the SIFs. The SIFs are thus able to perform an assortment of roles. SIFs sniff through information gathered by Knights and Spies (KnS). The SIFs sort through information collected from IP traffic and decompose data packets in the traffic into data formats suitable for reading by III.C.1.c.i Constellation Commanders. The later reading determines if there is a security threat within the flow of traffic through a port. Early breaches in security are discovered by a SIF sniffing Ethernet Packets and using Agents to transport surveillance information to the SACe. SIFs are the first line of defense for detecting security threats to a Protected Constellation. The SIFs provide monitoring for the detection of an unauthorized entry into both the Protected Server Constellation, as a whole, and any machine with protected files systems in the Protected Server Constellation.

Among the process personalities which comprise the Security Intelligence Forces are:

Servants (Sv-x)

Servants are communication processes that feed information into buffers and retrieve information from buffers. Servants are also responsible for performing sort, search, insertion, and extraction routines against databases. Servants are assigned to localized environments within a machine to perform local rudimentary tasks following the arrival of data or task preparation for the departure of data.

Knights and Spies (KnS)

Knights and Spies are dual personality processes that launch attacks against unauthorized processes and recover from an attack or illegal entry. Knights are the attack personality and they launch UNIX utilities that kill processes. The dual personality provides a KnS process with the ability to act as a Spy until the KnS is needed to act as an attack process against an unauthorized attempt to execute an action on a file or directory, or an unauthorized attempt to enter a file system.

Agents (agnt-x)

An Agent is a background process that conducts communication channels throughout the system, the Network, and the Protected Server Constellation. An agent carries information to an entity that makes a decision, performs analysis, or sends out an command to launch an attack against a process. To launch an attack against a process, an agent must carry the information to a source for launching an attack such as a process which has the appropriate tools.

Archangels

Archangels launch Angels through the use of the fork utility and monitors for the Angels request for assistance. If Angels find an unauthorized request while sniffing an IP packet, they communicate this information back to the Archangel and the Archangel communicates with an agent to carry this intelligence back to SAC.

Angels

Angels monitor the ports of server perimeters for unauthorized requests for entry. Angels scan IP packets for unauthorized source IP addresses and conduct surveillance on all IP traffic coming into the Protected Server Constellation. Angels perform tasks that support agents and archangels.

v. Military Intelligence Armies (MIAs)

The Military Intelligence Army, (MIAs) perform attacks against intruders by launching a series of successive attacks to defend against Syn Floods, for example, or denial of service attacks. MIAs are groups of processes that receive information from Agents and carry out an attack on traffic processes that are unauthorized, or that have attempted an unauthorized entry.

An MIA consist of a parent process and optional numbers of child processes. Section 3.4.2.1 OF UNIX TEXT provides a description of the fork system call and the creation of child processes from parent processes. The parent process will fork a number of child processes in correspondence to the security protection need. The child processes may also fork grand-child processes. The differentiation in child processes allows for the tailoring of a response to the specific requirements imposed by an attack, by variably employing differing fractions of the parent process code. The size and characteristics of a response are determined by the Expert System through consideration of the particulars of the constellation under protection and the specifics of the attack or intrusion. One example of a parent (captain) and five child processes which comprise an MIA is:

1. Captain

2. Lieutenants

3. Sergeants

4. Corporal

5. Constellation Guards

6. Infantry Server Guards

FIG. 15 depicts examples of parent—child relationships of a MIA 1510. A captain 1512 is the parent of PSC-1→n lieutenant commander processes 1514. The n^{th} lieutenant commander processes 1514 is the parent of PSC-nSv-1→n Corporal Demon processes 1516. The second Corporal Demon processes 1516 is the parent of a Private Root file system Guard 1518 which is in turn the parent of a plurality of individual Private Guards. These Private Guards include a slash-etcetera guard 1520, a slash-sbin guard 1522, a slash-bin guard 1524, a user-local guard 1526 and a file transfer guard 1528.

FIG. 16 illustrates the relationships between personalities of the rule based hierarchy 1610. A commander process 1612 relates to the processes: Demons 1614, 16nights & Spies 1616, and Archangels 1618. Archangels 1618 relate to Agents 1620, Angels 1622, and Servants 1624. Angels 22 have a wo-way relationship with SIFs 1626. The SIFs 1626 relate to MIAs 1628, to a CARL 1630, to a Support Team 1632, to additional Agents 1634, and to additional 16noights & Spies 1636. The MIAs 1628 also can then relate back to Agents 1620. The Support Team 1632 also can then relate back to the Servants 1624.

FIG. 17 illustrates examoples of the possible routes of data flow 1710 between the processes of FIG.s J and K. A data flow 1712 passes to the Expert System Security Intelligence 17ayer 1714 from a commander 1716. A data flow 1718 passes both ways between commander 1716 and 17ieutenant Commander 1720. A data flow 1722 passes both ways between a PSC-nSv2 Corporal Demon 1724 and SIFs 1726. The SIFs 1728 can pass data both ways over a dat flow 1728 with an PSC-nSv2 Agent Demon 1730 which can also have a two-way data flow 1732 with a Private slash-etcetera guard 1734. The PSC-nSv2 Agent Demon 1730 can also pass a data flow 1736 on to the Expert System Security Intelligence 17ayer 1714.

III.C.2 Basic Security Processes

The Basic Security Processes executive program manages the various components which fulfill the basic security functions of the Network Surveillance and Security System. Collectively, the components of the sub-layer III.C.2. comprise the Security Access Center (SAC). Control of the SAC involves controlling and invoking various components that are described in an assortment of sub-layers throughout the Network Surveillance and Security System's architecture. The security components and the information areas which are under the control of the SAC include:

Security Access Center

1. Security Auditing Function (SAFs)

Devices Monitoring and Controls

a. Access Control Rights

b. System Layer Access

c. File System Access

d. Group Layer Access

e. Directory Structure Access

f. File Access

g. User Account Access

2. Security Access Monitor

3. Security Reference Database (SRD)

4. Security Reference Model (SRMd)

5. Security Reference Monitor (SRMn)

6. Security Authorization Database (SAD)

7. Authorization Access Model (AAM)

a. Authorization Profile (AP)

i. Permission Profile

ii. Directories

iii. Permissions

iv. Group Permissions

v. Group Interactions

vi. Member Interactions

vii. User Permissions

viii. Group Access Rights

ix. User Access Rights

x. User Access Permissions

b. Rights and Ownership Profile

i. Files

ii. Command Executions Rights

iii. Command Execution Permissions

iv. Permissions

v. File Permissions

vi. File Interactions

vii. User Interactions

viii. User Permissions

ix. User Access Rights

x. User Access Permissions

8. Authorization Reference Model (ARM)

Functions

Reference Monitor Functions

9. PortMon (PM)

10. Security Reference Model (SRM)

a. Access Profile (AP)

i. Permission Profile

ii. Directories

iii. Permissions

iv. Group Permissions

v. Group interactions

vi. Member Interactions

vii. User Permissions

viii. Group Access Rights

ix. User Access Rights

x. User Access Permissions

b. Access Rights and Ownership Profile

i. Files

ii. Command Executions Rights

iii. Command Execution Permissions

iv. Permissions

v. File Permissions

vi. File Interactions

vii. User Interactions

viii. User Permissions

ix. User Access Rights

x. User Access Permissions

The components of the Basic Security Processes Executive sub-layer include:

A Network Manager (NMgr) which manages the information collected and analyzed from servers within a Protected Server Constellation using a secured channel for communication. The Network Surveillance and Security System NMgr maintains a topological perspective of a given network derived from processes that gather information of the flow of data through a network. The Network Surveillance and Security System NMgr detects arriving foreign packets which pass the central router and traces packets through the local network to a destination server within the Protected Constellation. The NMgr is able to communicate through Agents.

A Network File System Manager (NFSMgr) which manages the flow of information within a server, analyzes packets arriving from servers within the Protected Server Constellation for security breaches, and analyzes packets arriving from outside the Protected Server Constellation network for requests to access data within the Protected Constellation Servers, but lack authorized access permissions. The Network Surveillance and Security System NFSMgr is external to, and uses a secured channel to communicate with, the Network Surveillance and Security System. The NFSMgr also maintains a topological perspective of a given file system within the Protected Server Constellation. This perspective is derived from processes that gather information of the flow of data through the file system. The Network Surveillance and Security System NFSMgr detects packets arriving from outside the Protected Server Constellation and traces them as foreign packets through the local constellation to a destination server within the local constellation. The NFSMgr is able to communicate through Agents.

A Security Reference Monitor is a hidden controller that makes references against the Security Reference Database whenever the Security Reference Monitor detects that the Security Authorization Database receives a request for access.

A Port Monitor is a controller for deployment of port monitoring routines to monitor all of the Transmission Control Protocol (TCP) and the Internet Protocol ([P) port services. PortMon is a routine that monitors who is granted access and forms a report based on the changes in its reference model. The reference model is updated both periodically and whenever the Security Reference Monitor detects that the Security Authorization Database receives a request for access.

A System Logger (SYSLgr) facility is responsible for logging all system warnings and fault alarms into a file and supporting system administration across a network. SYSLgr logs critical system errors from the servers as well as fault alarms and warnings. SYSLgr accumulates information for analysis to determine if further actions are needed, or whether an administrator's attention is needed to correct parameters outside of acceptable tolerances.

The Basic Security Processes sub-layer utilizes UNIX utilities to conduct audits of the communications traffic entering, exiting, and passing within the protected constellation.

Among the UNIX utilities used for auditing network traffic are:

snmpsniff A promiscuous (stands on a LAN and shows all traffic) SNMP PDU sniffer.

tcpdump A tool for network monitoring and data acquisition (packet sniffer) trace route. This utility shows network path information of the traffic.

Netstat A tool for monitoring the status of the packets on the network.

ucdsnmp A system agent and a set of SNMP tools.

III.C.2.a Communication Utilities

III.C.2.b Process Control Management

i. Interprocess Communication (IPC)

ii. Domain Control Program

III.C.2.c Security Access Controller Executive

The Security Access Controller Executive sub-layer supervises the processes that are fundamental to the implementation of the security auditing and controlling access to the protected constellation. This sub-layer has three parts: i) Constellation auditing processes; ii) File System Watchdogs; iii) Directory Watch Dogs.

i. Constellation auditing processes include:

Constellation Access Record Logger (CARL)

The CARL is a daemon process that is notified by Agents of any attempt to breach security of the Constellation. The CARL records all information communicated by the Agents regarding security breaches, attempted security breaches or unauthorized attempts to access the Constellation. Records are stored in an internal database for subsequent access or analysis. The CARL retains information that enables Angels to influence judgments of potentially unsafe IP access attempts. Archangels access information from the CARL through Agents that communicate directly with the CARL and directly with agents of the Archangels.

Constellation Address Mapper (CAM)

The CAM is a daemon process that controls the processes used by the Network Surveillance and Security System to respond to security threats. An Attack Response is comprised of the actions taken to restore the security of the Protected Constellation. Attack Responses have a range of differing depths, which are employed in correspondence to the severity of a particular security threat. The CAM also controls where the Attack Responses are needed and reports information relating to the Attack Responses to the Expert System Intelligence Layer.

The appropriate depth of an Attack Response in response to a given security threat is learned through experience. An Attack Response would generally be comprised of a variety of processes in groupings termed Troops. In one embodiment of the present invention, a Troop would include 2 MIAs, 1 SIF, 2KnS, 2 Demons, and four Archangels. In this embodiment, there would be four depths of Attack Responses:

Attack Response depth 1:

1 Troop per server in the Protected Constellation; Process Kill level-5

Attack Response depth 2:

2 Troops per server in the Protected Constellation; Process Kill level-5

Attack Response depth 3:

4 Troops per server in the Protected Constellation; Process Kill level-7

Attack Response depth 4:

8 Troops per server in the Protected Constellation; Process Kill level-9

This embodiment is illustrative of a set of responses employed by the CAM of one embodiment of the present invention, but is not intended to be limiting. In principle, numerous variations in the set of responses are within the scope of the present invention. The number and types of processes which constitute a Troop may vary, Troops of differing compositions may be used in the same Attack Response, and the number of Troops per server can also vary. The number of Attack Response depths is also not limited in number, with the selection depending on the details of an individual security threat. Additionally, the process kill levels can vary for any troop across the entire range of possibilities, from −1 to −9.

Determining the appropriate depth of the attack response involves observing events that present potential security threats and implementing various forms of appropriate responses. Further possible responses will then follow depending on the subsequent events which are observed. An example of a group of responses to events is a particular protection strategy. Initially, the protection strategy would be input as a portion of the Network Surveillance and Security System's knowledge base at set up. These strategies may also be subsequently altered by the receipt of additions to the knowledge base from the system administrator, over the encrypted communication channel from other Network Surveillance and Security Systems, by downloads from a data repository, or by self-administered alterations under direction of the Expert System Security Intelligence Layer.

An example of one strategy for the direction of responses to potentially threatening events follows:

Among the observations made by the Network Surveillance and Security System of network operations which can be indicative of the Protected Server Constellation's security status are:

| Class | Features | VALUES | |
|---|---|---|---|
| A | Unauthorized IP address | True | False |
| B | Failed Login Attempts greater than 3 | True | False |
| C | Repeated Login Failures | True | False |
| D | Internal Network security violations | True | False |
| E | Repeated Internal Network violations | True | False |
| F | Directory Access Rights | True | False |
| G | Repeated Violations of Directory Access Rights | True | False |
| H | File Access Rights Violation | True | False |
| I | Repeated Violations of File Access Rights | True | False |
| J | Denied Access Rights | True | False |
| K | Repeated Denials of Access Rights | True | False |
| L | Address Verification Failure | True | False |
| M | Group Permissions Violation | True | False |
| N | Multiple Group Permissions Violations | True | False |
| O | User Permissions Violation | True | False |
| P | Multiple User Permissions Violation | True | False |

These features would be evaluated and responded to according to various security schemes. One example is:

TABLE A

| Concept | Description |
|---|---|
| Threat Level 1 | (A or J) and F |

TABLE B

| | | | | |
|---|---|---|---|---|
| Concept | Value | Intruder | Attack | No. of Attackers |

| | |
|---|---|
| Threat Level 1 | True |

TABLE C

| | | | | |
|---|---|---|---|---|
| Violator | Mistakes | Dishonesty | New User | Malicious |

| | | |
|---|---|---|
| True | False | True |

In this scheme, a threshhold is set and a threshhold interpreter algorithm operates using data inputs from processes running at the CIIL. Such a threshold is shown in Table A where, if at least two of the features as shown are true, then the threshold for determing a Threat Level 1 has been fulfilled. Table B represents knowledge about the events which have triggered the Threat Level 1. Table C represents intelligent evaluations made by the ESSIL regarding the nature of the user(s) that have triggered the Threat Level 1. Tables A, B, and C are only symbolic though, and do not represent an actual serial division or compartmentalization of threat detection and analysis procedures. Rather, the Tables are only indicative of a partial cross-section of multidudes of the matrices which are involved in security evaluations.

Port Monitor and Controller

FIG. 18 is a symbolic representation of the arrangement of components of the present invention, as they are encountered by data packets. Communictions enter the Network Surveillance and Security System 1810 through Encryption Machine 1812 components. The other parts of various network designs would be external to these components. External to the Encryption Machine 1812 are the Portmon components 1814.

System Loger (SYSLgr)

The Syslog facility is a daemon process that is responsible for logging system warnings and fault alarms into a file and supporting system administration across a network. SYSLgr logs critical system errors from the servers as well as fault alarms and warnings. SYSLgr accumulates a large record of information for analysis to determine whether further actions or human intervention is needed to correct parameters outside of tolerances.

ii. File System Watchdogs

Watchdog systems are daemon processes which implement policies that control access to file systems. A file system implementation defines its policies on several levels such as naming, access control and storage. These are applied uniformly to all files. It may be desirable to override the default policies for some files, such as in the following examples:

1. To implement different access control mechanisms.

2. To monitor and log all access to particular file.

3. To take certain automatic actions upon receipt of mail.

4. To store the file in a compressed or encrypted form and automatically decompress or decrypt the file when it is read.

The watchdog system does not have a special privilege, and is transparent to applications accessing the files. The watchdog system causes an additional processing expense only when it overrides an operation. A watchdog system can makes a file a guarded file. When a user process tries to open a guarded file, a message is sent to the watchdog daemon process to start up the watchdog process. The watchdog may use its own policies to permit or deny access, or it may pass the decision to other components of the Network Surveillance and Security System. If the file is allowed to be opened, the watchdog transmits information relating to the set of operations made on the file to the Expert System Security Intelligence Layer. The set of guarded operations may vary between different open instances of the file, different users of the file, and different files within the guarded file system.

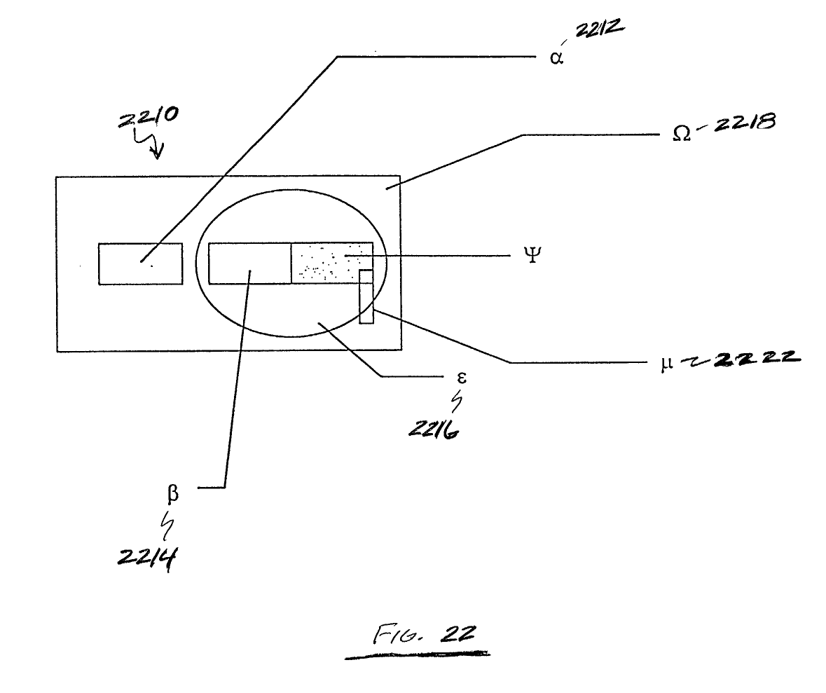

FIG. 19 illustrates common state transitions 1910 when the Network Surveillance and Security System receives a request for access from a user. The Network Surveillance and Security System starts with an INIT process 1912 which forks a Commander process 1914 and an Access Authentication demon 1916. The Access Authentication demon 1916 queries the database file in component III.C.1.B.iv to authenticate the UserID of the user requesting acess. The Commander Process 1914 test for any condition that would induce a transition to another state, but otherwise continues to recycle in the Commander state 1918. Upon the acces of a protected resource, a transition to a Watchdog state 1920 occurs. The Watchdog state 1920 continues to run the watchdog program 1922 as long as the resource is being accessed. When access to a file is requested, the state F_{A}—File Access 1924 is begun and continues to run 1926 as long as files are being accessed, after which the state is again Watchdog 1920. The state is transferred between the file Access 1924 and an Search of Database of access rights agent 1926 to determine the user's allowable access for requested files. The Search of Database of access rights agent 1926 also recycles 1928 while files are being accessed. The state switches back and forth to a Database Manager 1930 during file accessing so that the Database Manager 1930 can make a record of the file and database actions. When the Database Manager 1930 record raises security issues the state will switch to operation of the Security Access Center 1932.

The Watchdog state 1920 transitions to the state F_{A}—File Access 1924 if the user requesting access is the owher of the file. If the user is not the owner of the file, Watchdog state 1920 transitions to a File Access F state 1934 to monitor for possible damage to the file. The File Access F state 1934 also transitions back and forth with a Datagbase agent 1926, the Databse Manager 1930 and the Security Access Center 1932 as described above. The File Access F state 1934 additionally may transition toa Monitor state 1936 when file damage is detected. The Monitor state may transition to an Agent 1938 to execute a kill on the user process or to an Agent 1940 to execue a repair on the damaged file. The Monitor state 1936 may transition 1942 back to the Commander state 1914 after execuing a repair or kill.

There exist three types of systems within a file guard:

A guarded file system.

A unguarded file system.

A locked (encrypted) file system.

Each file system has a different set of security policies and acceptable operations. The guarded file system stores files in two formats, the guarded format- while the file operations are recorded and monitored when accessed but are not decompressed or locked. The unguarded file system stores files in their original formats. In the unguarded file system, the file operations are monitored, but not recorded, when the file is accessed. The locked file system stores files in an encrypted format wherein all file operations are both monitored and recorded. The locked file system monitors and records when access is attempted. The locked file system contains an access log, an access list of authorized permissions and viewing rights, as well as a list of userids permitted to access files.

Whenever a user attempts a guarded operation, such as open any guarded or locked file, the kernel relays the attempted operation to the watchdog system which then relays a signal message to invoke a security surveillance function. In response to the user attempted operation, the watchdog does one of:

Performs the operation. This may involve passing additional data between the operating system kernel and the watchdog system such as information for read or write operations. To avoid loops, the watchdog is allowed direct access to the file it is guarding.

Denies the operation. This involves passing back an error code, recording the attempted operation and error code, and passing this information to the Expert System Security Intelligence Layer to be added to the knowledge base.

Acknowledge the operation. This involves asking the kernel to perform the operation in the usual manner. The watchdog may also perform some additional processing on the file such as;

accounting,

auditing security background information relating to the userid of the user attempting the operation,

auditing security background information relating to the machine the user is using, and

accessing rights and permissions allowed all users in the file access list database.

iii. Directory Watch Dogs

Watchdogs that are associated with directories guard all operations made within the directory such as controlling access to files within the directory (access control is performed on each directory in a pathname). A directory watchdog has specific capabilities. It guards, by default, any file within a particular directory that does not have a watchdog directly associated with it. Within a Protected Constellation Server, access to any directory is controlled by a watchdog. The directory watchdogs monitor and record all operations made in a guarded directory regardless of whether all files or any files within the directory are made guarded, open, or locked.

There are two kinds of guard functions performed by directory watchdogs. Directory access rights may be organized according to the groups a user belongs to. One type of function guards access permissions for various user groups. The other type of function guards for the necessary permissions to access directories. There are three levels of association for differing classes of users. The owners of a directory or file have the greatest degree of access, and hence the broadest degree of permissions for the files or directories they own. Group members are given intermediate degrees of access in correspondence to the degree of permission available to the group. All others are given more restricted degrees of access. The access permissions are further sub-divided in correspondence to the desired operation:

Group Permission Guards

owners

Read

Write

Executive

members

Read

Write

Executive

others (the world)

Read

Write

Executive

Directory Access Guards

owners

Read

Write

Executive

members

Read

Write

Executive

others (the world)

Read

Write

Executive

A Master Watchdog is a specialized directory watchdog. A Master Watchdog process manages and communicates with all watchdog processes. It controls the watchdogs' creation (when the guarded file or directory is created or opened) and terminates the watchdogs (usually upon the last close of a guarded or locked file or directory). The Master Watchdog may choose to keep some watchdogs active even when no one has any associated files or directories open, to avoid the cost of starting up new processes every time a file or directory is opened.

Watchdogs operate according to the algorithm:

1. Start the watchdog;

2. Is the watchdog a file or directory watchdog?

3.A. If for a directory

a. Watch all directory files by monitoring and recording all operations made within the directory when opened by a process;

b. Report all unusual or unauthorized attempts to open and view directory files;

c. Permit (or deny) operations attempted within the directory in response to requests made by authorized (or unauthorized) users attempting access.

3.B. If for a file

a. Watch all operations attempted on the file by monitoring and recording all operations made within the file when opened by a process.

b. Report all unusual or unauthorized attempts to open a locked or guarded file.

c. Obtain the process id, the userid, and the group id of the process and user requesting operations.

4. Monitor file or directory permissions table;

5. Monitor file or directory rights table;

6. Monitor operations requested;

7. Are operations authorized?

8. If no, deny operations and make report;

9. Otherwise, allow operations and continue monitoring;

10. Repeat above steps until file or directory is closed;

11. End when file or directory is closed and pass information of normal termination to Master Watchdog.

Message Channels

Communication between watchdogs and the kernel is handled by message passing Each watchdog is associated with a unique Watchdog Message Channel (WMC), created by a createwme system call. This call returns a file descriptor, which the watchdog can use to receive and send messages to the kernel.

Each message contains a type field, a session identifier and the message contents. Each open instance of the file constitutes a unique session with the watchdog. The open file table entry for a guarded file points to an entry in a global session table. This in turn points to the kernel's end of the WMC, which contains a queue of unread messages. The WMC also points to the watchdog process.

III.C.3. Command Processes A variety of well known UNIX commands are employed by the component III.C.3 Command Processes of the CIIL. The commands employed by component III.C.3 obtain information relating to any user of the protected constellation. The information about the users is retrieved from the results of the constellation traffic audits of component III.C.2. Among the commands used are:

TABLE 3

| Symbolic Name | Value | Default | Event Signaled |
|---|---|---|---|
| SIGABRT | 6 | Core & Exit | Abort |
| SIGALRM | 14 | Exit | Alarm Clock |
| SIGBUS | 10 | Core & Exit | Bus Error |
| SIGCHLD | 18 | Ignore | Child Status Changed |
| SIGCONT | 25 | Ignore | Continued |
| SIGEMT | 7 | Core & Exit | Emulation Trap |
| SIGFPE | 8 | Core & Exit | Arithmetic Exception |
| SIGHUP | 1 | Exit | Hangup |
| SIGILL | 4 | Core & Exit | Illegal Instruction |
| SIGINT | 2 | Exit | Interrupt |
| SIGKILL(*) | 9 | Exit | Killed |
| SIGLWP | 33 | Ignore | Special signal used by thread |
| | | | library |
| SIGPIPE | 13 | Exit | Broken Pipe |
| SIGPOLL | 22 | Exit | Pollable Event |
| SIGPROF | 29 | Exit | Profiling Timer Expired |
| SIGPWR | 19 | Ignore | Power Fail/Restart |
| SIGQUIT | 3 | Core & Exit | Quit |
| SIGSEGV | 11 | Core & Exit | Segmentation Fault |
| SIGSTOP(*) | 23 | Stop | Stopped (signal) |
| SIGSYS | 12 | Core & Exit | Bad System Call |
| SIGTERM | 15 | Exit | Terminated |
| SIGTRAP | 5 | Core & Exit | Trace/Breakingpoint Trap |
| SIGTSTP | 24 | Stop | Stopped (user) |
| SIGTTIN | 26 | Stop | Stopped (tty input) |
| SIGTTOU | 27 | Stop | Stopped (tty output) |
| SIGURG | 21 | Ignore | Urgent Socket Condition |
| SIGUSR1 | 16 | Exit | User Signal 1 |
| SIGUSR2 | 17 | Exit | User Signal 2 |
| SIGVTALRM | 28 | Exit | Virtual Timer Expired |
| SIGWAITING | 32 | Ignore | Process's LWPs are blocked |
| SIGWINCH | 20 | Ignore | Window Size Change |
| SIGXCPU | 30 | Core & Exit | CPU time limit exceeded |
| SIGXFSZ | 31 | Core & Exit | File size limit exceeded |

III.C.3.a Unix Control Utilities Versions

III.C.3.b Hardware Interfaces Control Program

III.C.3.c Portmon Executive Program

IV. PLATFORM SYSTEM LAYER (PSL)
Executive Program

| IV.A BSD 4.4 Operating System | IV.B AT&T SVR4 Operating System |
|---|---|
| Interface Commands | Interface Commands |

IV.C. UNIX PRODUCTS

| | IV.C.2 BSD | |
|---|---|---|
| IV.C.1 BSD UNIX | and AT&T UNIX | IV.C.3 AT&T UNIX |
| IV.C.1.a | IV.C.2.a | IV.C.3.a |
| FREEBSD | SOLARIS | AT&T SYSTEM V R 3 |
| IV.C.1.b | IV.C.2.b | IV.C.3.b |
| BSDI | HP-ULTRIX, | AT&T SYSTEM V R 4 |
| | IBM-AIX | |
| IV.C.1.c | IV.C.2.c | IV.C.3.c |
| LINUX, SUN OS 4.X | IRIX 5.X, IRIX 6.X | DEC-UNIX |
| IV.C.1.d | IV.C.2.d | IV.C.3.d |
| SUN OS 3.X | DIGITAL UNIX | VM/MVS-UNIX |

IV. Platform System Layer

When the Network Surveillance and Security System is deployed, the CIIL processes communicate with the operating system through the Platform System Layer (PSL) using UNIX utilities known as System Calls. These System Calls are commands that either launch UNIX processes, or direct system resources, or use system resources to communicate with the hardware using commands that are applicable to the particular operating systems described in the PSL architecture outline. The UNIX processes that are launched at the PSL are pure UNIX processes that perform functions that are primarily operating system functions such as file management, file storage, information processing through system ports using Interprocess Communications (IPC's) such as sockets, STREAMS, pipes, named pipes, semiphores, remote file system utilities, and Remote Procedure Calls (RPC).

The PSL deploys UNIX processes, signals to and from processes using signals, and system calls in a novel manner so that they serve the Expert System Security Intelligence Layer. The PSL also uses UNIX Interprocess Communication facilities (such as pipes, named pipes, STREAMS, and sockets) to establish and exchange information between the different layers of the Network Surveillance and Security System. UNIX processes are not normally used in this manner because they were not designated to do so. The Network Surveillance and Security System uses signals to establish communication between processes, establish control over processes and to receive from processes information that allows the Network Surveillance and Security System to monitor activities in order to make decisions regarding security.

The Network Surveillance and Security System does not change the rules and specifications of either of the two UNIX architectures, SVR 4 or BSD 4.3. Rather, the Network Surveillance and Security System shapes the manner in which the design of the UNIX Architecture is being applied to system processes and programs by modifying key components (such as the way service daemons are structured) that directly relate to Network Surveillance and Security System processes and programs.

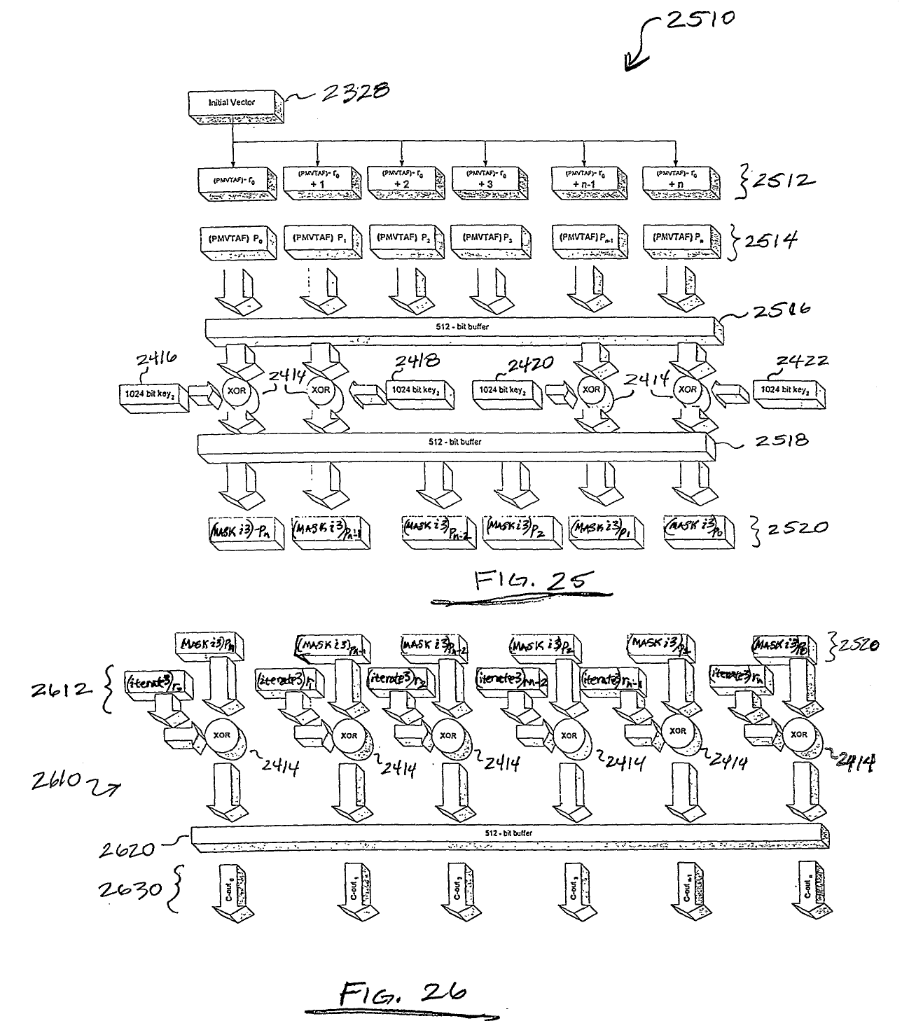

For example, all Network Surveillance and Security System programs are run as daemons. These daemons are specially designed processes that run on the OS in the background. FIG. 22 is a template for a typical Network Surveillance and Security System daemon.

Another UNIX system utility that is re-designed and modified to run the Network Surveillance and Security System is the process scheduler. The Network Surveillance and Security System process scheduler replaces the UNIX process scheduler on the Network Surveillance and Security System computer hardware so that Network Surveillance and Security System high priority processes are scheduled to run in real time and are not pre-empted under most conditions.

The Network Surveillance and Security System also uses the OSI-Data Link Facility which is a part of the TCP/IP interface in the OS to listen to all network traffic on a selected portion of the network. Traffic is recorded for purposes of determining whether a particular user request has the appropriate authorization to make such a request.

### EXAMPLE

If a user with an established account for a particular server in the protected server constellation seeks access to that server, the Network Surveillance and Security System uses the Data Link Facility to listen in on the communications between the user and the server.

The method for listening is as follows:

Step A.

An Ethernet frame is subdivided into the following sniplets so that no information is lost:

E- (or M-) Sniplets which contain the Ethernet header information such as the source and destination addresses (or the MAC source address)

IP Sniplet—The Data portion of the frame which contains information for the next step is assigned to a data variable labeled IP.

The Ethernet frame is defined according to the IEEE 802.3 specification:

| | | |
|---|---|---|
| Ethernet | Data | Tail |
| Header | | |

The Ethernet header is the header of the Ethernet frame that provides the Network Surveillance and Security System with the address of the source of the request and the address of the destination of the request. This information is taken from a packet of data being transmitted and is transmitted through the Data Link facility and allows the Expert System Security Intelligence Layer to determine if such a request by the user should be granted by the destination host server.

Step B.

The Ethernet frame, having been broken into two portions called E-sniplet and IP sniplet, is further divided into I-sniplets for IP information. The header of the Ethernet frame remains in the E-sniplet buffer and the IP Sniplet variable containing the Ethernet data portion is further subdivided into the following:

I-Sniplet which contains the IP header information from the IP packet

TCP-Sniplet which contains the IP data portion of the IP Packet

| | |
|---|---|
| IP Header | Data |

The header of the I-Sniplet contains the source IP address of the user's machine performing the request and designation IP address of the server the request is being made against. The header information is placed onto the I-sniplet and the data portion is further subdivided to obtain TCP type information in order to determine how and where the data is being transmitted. This method for obtaining IP information and I-sniplet is similar to the method for handling Ethernet information from Ethernet frames.

Step C.

After the IP frame has already been subdivided into two sections—header and data, respectively—the data section is further subdivided into two portions called TCP header and data. The TCP-Sniplet is subdivided into the following:

T-Sniplet which contains the TCP header information of the TCP packet

Session-Sniplet which contains the data portion of the TCP packet information.

| | |
|---|---|
| TCP Header | Data |

The header of the TCP packet contains information such as the “source port” of the user's machine and the destination port of the server where the request is being made. The Network Surveillance and Security System uses this information to determine what type of request is being made against the PSC servers and whether or not the Network Surveillance and Security System will require further investigations before sending a kill signal to the UNIX daemon that is servicing the port on the server where the request is being made. The Network Surveillance and Security System uses TCP-port information to make early assessments about authorized users and their request.

Step D.

| | |
|---|---|
| Session Header | Data |

The Session-Sniplet is further subdivided into the following two portions:

SSAP—Sniplet contains the Session Service Access Points

SPDU—Sniplet containing the Session Protocol Data Points

The SPDU may be further subdivided in the same manner to obtain information for Presentation and Application layers of the OSI model and stored into P-Sniplets and A-Sniplets respectively.

When a data abstract such as a socket is created, the engine must specify a communication domain from the two available types of communication domains, UNIX and internet. The term “domain” is utilized in reference to the communication type for a socket interface.

In the UNIX domain, the Network Surveillance and Security System creates sockets that have actual computer file path names. These sockets are then used with processes that reside on the same computer which hosts the engine. This domain is referred to as the local domain for the Network Surveillance and Security Sys tem. Sockets created in the internet domain allow unrelated processes on different hosts to communicate.

The two types of UNIX have evolved over time to combine libraries that provide compatibility for each UNIX type. Hardware platform manufacturers (OEM's) and other vendors support both versions. The Network Surveillance and Security System is compatible with both versions. Though the differences between the two versions of UNIX are reflected in their utilities distinctions, the Network Surveillance and Security System performs operations equally as well with either version.

ATT SVR3 Model

In the AT&T System V Release 3 (SVR3), (as well as earlier AT&T releases), the process group exhibits the characteristics of a terminal login session. The following are the important features of the ATT SVR3 Model:

Process Groups

Each process inherits its parent's process group ID during a fork. The only way to change the process group is by calling setpgrp, which changes the caller's group to equal its process identification number (PID). As a result, the caller becomes the leader of the new group, and any child process it subsequently forked from it will join this group.

Controlling terminal

The controlling group owns its terminal. Thus, when a process forms a new group, it loses its controlling terminal. After forming a new group, the first terminal the new group opens (that is not already a controlling terminal) becomes its controlling terminal. The t_pgrp for that terminal is set to the p_grp of this process, and all child processes inherit the controlling terminal from the group leader. No two process groups have the same controlling terminal.

A typical initiation scenario proceeds as:

The init process forks a child for each terminal listed in the file “/etc/inittab” (called initial table in English) The child process calls setpgrp, becoming a group leader, and then executes the getty program, which displays a login prompt and waits for input. When the Network Surveillance and Security System, as the user, inputs a login name, getty executes the login program (shell, a command input program running on the hosts in the Protected Server Constellation), which asks for and verifies a password, and then executes the login shell. Hence, the login shell is a direct child of init and is a process group leader as well. Usually, other processes do not create their own groups (except for system daemon processes that run under the highest priority in the background without a terminal started from a login session). As a result, all processes belonging to a login session will be in the same process group.

Continuing now the discussion of the Network Surveillance and Security System's use of the important features of the ATT SVR3 Model:

Terminal Access

There is no support for job control. All processes that have a terminal open can access it equally, whether they are in the background or foreground. Output from such processes will be randomly intermingled on the screen, in the event that the operation has a screen attached to it. Should several processes try to read the terminal concurrently, it is purely a matter of chance which process will read any particular line of input. In such instances, the Network Surveillance and Security System does not allow a terminal screen to have terminal access unless monitoring of activities under testing is taking place. As a result, this feature does not directly apply.

Terminal Signals

Signals such as SIGQUIT and SIGINIT, generated at the keyboard, are sent to all processes in the terminal's controlling group, and thus, usually, to all processes in the login session. Only foreground processes are the intended recipients of these signals. Should the Network Surveillance and Security System be running a foreground process for testing purposes only, then this terminal signal feature applies so that the Network Surveillance and Security System can efficiently monitor all activities taking place by the foreground processes. Hence, when the shell creates a process that will run in the background, they are set up to ignore the terminal signals. It also uses a redirection facility to redirect the standard input of such processes to /dev/null, so that they may not read from the terminal through that descriptor (although they may still open other descriptors to read from the terminal).

Detaching the Terminal

A terminal is detached from its controlling group when we set its t_pgrp field to zero. This occurs when no more processes have the terminal open or when the group leader (usually the login process) exits.

Death of a Group Leader

The group leader is the controlling process of its terminal and is responsible for managing the terminal for the entire group. Upon the death of a group leader, a disassociation occurs between the group leader's controlling terminal and the group (its t_gprp is set to zero). A SIGHUP signal is sent to all other processes in the group which sets their p_pgrp to zero, hence they no longer belong to a process group, and are thus orphaned.

Implementation

The p_pgrp field of the process structure contains the process group ID. The u area has two terminal-related fields −u_typ (a pointer to tty structure of controlling terminal) and u_tyd (device number of controlling terminal). Moreover, the t_pgrp field in the tty structure contains the controlling process group of the terminal.

Signal Generation

The UNIX kernel generates signals to processes in response to various events. These events may be caused by the receiving process, by another process, interrupts, or external actions. The major sources of signals are:

Exceptions—When an exception occurs in a process, the kernel notifies the process by sending it a signal;

Other Processes—A process may send a signal to another process, or set of processes, through the kill or sigsend System Calls. A process may even send a signal to itself;

Job Control—The Network Surveillance and Security System sends job control signals to background processes that try to read or write to the terminal. job control shells such as csh and ksh use signals to manipulate foreground and background processes. When the Network Surveillance and Security System terminates or suspends a process, the kernel notifies the parent of the process via a signal;

Quotas—When a process exceeds its CPU or file size limits, the kernel sends a signal to the process;

Notifications—A process may request notification of certain events, such as a device being ready for I/O. At that time, the kernel informs the process via a signal;

Alarms—A process may set an alarm for a certain time; when it expires, the kernel notifies the process through a signal.

Representative SVR3 Scenarios

The Network Surveillance and Security System is structured as a hierarchy of UNIX processes. UNIX signals are used to perform operations within the Network Surveillance and Security System domain. These operations include:

Communication between processes.

Communication between processes on different platforms (computers).

Communication between hierarchical structures on other platforms as well as within the same platform.

Communication with the kernel and with other time-laden processes within the same platform and between platforms.

One common scenario utilizes the Network Surveillance and Security System ability to protect other platforms by deploying processes termed Virtual Robotic Agents. Virtual robots can be used to monitor UNIX computer servers within the Protected Server Constellation. The activities on protected servers are monitored and reported to the Network Surveillance and Security System on a periodic basis. The Network Surveillance and Security System also constructs and deploys armies of protective virtual robots to extinguish threats to system security. These threats take many forms and may involve, for example, an attack on the security of a file system, of a directory structure, or of a user account. The Network Surveillance and Security System communicates with the Virtual Robots Agents (VRA's) with UNIX signals listed previously. The Network Surveillance and Security System layers II. and III. execute process management and monitoring for the UNIX facilities utilized to monitor the protected servers.

Berkeley Software Distribution (BSD) Signal Management

4.3 BSD UNIX provided the first reliable signals and offered more powerful facilities than AT&T System V Release 3 (SVR3) UNIX. Additionally, most 4.3 BSD system calls take a mask argument (a 32-bit mask of the signals on which the calling process operated—inter alia, one bit per signal). Hence, a single call can operate on multiple signals. The SIGSETMASK call specifies the set of signals to be blocked; the SIGBLOCK call added one or more signals to the set, and the implementation of SIGPAUSE automatically installs a new mask of blocked signals and puts the process to sleep until a signal arrives.

4.3 BSD UNIX also introduced several additional signals, including some devoted to job control. A job is a group of related processes, usually forming a single large program. Programs such as the Network Surveillance and Security System may concurrently run several jobs in a terminal session, but only one can be the foreground job. The foreground job may read and write to the terminal, while the Network Surveillance and Security System sends signals to background jobs.

Additionally, 4.3 BSD UNIX allows automatic restarting of slow system calls when signals have aborted those calls. Slow system calls include reads and writes to character devices, network connections and pipes; wait; waitpid; and ioctl. When a signal interrupts such a call, the call is automatically restarted after the handler returns instead of being aborted with an EINTR error. 4.3 BSD UNIX also has the siginterrupt system call, which allows selective enabling and disabling of the automatic restart of the interrupted system call on a signal-by-signal basis.

While the 4.3 BSD UNIX signal interface is powerful and flexible, its main drawback is the lack of compatibility with the original AT&T interface (and with the later released SVR3 interface). These incompatibilities drove third-party vendors to develop various library interfaces that provide compatibility for both versions of UNIX. Subsequently, AT&T SVR4 introduced a POSIX-compliant interface that is backward compatible with previous releases of System V as well as BSD semantics. The POSIX Standard is the interface standard specified in the IEEE 1003.1 POSIX Standard, which is available from the Publications Department of the Computer Society of the IEEE. The Network Surveillance and Security System is designed to function with both BSD and AT&T UNIX, by compliance with the POSIX standard. The Network Surveillance and Security System is projected to be compatible with differing versions of UNIX releases from a wide variety of vendors, and its initial design is resident to a version of System V Release 4 called IRIX™ by Silicon Graphics, Inc. of Mountain View, Calif.

AT&T System V Release 4 (SVR4)

UNIX Signal Utilities

SVR4 offers a set of system calls that provides a superset of the functionality of the newer SVR3 and BSD UNIX signals, as well as support for the older, less reliable signals. These system calls include:

sigprocmask (how, setp, osetp)

The use of the setp argument modifies the mask of blocked signals. If the how argument is SIG_BLOCK, then setp is “or'ed” to the existing mask. If the how argument is SIG_SETMASK, then the current mask is replaced by setp. Upon return, osetp contains the value of the mask prior to the modification. The Network Surveillance and Security System may use this argument during testing of a modification.

signaltstack (stack, old_stack)

This signal specifies a new stack to handle the signals. Handlers must specifically request the alternate stack upon installation. Other handlers use the default stack. On return, old_stack points to the previous alternate stack.

sigsuspend (sigmask)

This signal sets the blocked signals mask to sigmask and puts the process to sleep, until a signal not ignored or blocked posts to a process. If changing the mask unblocks such a signal, the call returns immediately.

sigpending (setp)

This signal upon return uses setp to contain the set of signals pending to a process. The call does not modify any signal state and the Network Surveillance and Security System simply uses it to obtain information.

sigsendset (procset, sig)

This signal is an enhanced version of the kill command. Its sends the signal sig to the set of processes specified by procset.

sigaction (signo, act, oact)

This signal specifies a handler for signal signo; it resembles the BSD sigvec call. The act argument points to a sigaction data structure that contains the signal disposition (for example SIG_IGN, SIG_DFL, or handler address), the mask to be associated with the signal (similar to the mask for the BSD sigvec call), and one or more of the following flags:

| | |
|---|---|
| SA_NOCLDSTOP | Do not generate SIDCHLD when a child process is |
| | suspended; |
| SA_RESTART | Restart system call automatically if interrupted |
| | by this signal; |
| SA_NOCLDWAIT | Used only with SIGCLD to ask the system |
| | not to create a zombie process when children of |
| | calling processes terminate. If this process |
| | subsequently calls waitm it |
| | will sleep until all its Children terminate; |
| SA_SIGINFO | Provides additional information |
| | to the signal handler. Used for |
| | handling hardware exceptions; |
| SA_NODEFER | Disallows automatic blocking |
| | of a signal while its handler is running; |
| SA_RESETHAND | Resets the action to default |
| | before calling the handler. |

SVR4 also provides compatibility with older releases of UNIX by supporting the following signals:

| | |
|---|---|
| • signal | • sigset |
| • sighold | • sigignore |
| • sigpause | |

Signal Implementation

Signal implementation requires that the kernel of any UNIX variant must maintain some state in both the u (user) area and the process (proc) structure. SVR4 signal implementation resembles that of BSD UNIX, differing primarily in some variable and function names. The u area contains information required to properly invoke the signal handlers, including the following fields:

| | |
|---|---|
| u_signal [] | Vector of signal handlers for each signal |
| u_sigmask [] | Signal masks associates |

Signal Generation

At signal generation, the kernel checks the proc structure of the receiving process. If the proc structure has ignored the signal, the kernel returns without taking any action. If the proc structure has not ignored the signal, it adds the signal to the set of pending signals in p_cursig. Since p_cursig is just a bitmask with one bit per signal, the kernel cannot record multiple instances of the same signal. Hence the process will only know that at least one instance of that signal was pending.

If the process is in an interruptible sleep and the signal is not blocked, the kernel wakes up the process so it can receive the signal. Job control signals such as SIGSTOP or SIGCONT directly suspend or resume the process instead of posting the process.

Signal Delivery and Handling

A process checks for signals by calling issig ( ) as it is about to return from the kernel mode, after a call has been made to the system, or it has encountered an interrupt. A process also calls issig ( ) just before entering, or after waking up from, an interruptible sleep. The issig ( ) function looks for set bits in p_cursig. If any bit is set, issig ( ) checks p_hold to discover if the signal is currently blocked. If not, issig ( ) then stores the signal number in p_sig and returns TRUE.

If a signal is pending, the kernel calls p_sig (to manage the signal; psig ( ) then inspects the information in the u area pertaining to a particular signal. If no handler is declared, psig ( ) takes the default action, usually by adding the current signal, as well as any signal specified in the u_sigmask entry associated with this particular signal. If the Network Surveillance and Security System has specified the SA_NODEFER flag for this handler, it does not add the current signal to this mask. If the Network Surveillance and Security System has specified the SA_RESETHAND flag, the action in the u_signal [ ] array is reset to SIG_DFL.

Lastly, psig ( ) calls sendsig ( ), which arranges for the process to return to the user mode and pass control to the handler. Additionally, sendsig (ensures that when the handler completes, the process will resume the code it was executing prior to receiving the signal. If the alternate stack must be used, sendsig ( ) invokes the handler on that stack. The implementation of sendsig is machine-dependent, since it must know the details of stack and context manipulation.

Additionally, the roster of UNIX Operating System signals in 3 above are also utilized by the Network Surveillance and Security System

Component Functions

In operation, the components of the Network Surveillance and Security System accomplish a variety of functional benefits for monitoring and protecting the security of a Protected Constellation. Among these functional benefits are:

Security Monitoring

The Network Surveillance and Security System deploys Security Intrusion Detection (SID) agent processes to monitor protected constellations; these SID agents communicate reports back to the Network Surveillance and Security System through data files that contain information on the security status of the protected constellations. These agents are deployed in groups and are controlled through commands initiated by the Network Surveillance and Security System.

The security status reports are received through a UNIX facility termed Syslog. The Network Surveillance and Security System configures the Syslog API to report changes in security status within the protected constellation. Other agents will variously communicate with the Network Surveillance and Security System through Remote File Systems (RFS), Remote Procedure Calls (RPC) or from other Network Surveillance and Security Systems with the Privesea Encryption Component.

The Network Surveillance and Security System monitors systems within the Protected Constellation with processes that monitor network access ports. The Network Surveillance and Security System SAC deploys SID agents to perform real-time monitoring and report to the Network Surveillance and Security System in two modes: periodic reporting of activities, and real-time reporting of security events. When the Network Surveillance and Security System receives reports of system access indicating a user in violation of a security policy, the Network Surveillance and Security System can conduct the following procedures to protect the protected constellations when indicated by the knowledge base security policies:

i. perform a scan on network traffic to isolate the user that is in violation; and then

ii. terminate the violator by;

a) first recycling the centralized device that acts as a switch to the Protected Constellation,

b) obtain information about the violator,

c) issue a command to the centralized router to terminate the violator's access rights, and

d) update the filter of the router to deny future access for the violator.

The Network Surveillance and Security System also performs real-time monitoring of the number of failed attempts at accessing a user's account. Only three attempts at any given login are allowed. All attempts are recorded and pattern matching is performed by the multi-layered perception functions of the Neural Network Algorithms of the Network Surveillance and Security System. The Security Authorization Database Accounts Profile is updated to reflect all failed attempts for every account. After a specified number of failed account access attempts, the Network Surveillance and Security System will issue a command to the SAC to lock the account and extinguish the violator.

Data Link Provider Interface

The Data Link Provider Interface is a service interface for drivers implementing the data link layer services. The primary task of a hardware driver is to copy data between the kernel and an I/O device. A software driver is like a hardware driver, but instead of interacting with an I/O device, a software driver provides a service to applications. In these terms, the Network Surveillance and Security System is an application.

Under System V Release 4, many software drivers are available for the Network Surveillance and Security System to use. These include PTS and PTM drivers for pseudoterminal functionality. The Network Surveillance and Security System also uses the LLCLOOP driver to provide a data link layer loopback, and TICLTS, TICOTS, and TICOTSORD drivers for transport layer loopback drivers. The Network Surveillance and Security System uses the LOG driver as an administrative driver for processes to obtain log messages. The SAD driver is also an administrative driver that the Network Surveillance and Security System uses to provide an administrative interface to the STREAMS subsystem. In the UNIX operating system, the drivers are accessed simply as files. They have nodes in the file system that are either of type block special or of type character special. STREAMS drivers are always accessed through character-special files. Descriptions of these well-known drivers can be found in “Advanced Programming in the UNIX Environment”, by W. Richard Stevens, Addison-Wesley, Reading, Mass., 1993.

Requirement Specifications

Once a driver is open, the Network Surveillance and Security System processes can write data to the device by writing to the stream which has opened the device (using its file descriptor). The stream head will copy data from the Network Surveillance and Security System buffer L-buf, into the STREAMS messages and pass them to the driver. The driver will process the messages and transmit data destined for the device to its I/O board. If the device generates input—in the Network Surveillance and Security System case there is mostly input—the driver will copy data from the device into STREAMS messages and send the messages upstream, where they can be obtained by the Network Surveillance and Security System processes reading from the stream.

When the last process closes its file descriptor referring to a stream, the driver's “close (D2DK)” UNIX routine is called and the stream is dismantled. The driver's close routine is thus, only called when the last reference to the stream is given up.

Driver Entry Points

The driver entry points are defined by the DDI/DKI and are called at well-defined points during the execution of the operating system. Seven of these interfaces relevant to STREAMS drivers are in the following table. The first two drivers are the initialization driver and the start driver entry points. They are: Init (D2D) and start (D2DK). The init routine is called at system initialization, before system services are available. Interrupts are disabled during its execution. Drivers use init routine to allocate memory (one of the services available at this point) and to initialize the I/O devices they control. The init routines run without user context, so they cannot call any routines that sleep.

The start entry point is also used for driver initialization, but is called after system services are available, with interrupts enabled. Similar to the init routine, the start routine runs without user context. Both entry points are optional. In a related note, the init routine is in the DDT, but the start routine is in both the DDT and the DKI. Hence, drivers that use the init entry point might have to perform initialization differently on different hardware architectures. If drivers confirm their initialization to the start routine, fewer changes across hardware platform are needed. Accordingly, the Network Surveillance and Security System confines its initialization of such drivers to the start routine. Characteristics that might differ across architectures include I/O bus protocols, data-transfer methods, I/O board identification methods, and interrupt priority layers.

Operation of the Network Surveillance and Security System

The following account of representative actions of the Network Surveillance and Security System provides an orientation for the subsequent detailed descriptions of its components and functions. A common scenario that illustrates a customary group of the Network Surveillance and Security System's operations is:

A request is made by a user to gain access to a network resource from one of the servers in a Protected Server Constellation (to be described subsequently). The request for access is provided using TCP/IP. The request comes in over a port that is well known to the Network Surveillance and Security System and a service daemon called Inetd (to be described subsequently) responds to the request. The Network Surveillance and Security System initially responds to all requests by monitoring traffic on all ports of all servers within the Protected Server Constellation (PSC) and analyzing any attempts against the security of their ports, accounts and resources. The Network Surveillance and Security System responds to a request for access to an account on a server within the PSC by sending the message:

“Request access to an account (rlogin, logh rsh, telnet, or rhost)” to a Security Access Center (SAC). The SAC then forks a process called the Security Reference Monitor to deploy the functions which query a Security Reference Database; this process returns an Authorization Reference Model (ARM) to the SAC. The Authorization Reference Model includes a determination of the user's access authorization.

If the user has authorized access, then an Authorization Access Model (AAM) will include an Authorization Profile (AP) of the user's authorization rights. The AP includes:

File systems access rights;

File system names and the particular directories the user has access rights for;

Group permissions for the directories and groups the user is a member of;

Interactions with other members of the group the user has rights to perform;

User permissions within the group and user access permissions as defined at group formation.

If the user has authorized access, then the AAM will include an Authorization Profile (AP) of the user's authorization rights. A representative AP for an authorized user is organized by:

For Directories

Permissions

Group Permissions

Group Interactions

Member Interactions

User Permissions

Group Access Rights

User Access Rights

User Access Permissions

When an authorized user has been cleared for access as a member of a particular group, the user must be cleared by the SAC to participate as a member with access to files within a file system's directories. The AP includes a File Access and Permission Profile (FAPP). A FAPP for an authorized member of a Group will be organized as:

For Files

Command Executions Rights

Command Execution Permissions

Permissions

File Permissions

File Interactions

User Interactions

User Permissions

User Access Rights

User Access Rights

User Access Permissions

Within the FAPP, will be an evaluation of access rights and permissions to read, write or execute files within directories owned by the group the user is a member of. Files are evaluated for user command execution permissions:

If the file is a command or an executable;

Command file rights with execution rights on a file that is a data object;

Standard permissions for reading or copying a particular file;

Permissions for other interactions with files or groups of files such as merging, deleting, or linking of files;

Permissions for viewing files owned by other members of the same group as the user.

The Security Reference Monitor (SRM) component of the SAC controls changes to the Security Authorization Database (SAD). The SRM controls the changes by either providing or denying access to resources within the network. The Security Auditing Function (SAuditF) of the SAC also performs a major role in determining access rights and authorization. The SAuditF controls a complete record of any request to change authorizations, permissions, or denials, as well as all requests made by an authorized user after gaining access to a portion of the PSC. The SAuditF both controls how authorized users gain access to resources within a system, and controls all changes to users' rules of access to system resources and records those changes. The Security Authorization Function (SAuthF) of the Network Surveillance and Security System controls all new authorizations for a user and updates the SAD. If an authorized user attempts an unauthorized action, the SAuthF can deny the user further access to network resources during an access session. The Network Surveillance and Security System uses rules to govern a user's behavior. These rules are differentially weighted. If a heavily weighted access rule is violated, the Network Surveillance and Security System will deny further access to the now unauthorized user, and the user's session is terminated.

Each of the processes described above occur whenever a user attempts to access a file, modify a file, or execute a command on a server within the PSC. Each of the processes are also engaged whenever a PSC resource is requested, accessed, or execution rights are granted to a user.

The SAC monitors the PSC's critical resources. The monitoring ensures that rights and permissions to PSC Management directories are maintained and secured. The SAC also controls access to:

/bin directories;

/etc directories;

/sbin directories;

/dev directories.

Monitoring of files within the protected directories maintains their respective permissions and rights, thereby preventing intrusions and preserving the integrity of the PSC's files security.

Network Communication Functions

(A) Security Audits

The Network Surveillance and Security System uses a UNIX utility termed get_ethers to scan through a series of Ethernet ports addresses on an Ethernet LAN using the format: (a.b.c.1-a.b.c.254) to ping each address as a test whether a particular network Protected Server Constellation server or destination is still operational. As described in whatis.com:

“Ping (Packet Internet or Inter-Network Groper) is a basic Internet program that lets you verify that a particular IP address exists and can accept requests. The verb ping means the act of using the ping utility or command. Ping is used diagnostically to ensure that a host computer you are trying to reach is actually operating. By using ping, you can learn the number form of the IP address from the symbolic domain name. Ping operates by sending a packet to a designated address and waiting for a response.” (TechTarget.com)

Subsequent to determining whether the destinations are online, the Network Surveillance and Security System then determines the Ethernet address for each destination on the network from its ping response.

The Network Surveillance and Security Systemalso utilizes UNIX utilities to gather information about the state of the Protected Server Constellation, and to provide surveillance of the devices connecting to the Protected Server Constellation.

B) Analysis Re: Knowledge Base

Security Policies

Filtering Policies:

By default, the Network Surveillance and Security System denies access to any request not determined to be specifically authorized. Incorporating knowledge of firewall filtering policies into the Network Surveillance and Security System's secondary intrusion detection filters further improves its effectiveness. The Expert System Security Intelligence Layer can be configured to implement a wide range of specific security polices, ranging from “monitor everything” to “denial of all host or quadrant based services”. Below are some of the available security policies for TCP/IP service denial:

Deny Selectively based on criteria from the knowledge base;

Deny everything with specific limited exceptions;

Deny access for specific TCP Services;

Deny all access to services in a Protected Server Constellations.

The above filtering policies are rote utilizations of the current authorization information in the knowledge base. An Intrusion Analysis Algorithm designed to detect and prevent potential intrusions is a more advanced use of the knowledge base. The Intrusion Analysis Algorithm (IAA) examines intrusion sequence signatures from a database of known patterns using the Transmission Control Protocol (TCP) header information to detect attack signatures. The IAA uses the Neural Network Inference Engine Algorithm to determine whether an unauthorized user is repeating a pattern of attack sequences previously learned by the Guard. The IAA also uses third party UNIX utilities such as network intrusion detection (NID) clonesto collect new strings of NID signatures by matching them against known patterns and sequences.

A detailed listing of an assortment of known attack signatures follow in the Attacks Sequence Database. If the source Internet address is the same as the destination Internet address, then the attack analysis algorithm records the time of the event, the Medium Access Controller (MAC) address, the IP address of the source computer, and the destination addresses. Other data collected for subsequent analysis are the Ethernet frame, datagram headers, and TCP headers of the attacks' sending frames.

When examining incoming traffic seeking to access the network the IAA decomposes the header of a communication into byte patterns called sniplets. There are three types of sniplets:

E-(or M-) Sniplets which contain the Ethernet frame source address (or MAC address).

I-Sniplets which contain IP source information.

T-Sniplets which contain the TCP header information.

Algorithm Outputs and Interfaces

With the information gleaned by the IAA, the Network Surveillance and Security System is able to use the multi-layer perception functions of the Neural Network algorithms to draw intelligent conclusions regarding the network traffic seeking access to a resource in a protected constellation. As an example, the Neural Network MLP algorithm sets off an early warning signal to the Security Access Controller within the Security Access Center that:

(i) an anomaly is occurring that is not recognized;

(ii) an anomaly is occurring as a result of an Intrusion;

(iii) an anomaly is occurring as a result of an Attack.

An Attack Sequences Database (ASD) is comprised of a range of recognized types of intrusions or attacks against network security. The ASD, a component of the knowledge base, initially includes at least the following 33 attack sequence signatures:

TABLE 3
Network Surveillance and Security System Attack Sequences Database

| # | Name |
|---|---|
| 1 | IRC |
| 2 | Root |
| 3 | RootKits |
| 4 | Christmas Tree |
| 5 | Net Camping |
| 6 | TCP Hijacking |
| 7 | Port Attacks xy |
| 8 | Port Attacks |
| 9 | TCP Rst |
| 10 | SYN/ACKs |
| 11 | Net BIOS D's |
| 12 | Coordinated Attacks |
| 13 | Denial of SVCS Attacks |
| 14 | Spoofing Attacks |
| 15 | Trojan Horse |
| 16 | Account Security Breech |
| 17 | Stealth Attack - Null Scan |
| 18 | Large Scale Attacks |
| 19 | Eves Droppings |
| 20 | Null Session/Fingering |
| 21 | Host MapScanning |
| 22 | SYN/FIN |
| 23 | Vanilla TCP |
| 24 | TCP/FIN |
| 25 | ICMP SCAN PingSweep |
| 26 | TCPPing Scan |
| 27 | Remote OS ID |
| 28 | Reverse INDENT Scan |
| 29 | Land Attack |
| 30 | Ping Of Death |
| 31 | Smurf Attack |
| 32 | SYN Flood |
| 33 | BackOrifice |

C) Learning and Updates to Expand Knowledge Base

The ASD also includes a roster of clues which link the Expert Security System to the ongoing communication monitoring, thereby allowing the Network Surveillance and Security System to make inferences about current events in real-time. Additionally, inferences are made based upon preliminary conclusions generated through a series of perturbations using both the Knowledge Base data it has corroborated over time, and attack sequence specific data formed from the definitions of the Attack Sequences.

Network Surveillance and Security System Neural Networks Algorithms

Event learning Algorithm (ELA)

An Event Learning Algorithm sublayer of the Expert System Security Intelligence Layer gains knowledge from observations of network security. Immediately prior to a communication event, the network is in an initial state where the security of the network is presumably known. Immediately after the event, the network is in a new state. The Network Surveillance and Security System determines the security of the network in the new state. What's more, the invention determines the security of the network in the new state, even when the communication event is at least partially unrecognized.

The Network Surveillance and Security System continuously expands its knowledge base by learning from observations of network security states which result from ongoing events. An initial state of the network has a security status which is certain. A data packet is communicated to the network which induces a transition to a new network state. The security of the new state needs to be determined, as well as the certainty of this determination. An uncertain security determination may be of no more benefit than no determination of security.

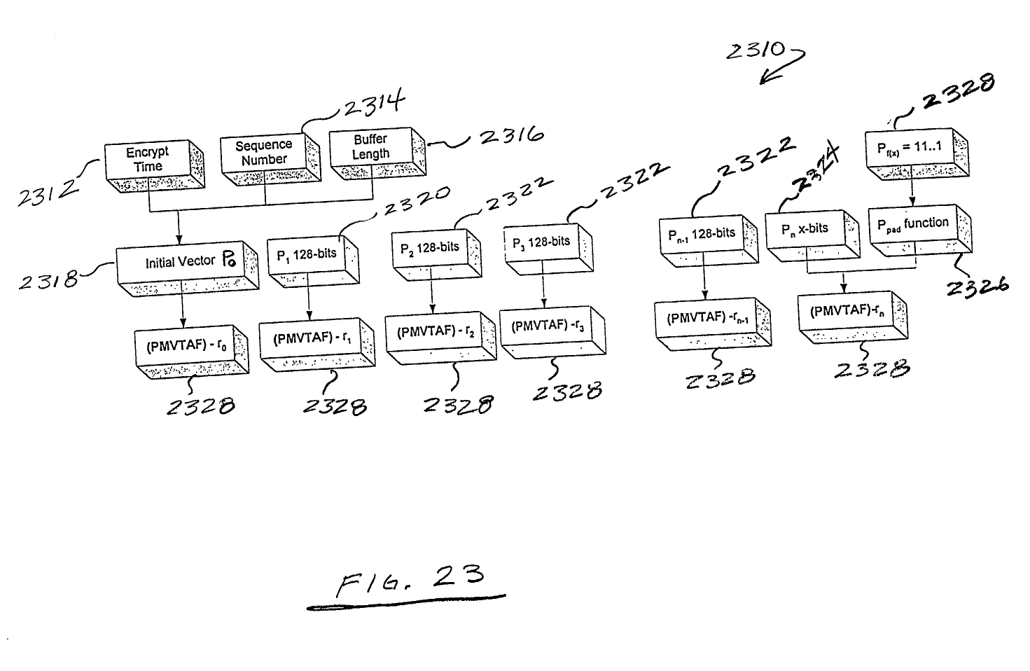

FIG. 20 depicts a schematic representation of a transition fork 2010 in the evolution of the state of security of a Protected Server Constellation. The transition fork 2010 is initiated by the arrival of a data packet 2012 at the Protected Server Constellation, where the Protected Server Constellation is in an intial, known S₁ security state 2014. After the arrival of the packet 2012, the Protected Server Constellation undergoes one of two transitions. The two transitions are either a first E₁ transition 2016, or a second E₂ transition 2018. The E₁ transition 2016 leaves the Protected Server Constellation in a state S₂ of certain security 2020. The E₂ transition 2018 leaves the Protected Server Constellation in a state S₂ of uncertain security 2022.

The ELA uses hidden Markov Models to define states of certain and uncertain security. A hidden Markov Model is defined as a fourtuple <S′, S, W, E > where:

S is a set of states;

S′∈S is the initial state of the model; W is a set of output states; and

E is a set of transitions between states.

A canonical ordering of elements is assumed for each of the sets S, W, and E:

S=[S¹, S², . . . S^{σ}]

W=[W¹, W^{2′}, . . . W^{ω]}

E=[e¹, e², . . . e^{θ]}

And:

Sⁱ∈S is the initial state of security prior to E;

s^{j}∈S is the later state of security following E;

W^{K}∈W is an output result of the ELA

(the output W^{K} being either accepted or generated by ELA in correspondence to ELA being used as an acceptor or generator of event strings.)

p^{l}∈P is the probability of the transition represented by the fourtuple:

<Sⁱ, S^{j}, W^{k}, P>

The ELA Markov Model assumes that only the observed prior state affects the probability of an output state. This is the Markov Assumption, which is expressed explicitly as:

$$P ( {w}_{i , n} ) = {\sum }_{{S}_{i , n + 1}} P ( {w}_{i , n} , {S}_{i , n + 1} ) = {\sum }_{{S}_{i , n + 1}} {\prod }_{i = 1} P ( {S}_{i + 1} \vert {S}_{i} )$$

The ELA computation of the probability of an output is efficient because the set of possible outputs to be learned from is limited. Hence, sentences of probable paths are framed by subcategories keeping the computation as a sum over all possible paths and the number of possible paths from growing exponentially with the length of an output state string

Network Surveillance and Security System Genetic Programming Algorithm

The genetic algorithm uses pseudo-random numbers to mimic the randomness of natural evolution As a result, the genetic algorithm uses stochastic processes and probabilistic decision-making at several stages of program development.

Functions and terminals are the primitives comprising a genetic program. As described in whatis.com:

“In computer programming, a primitive is a basic interface or segment of code that can be used to build more sophisticated program elements or interfaces.” (TechTarget.com)

The genetic programming algorithm assembles variable length program structures from the functions and terminals. Functions and terminals play different roles in the decision making process during the encounter of a new event. Terminals provide a value to the genetic algorithm, while functions process a value already in the genetic algorithm. Functions perform operations on their inputs, which are either terminals or outputs from other functions. The actual assembly of the programs from functions and terminals occurs at the beginning of a call to the genetic algorithm. The result becomes a decision, which transforms into an action, and then into a system layer command of the Network Surveillance and Security System.

The genetic algorithms transform the programs in the population using genetic operators. Crossover between two individual programs is a principal genetic operator in the genetic algorithm. The genetic algorithm drives a population of programs in parallel. A form of fitness-based selection is simulated. Fitness-based selection determines which programs are then selected for further improvements.

Machine Learning Algorithm Primitives

The machine-learning algorithm (MLA) is a subcomponent of the genetic algorithm. The MLA is a process that begins upon identification of the learning domain and ends by testing and using the learning domain results. Among the key constituents of this process are the:

| | |
|---|---|
| A. | learning domain |
| B. | learning system |
| C. | training set |
| D. | testing |

Learning Domain & System

A learning domain can be facts or problems of security, layer of security, state of security, unsecured network, or environment. These facts or problems are termed features, if inputs, and classes, if outputs, of the particular learning domain. The features and classes are organized by the machine-learning algorithm according to the manner that the researcher sub-algorithm predicts such a feature as an outcome of a network action. These features or facts all relate in some manner through a transitional matrix to the desired results.

The MLA refers to features as inputs and classes as outputs. Under the learning domain, features are the sets and classes are subordinates. One example of a class is a particular Internet attack sequence. The specification of this attack sequence is organized into a class and referenced according to its name. Following, the machine learning algorithm references features in the learning domain against known attack sequences. The desired outcome for a machine experiencing a known attack is contained within the knowledge base. The MLA makes predictions about the next state of the machine which is undergoing a given attack, by comparison to the Attack Sequence Knowledge Base. Based on these predictions, the Network Surveillance and Security System will determine the responses to the attack which have higher probabilities of protecting the network. The MLA operates on the training set in order to learn from examples.

Training Set

The selection of features (inputs) from the learning domain partially defines a total environment the MLA operates within. The Research Funstion Algorithm operates on existing class sets and their relationships from the learning domain to accomplish this result. A class set represents one case of the relationship between the chosen features (inputs) and the classes (outputs). The class sets are termed training cases. One example of a class set would be attack sequences. In genetic programming, they are termed “fitness cases”. The foundation of the MLA is the ability to train the engine. Training results from incorporating within the knowledge base the information learned of both failed and successful attempts to prevent an attack. The MLA utilizes computer algorithms to predict, from the features, the outcome for network security of possible action commands from the Network Surveillance and Security System.

Generalizing from the Test Set

A test set is comprised of the inputs and outputs within a single training domain of the MLA. The Research Function Algorithm (RFA) can also conduct an appraisal of the quality of the learning by the MLA. The RFA quality appraisal utilizes the Test Set and the algorithms' ability to predict the best response in the relevant domain.

D) Responses & Countermeasures

The components of the Network Surveillance and Security System sub-layer III.C.1.c. Rule Based Personalities System are the processes that execute responses and countermeasures to events that can compromise the security of the Protected Server Constellation. The components of sub-layer. These responses are directed and monitored by the components of sub-layer III.C.2.c. Security Access Controller. The higher level analysis, inference, and learning operations, both for directing the responses and for revising the knowledge base to incorporate the results of the responses, are conducted by the Layer I.Expert System Security Intelligence Layer.

E) Secured Remote Access

Data encryption components for ensuring secure communication links are among the tools provided by the Network Protocol Center.

A proprietary encryption tool termed Privisea™ is an element of the Network Protocol Center. Privisea™ encrypts information using 512 bit cyphers and 1024 bit keys and can conduct key management across any publicly accessible network. Privisea™ provides secure communication for the Network Surveillance and Security System across publicly accessible networks. Proprietary information can thus be shared confidentially with another Network Surveillance and Security System without maintaining an exclusively private communication channel. Privisea™ encrypts (decrypts) the information before (after) the information is decomposed (reassembled). The packets of encrypted and decomposed information are then transported across the Internet, another public network, or a private network sector outside of the protected constellation.

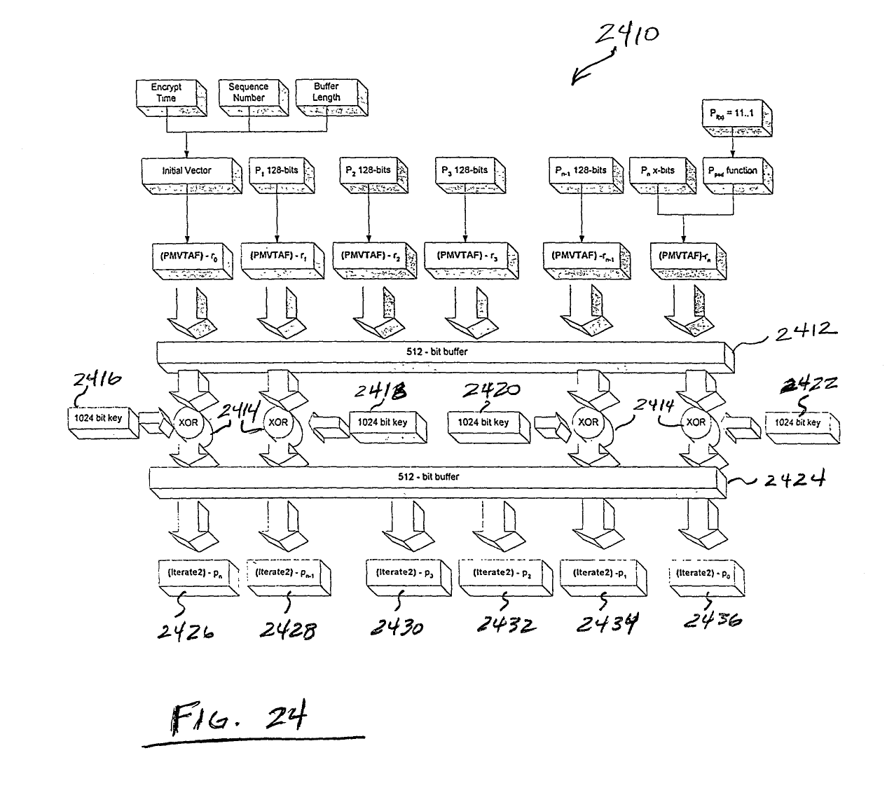

FIG. 21 depicts the structure of the encryption channel 2110. An application level protocol packet 2112 is, by an Encryption Machine A 2114, transformed into an encrypted packet 2116. The encrypted packet 2116 is communicated over the Internet 2118 to encryption channel B which receives the packet 2120 for decryption.

Encryption Channel Design

In ESKsc resides a software algorithm that encrypts the signature of the user into a series of seen and unseen codes. The α and u portions of code are randomly selected and may, at any given time, be interchanged. The β contains several fractions F some of which must be augmented during verification and during authentication. Furthermore, ∈ the Authentication and Verification keys are themselves algorithmsthat are interchangeable as well as unseen by the user and not remembered by the developer. The Design of the ESKsc is similar to that of a gyro within a gyro where the head angles are afloat and must be in alignment in order to authenticate.

The α argument is produced by an algorithm that seems digital in nature It executes a trace over the signature and can reproduce a digital replication of the signature. There are other dynamics that are involved so the β argument algorithm incorporates the fuzzy logic fractional portions by making another pass over the signature to concentrate on angles of the letters, deviations from the norm, normal deviations, the means and past history of the means. We then calculate the information into a fuzzy fractional component and augmented to the α argument result as a transitory result. Lastly, Privisea™ performs and transmits safety parity checks as a portion of the β argument in its transitory result.

Light Variant Of Encryption Scheme (LVES)

A “Light Variant of Encryption Scheme” (LVES) component of Privisea™ is based upon an existent algorithm termed Twofish and uses two sets of keys in which to encrypt data. The keys, termed K1 and K2, are 1024 bit keys used in encrypting 512 bits of raw text data into a form which Privisea™ uses to disburse through an algorithm called ESKsc before communicating across an unsecured channel.

Zolotov's LVES Main Algorithm

The LVES encryption process begins when a communication, such as raw text data, a data file, or a data buffer, is input to Privisea™ to be transmitted across an unsecured channel. The communication is time stamped and stored in a data structure called the Initial Vector. The Initial Vector includes:

Time the data is extracted from a buffer, file, or is entered into the sending computer running Privesea™ to be transmitted to the receiving computer running Privesea™.

An incremental (a random enumeration variable that uniquely sequences the timestamp)

length quantity (length of data being transmitted, or size of initial buffer, or number of characters being transmitted) which forms a check sum value for error control.

The Initial Vector contains 128 bit encryption and is partitioned to comprise one segment of Privesea™ (although this one segment forms a data encryption standard, it is merely one segment of Privesea™). The Initial Vector is composed of a sequence of partitions termed P's and each of the partitions P consist of 128 bits of raw text data. The partition function P{has the form {P₁, P₂, P₃ . . . Pₙ}, and controls the partitions of the Initial Vector in the Block Cipher If the raw text data in the last partition does not complete a full 128 bits, the Initial Vector is padded to complete the full 128 bit partition. The Padding function P(f), completes and fragmented raw text data with either ones 1's, or 0's, or both mixed according to a tracking formula. Hence, the Initial Vector and its partitions the P(s) along with the Padding function P(f) comprise the first iteration of the Privesea™ block cipher.

Privesea™ takes that which is decomposed into and Each of the Initial Vector 128 bit partitions is then encrypted with the Privesea™ Modified Version of the TwoFish algorithm using a 1024 bit key to complete the first iteration. Twofish is a 128-bit Block Cipher that accepts a variable-length key up to 256 bits.

Completing the first iteration with the key, K₁ produces a new vector wherein the original Initial Vector leading partition becomes partition T₀ comprising 128 along with each successive partition, formerly the function P(f) becoming Pₜ₍ₗ₎(f) and each successive Pₙ(f) of the Initial Vector becomes Pₜ₍ₙ₊ₗ₎(f) of the encrypted vector of the first iteration.

Privesea Modified Version of the Twofish Algorithmic Functions (PMVTAF)

Feistel Networks

A Feistel network is a method of forming a permutation of a function (usually termed the F function). The fundamental building block of a Feistel network is the F function: a key-dependent mapping of an input string onto an output string. An F function is always non-linear and possibly nonsurjective. A non-surjective F function is one which not all outputs in the output space can occur.

An F function is defined as:

F:{0,1}^{n/2*}{0,1}ⁿ|→{0,1}^{n/2}

Where;

n is the block size of the Feistel Network

F is a function with:

inputs—n/2 bits of the block & N bits of a key; and

outputs—length n/2 bits.

In each round, the source block is the input to F, and the output of F is xor'ed with the target block, after which these two blocks swap places for the next round. The repeated iteration of the F function creates a stronger encryption algorithm than when the F function is used alone. Two rounds of a Feistel network is termed a cycle. In each cycle, the entire text block has been modified once.

S-Boxes

An S-Box is a table-driven non-linear substitution operation used in most block ciphers. S-boxes vary in both input size and output size, and can be created either randomly or algorithmically. S-boxes were first used in GOST, Lucifer, then DES, and afterwards in most encryption algorithms.

Twofish uses four different, bijective, key-dependent, 8-by-8-bit S-boxes. Privesea modifies this design to use 8 S-boxes in LVSE version and 16 to 32 S-boxes in HVES version.

MDS Matrices

A maximum distance separable (MDS) code over a field is a linear mapping from a field elements to b field elements, producing a composite vector of a+b elements, with the property that the maximum number of non-zero elements in any non-zero vector is at least b+1. The distance between any two distinct vectors produced by the MDS mapping is at least b+1.

MDS mappings can be represented by an MDS matrix consisting of a x b elements. Reed-Solomon (RS) error-correcting codes are known to be MDS. A necessary and sufficient condition for an a x b matrix to be MDS is that all possible square sub matrices, obtained by discarding rows or columns, are non-singular.

Pseudo—Hadamard Transforms

A pseudo—Hadamard transform (PHT) is a simple mixing operation that runs quickly in software. Given two inputs, a and b, the 32-bit PHT is defined as:

a′=a+b mod2³²

b′=a+2b mod 2³²

SAFER uses 8-bit PHT's extensively for diffusion. Twofish uses a 32-bit PHT to mix the outputs from its two parallel 32-bit g functions. Privesea modifications to this function includes modifications that results in the following equations:

a′=a+b mod 2⁶⁴

b′=a+2b mod 2⁶⁴

and in later versions

a′=a+b mod 2¹²⁸

b′=a+2b mod 2¹²⁸

Whitening

Whitening, the technique of XORing key material before the first round and after the last round, was used by Merkle in Khufu/Khafre, and independently invented by Rivest for DES-X.

In, it was shown that whitening substantially increases the difficulty of key search attacks against the remainder of the cipher. Whitening hides from the attacker the specific inputs to the first and last rounds' F functions.

Twofish XORs 128 bits of sub key before the first Feistel round, and another 128 bits after the last Feistel round. These sub keys are calculated in the same manner as the round sub keys, but are not used anywhere else in the cipher.

Key Schedule

The key schedule is the means by which the key bits are turned into round keys that the cipher can use. Twofish requires a high quantity of key material, and has a complicated key schedule. This function, under Privesea LVES is not modified.

The Function F

The function F is a key-dependent permutation on 64-bit values. It takes three arguments, two input words R₀ and R₁, and the round number r used to select the appropriate sub keys. R₀ is passed through the g function, which yields T₀. R₁ is rotated left by 8 bits and then passed through the g function to yield T₁. The results T₀ and T₁ are then combined in a PHT and two words of the expanded key are added.

T₁=g(R₀)

T₁−g(ROL(R₁,8))

F₀=(T₀+T₁+K₂ᵣ₊₈)mod 2³²

F₁=(T₀+2T₁+K₂ᵣ₊₉)mod 2³²

Where (F₀, F₁) is the result of F.

The Function g

The function g forms the heart of Twofish. The input word X is split in four bytes. Each byte is run through its own key-dependent S-box. Each S-box is bijective, takes 8-bits of input, and produces 8 bits of output. The four results are interpreted as a vector of length 4 over GF(2⁸), and multiplied by the 4×4 MDS matrix (using the field GF(2⁸) for the computations). Twofish interprets the resulting vector as a 32-bit word which is the result of g.

x₁=[X/2^{8i]mod} 2⁸, for i=0, 1, . . . , 3

y₁=sᵢ[xᵢ], for i=0, 1, . . . , 3

$$\vert \begin{matrix}{Z}_{0} \\ {Z}_{1} \\ {Z}_{2} \\ {Z}_{3}\end{matrix} \vert = [ MDS ] \cdot \vert \begin{matrix}{Y}_{0} \\ {Y}_{1} \\ {Y}_{2} \\ {Y}_{3}\end{matrix} \vert$$

Z=ΣZⁱ.2⁸ⁱ

for i=0, 1 . . . , 3

where si are the key-dependent S-boxes and Z is the result of g.

ESKsc—The Stream Cipher

FIG. 22 depicts a stream cipher 2210. The stream cipher 2210 has six arguments:

A fisrt α argument 2212;

A second β argument 2214;

A third ∈ argument 2216;

A fourth Ω argument 2218;

A fifth ψ argument 2220; and

A sixth μ argument 2222.

The core of the Encryption Machine is a stream cipher called “The ESKsc”. The ESKsc controls the flow of packet partitions transmitted across electronic channels. The core uses a parametric control mechanism built into the algorithm to determine the placement of each data partition segment within a given packet before it is transmitted to the transmission control protocol layer of the OSI protocol stack. A packet's data partition takes on an random size defined by the ESKsc algorithm and the size of the partition is randomly selected by the algorithm and is secretly transmitted to the ESKsc receiving algorithm representing the key to the deciphering side. Privesea, being the parent algorithm to the ESKsq core, receives as input, a block of text data otherwise known as ASCII format and decomposes it first into cipher blocks and encrypt it with 512 bit encryption. Privesea then stores the encrypted data in a block size buffer where the ESKsc algorithm reads this buffer as input and feeds it through an input stream cipher with partition positioning parameters and control flow mechanisms.

I. Main Algorithm Definition.

The Privesea main algorithm is a 512-bit block cipher with a 1024 bit key. Key-One and Key-Two. Key-One used to prepare internal encryption data, Key-Two used to prepare the data mask. This implementation of preparing the data mask Privesea also has some key material called Cipher-boxes that will be discussed later. The main algorithm performs iterations up to 64 rounds during which it decomposes data into buffer formats of {fx:|f(1), f(2) . . . f(n)} which comprise encrypted bit formatted partitions of four 32 bit, two 64 bit, and two 128 bit partitions forming a 512 block of encrypted data and thus generating a 1024 bit key. Privesea uses a 1024 bit key for encrypting and decrypting formats generated using 32 Cipher-box permutations similar to a transitional matrix of secret data bits. These bits maybe interchangeable based on the version of Privesea or the encrypted channel data Privesea is integrating to compose. The fx's are all defined by the Privesea main algorithm using a random parametric technique which basically selects a parameter defining the sizes of each of the {fx}'s and stores them in a buffer. The main algorithm defines a text padding parameter to complete ASCII formatted data that might be fragmenting any file, stream or context of data to be encrypted using Privesea. Further decomposition of the data is performed to map the {fx}'s of the first buffer defined as buffer Bn into encrypted fx formats and keys of buffer Bn+1. The next successive round or permutation of data is enumerated by a succession of partition parameters as well as buffer parameters all to be passed in keys for decrypting the data.

Section 1.1 Input Specifications.

The main body of this algorithm accepts as input, whole files either in the form of formatted documents, text files, numerical data files, or anything of a file nature. The input file shall take on the form of the following: the data file in which the contents are to be altered, and a personal key in which will be necessary to unlock the contents of the file. Lowercase characters.

Section 1.2

Output Specifications. The main body of this algorithm produces results that are contents of an altered file. These contents are altered in the manner described below, in the following sections defining the different operations performed. The output results are in the form of. the altered file, the main key (K1), and the personal key (K2).

The following is a description of a novel iteration procedure for encrypting data. This iteration procedure is used in conjunction with the other encryption functions described previously.

A Zolotov's LVES Algorithm 2310 is depicted in FIG. 23. In a first iteration, the time 2312 the data is encrypted, a sequence number 2314 and the length of the data buffer 2316 is all stored into the Initial Vector P₀ 2318, plus any padding, if necessary, to complete the 128 bits of data in the Initial Vector. The Initial Vector 2318 is used as a marker that marks the header of each data sequence stream and allows the decryption algorithms to map sequences back to original text by obtaining the information contained in the Initial Vector 2318 (i.e. buffer length 2316 and time 2312).

The packet P₁ 2320 is the next 128 bits of raw data to be encrypted, where P₁ 2320 and each subsequent packet Pₓ 2322, where x varies between 2 and n, contains data to be encrypted. Each packet Pₓ 2322 breaks the files of raw data into packets where each break comes at 128 bits of raw data and where each break completes a packet of data to be encrypted.

The Pₙx-bits function 2324 contains the final break of text from the file. The final text or the text leftover from the last complete packet of 128 bits may be thought of as an incomplete 128 bits, so the Pₙ 2324 is broken at bit x, and the padding function (P_{pad}) 2326 produces a random padding to complete the full packet of 128 bits. Though the random padding uses random numbers to complete the packet tail, encoded in the tail is information pertaining to how long the random sequence of bits are and information about the number of the last bit of raw-true data.

The P_{f(x)} function 2328 produces a random sequence of “1”s and “0”s and encodes a number that provides information on the random sequence to allow the algorithm for decryption to map the random sequence to the padding needed to complete the 128 bits tailer.

The P_{pad} function 2326 is responsible for the padding that completes the tailer packet and the encoding necessary to provide the appropriate information about the size of the padding and a checksum on the randomness of the sequence of “1”s and “0”s generated to pad the packet data.

In a second iteration, a second step involves a modification of the published Two Fish algorithm. Two Fish is a 128 bit encryption algorithm. The modification uses certain functions of Two Fish and this modification is called Privesea's Modified Version of the Twofish Algorithmic Functions (PMVTAF)r₀₋ₙ 2328. The functions of this step have been described previously and are therefore only referenced here for the manner in which they are applied. The PMVTAFs 2328 all encrypt in parallel each of the 128 bit outputs from the packets 2318-2326 described above. The output from the PMVTAFs 2328 are all directed into a buffer of 512 bits. The PMVTAF 2328 provide the industry standard encryption on data packets and each data packet is 128 bits of raw data. The output differs from the industry standard of 128 bits, in that it comprises a buffer of 512 bits of encrypted data (see FIG. 24) and exclusive OR's it with a 1024 bit key.

A Zolotov's-Carter Key Scheduler Algorithm 2410 is depicted in FIG. 24. A third iteration takes the 512 bits of encrypted data from the data buffer 2412, and exclusive OR's 2414 it with one of the 1024 bit keys 2416-2422, whereby the 1024 bit keys 2416-2422 are unique to each transmission, and randomly generated. There are four such keys 2416-2422 generated and used to encrypt the buffer 2412, which must do so in the right sequence. The data in the buffer 2424 is then reversed and is reflected in the buffer 2424 inputs to a fourth iteration.

The exclusive OR function 2414 involves:

One bit from the 512 buffer 2412 is exclusive OR'd 2414 with the Exclusive OR'd 2414 two bits of one of the keys 2416-2422. For example, the first two bits of a key 2416-2422 are exclusive OR'd 2414 with each other, and the output of that operation provides one bit to exclusive OR 2414 from the 512 data buffer 2412. This operation is continued with the 1024 bit key-r 2416 and 1024 bit key-1 2418 which reverses the 512 buffer 2412, and with 1024 bit key-L 2420 and 1024 bit key-L-1 2422. The 512 buffer 2424 is reversed and then the data is broken into packets of 128 bits of outputs to perform another encryption iteration. These packets are called iterate2 2426-2436 and are enumerated according to the p's in FIG. 24.

A Zolotov's-Carter Counter Mask algorithm 2510 is depicted in FIG. 25. A Fourth Iteration begins the generation of a Counter Mask. The generation of the Counter provides extra protection while providing additional steps to map the encrypted data to the right sequences in which it was encrypted. The Counter Mask generation begins with the encrypted Initial Vector 2328 header, described above in the Initial Iteration, and the contents of the Initial Vector 2328 are the same as the contents of the encrypted Initial Vector 2328 in the Initial Iteration in FIG. 23. The subsequent packets (PMVTAF)r_{0 through x} 2512 contain the same information from the outputs of the first iteration with the exception of an incremental value that takes the number of each of the 128 bit packets and adds it to the encrypted contents of each packet. This produces the initial inputs to form the mask. The contents of each packet 2512 is encrypted using PMVTAF, thus producing the output (PMVTAF)p_{0 through n} 2514 which forms the contents of a 512 bit Counter Mask Buffer 2516. The Counter Mask Buffer 2516 is then exclusive OR'd 24514 with the same four 1024 bit keys 2416-2422, in the same manner in which the key function is performed for the data buffer in FIG. 24. The Counter Mask contents are too, reversed 2518 and the output is directed into packets named (Mask-i3) pₙ−p₀ 2520 which are shown in the illustration below to be in reversed order.

FIG. 26 depicts a Zolotov's Mask Result Algorithm 2610. A fifth iteration takes the (Mask-13)pₙ−p₀ 2520 and exclusive OR's 2414 it with the packets named (iterate3)-r₀₋ₙ 2612 which are the input corresponding to the outputs (iterate2)-p₀₋ₙ 2426-2436, the output from Iteration Three. The Fifth Iteration is exclusive OR'd 2414 bit for bit with the contents of the packets named Mask-i3p₀₋ₙ 2520 and the output from this iteration is stored in a 512 bit buffer 2620 for transport control. The next step in the preparation of this procedure is to allow the stream cipher 2210 to access this buffer 2620 and perform its operations to transport the data across some electronic channel. The packet labels c-outs 2630 are parcels that illustrate the end of the iterations rather than an indication of a data structure.

What is claimed is:

1. A network security system for a network having a plurality of computers, said system comprising at least one security program, said security program monitoring activity of a set of computers in the network, said program including an artificial intelligence component and a plurality of security rules, said security rules being alterable by the artificial intelligence component of the program in response to the monitored activity.

2. The network security system as set forth in claim 1 wherein the set of computers whose activity is monitored constitutes less than all the computers in the network.

3. The network security system as set forth in claim 1 wherein the network is in communication with an external computer network through one or more ports, the set of computers being monitored including at least some computers not connected directly to the ports in communication with the external network.

4. A network security system for a first computer network in communication with external computer networks having said security system, said system comprising at least a security program, said security program monitoring activity of the computer network and operating in accordance with a plurality of security rules, said security rules in the program running in the first computer network being alterable in response to information from at least one of the external computer networks running said security system, said information reflecting the monitoring of activity in said external computer network by the security system running in that external computer network.

5. The network security system as set forth in claim 4 further including an encrypted communication channel between said first computer network and said external computer network over which the security rule alteration information is communicated.

6. A network security system for a computer network, said system comprising at least a security program, said program monitoring activity of a set of computers in the network running a plurality of processes, said program assigning to each of said processes a unique identifier, said program further using said unique identifier to track the characteristics of each of said processes in the set of computers which is monitored.

7. A method of protecting network security in a computer network having a plurality of interconnected computers, said method comprising:
monitoring the activities of at least a plurality of computers in the network;
modeling information relating to new events in the monitored activities by examining previously obtained information relating to known events and thereby simulating the new events using the information relating to the known events;
applying security measures based upon the results of said modeling.

8. The method as set forth in claim 7 further including modeling information processes of said computers using artificial intelligence learning algorithms incorporating communication theory paradigms.

9. The method as set forth in claim 7 wherein the security measures include the execution of UNIX utilities, further including using artificial intelligence genetic evolution and co-evolution for modeling separate generations of said UNIX utilities, and applying those utilities of the separate generations that are the most successful at protecting security in the modeling.

10. The method as set forth in claim 9 wherein the most successful utilities are identified by their ability to accomplish pre-specified results, based upon prior observations of network events.

11. The method as set forth in claim 7 wherein the security measures are continuously updated using artificial intelligence programs in response to on-going events.

12. The method as set forth in claim 7 wherein the modeled information processes are UNIX processes, said process modeling step including the use of genetic programming and genetic machine learning programs.

13. The method as set forth in claim 7 wherein the process modeling step includes self-initiated and self-controlled genetic programming.

14. A method of protecting network security in a computer network having a plurality of interconnected computers, said method comprising:
monitoring the activities of at least a plurality of computers in the network;
modeling information processes of said computers using artificial intelligence learning algorithms incorporating communication theory paradigms;
identifying security events and sequences in the monitored activities and analyzing said security events with an expert system;
inferring motivations to the security events by modeling the events, taking into account preset system security policies and customer security policies;
applying security measures based upon the results of said modeling;
autonomously adapting the security measures in response to on-going security events;
identifying previously unseen security events and sequences and adding information concerning such events and sequences to a store of known security events and sequences;
testing previously unseen security events and sequences against a knowledge base to compare information concerning the previously unseen security events and sequences with information concerning known security events and sequences;
refining the knowledge base as a result of the testing of the previous step, including logging the events and sequences to automatically enhance the security measures to protect against future attack.

15. The method as set forth in claim 14 further including scheduling processes in accordance with an adaptation of the Digital UNIX real-time process scheduling scheme.

16. A method of protecting network security in a computer network having a plurality of interconnected computers, said method comprising:
monitoring the activities of at least a plurality of computers in the network;
modeling Internet and local area networks by applying artificial intelligence neural network programming to construct a plurality of knowledge bases;
simulating logical operations involved in securing computers against security threats using artificial intelligence neural networks;
maintaining the information security of the network against dynamic threats using artificial intelligence genetic programs and neural network sub-systems, including simulating internetworking security and creating an internetworking knowledge base based upon said simulating;
observing Internet and internetworking security policy violations in real time;
applying security measures based upon the observations and results of the modeling and simulations.

17. The method as set forth in claim 16 wherein the modeling includes constructing symbolic representations of UNIX utilities designed to protect computer systems against security threats.

18. The method as set forth in claim 16 further including using neural networks comprised of simulated neurons to obtain, in real time, knowledge relating to dynamic security threats.

19. The method as set forth in claim 18 further including characterizing computer security threats by establishing states representing current system security, said neural network predicting future system security states based upon past system security states.

20. A method of protecting network security in a computer network having a plurality of interconnected computers, said method comprising:
monitoring the activities of at least a plurality of computers in the network, including monitoring of multiple packets at TCP ports in real time;
detecting anomalous events in the monitored activities both statistically and with pattern matching, using both firewall logs and system logs;
identifying newly encountered attack sequences and storing information relating to said sequences in a knowledge base;
updating firewall filters in response to newly encountered attack sequences;
generating alerts and warnings to system administrators and site officials upon the detection of an attack sequence.

21. The method as set forth in claim 20 further including communicating information relating to newly encountered attack sequences to other computer networks.

22. A method of protecting network security in a computer network having a plurality of interconnected computers, said method comprising:
monitoring the activities of at least a plurality of computers in the network, including monitoring all connections to TCP and UDP ports;
analyzing packet contents in the monitored activities statefully using information from packet headers, including stateful analysis of Ethernet packet headers, IP packet headers, and TCP packet headers;
further including statefully analyzing session identification and protocol layer information from packet headers;
applying security measures based upon the stateful analysis of the packet header information.

23. A method of protecting network security in a computer network having a plurality of interconnected computers, said method comprising:
monitoring the activities of at least a plurality of computers in the network, including monitoring of failed login attempts;
detecting monitored activities that are contrary to preestablished administrative policies;
monitoring network system traffic;
administering internal and external resource authorizations for the network, including authorizations for the computers being monitored;
applying security measures based upon the detection of monitored activities that are contrary to said preestablished administrative policies.

24. A method of protecting network security in a computer network having a plurality of interconnected computers, said method comprising:
monitoring the activities of at least a plurality of computers in the network, including monitoring file systems and file security to protect file ownership and directory ownership;
detecting and locking weak accounts;
applying security measures based upon results of the monitoring that indicate a security threat.

25. A method of protecting network security in a computer network having a plurality of interconnected computers, said method comprising:
monitoring the activities of at least a plurality of computers in the network;
said network having at least some ports for connection to external computers outside the network;
making a connection to an external computer over a first port;
monitoring the connection over the first port;
switching the port over which the connection to the external computer is made to a second port;
continuing to monitor the connection over the second port throughout the existence of the connection.

26. The method as set forth in claim 25 wherein the first port is a user defined port (UDP).

27. A method of protecting network security in a computer network having a plurality of interconnected computers, said method comprising:
monitoring the activities of at least a plurality of computers in the network in real time;
modeling the plurality of computers and the operations performed thereby in a multidimensional, dynamically evolving network status space, each dimension of said network status space representing a quality relating to the network, network users, or the computer processes.

28. The method as set forth in claim 27 wherein the coordinates of a point in network status space represent the state of the network and its operations.

29. The method as set forth in claim 27 wherein the network status space is divided into areas of acceptable security, areas of unacceptable security, and areas of uncertain security.

30. The method as set forth in claim 29 further including the step of determining a path from an unacceptable security area in network status space to an acceptable security area, and effecting a move of the network from an unacceptable security area to an acceptable security area in network status space.

31. The method as set forth in claim 27 wherein the position of the network in network status space is tracked and monitored throughout the duration of external communications with the network.

32. The method as set forth in claim 27 wherein the modeling step includes forming a matrix-representation of the computers and the operations performed thereby.

33. A method of protecting network security in a computer network having a plurality of interconnected computers, said method comprising:
monitoring the activities of at least a plurality of computers in the network;
modeling Internet and local area networks by applying artificial intelligence neural network programming to construct a plurality of knowledge bases;
simulating logical operations involved in securing computers against security threats using artificial intelligence neural networks;
maintaining the information security of the network against dynamic threats using neural network sub-systems, including simulating internetworking security and creating an internetworking knowledge base based upon said simulating;
observing Internet and internetworking security policy violations in real time;
applying security measures based upon the observations and results of the modeling and simulations.

34. The method as set forth in claim 33 wherein the modeling includes constructing symbolic representations of UNIX utilities designed to protect computer systems against security threats.

35. The method as set forth in claim 33 further including using neural networks comprised of simulated neurons to obtain, in real time, knowledge relating to dynamic security threats.

36. The method as set forth in claim 35 further including characterizing computer security threats by establishing states representing current system security, said neural network predicting future system security states based upon past system security states.

37. The method as set forth in claim 14 wherein the security policies are autonomously altered during run-time based upon preset security goals.

38. An encryption method for communications between computers, said method comprising:
storing in an initial vector a time at which data is encrypted, a sequence number, and a length of a data buffer;
breaking the data to be encrypted into packets;
padding the final packet with random numbers and encoded information relating to the length of the padding and the location of the last bit of data;
encrypting the data in the packets and directing the encrypted data into a buffer having a length substantially longer than the length of the packets;
performing a logical operation on the data in the buffer and a key to form encoded buffer contents, said key being unique to each transmission;
generating a counter mask using the initial vector;
performing a logical operation on the counter mask and the key to form an encoded counter mask;
performing a logical operation on the encoded buffer contents and the encoded counter mask;
transporting the result of the previous step over an electronic channel.

39. The method as set forth in claim 38 wherein the initial vector is padded to create a vector of a predetermined length.

40. The method as set forth in claim 38 wherein the key is randomly generated.
